(19) United States
(12) Patent Application Publication
(10) Pub. No.: US 2024/0402984 A1
(43) Pub. Date: Dec. 5, 2024

(54) DEVICES, METHODS, AND GRAPHICAL USER INTERFACES FOR MANAGING AUDIO SOURCES

(71) Applicant: Apple Inc., Cupertino, CA (US)

(72) Inventors: Hugo D. VERWEIJ, Portola Valley, CA (US); Mitchell R. LERNER, San Francisco, CA (US); Danielle M. PRICE, Los Gatos, CA (US); Sanket S. DAVE, Sunnyvale, CA (US); Deepak IYER, Mountain View, CA (US); Lauren A. HASTINGS, Oakland, CA (US)

(21) Appl. No.: 18/627,669

(22) Filed: Apr. 5, 2024

Related U.S. Application Data
(60) Provisional application No. 63/471,226, filed on Jun. 5, 2023.

(51) Int. Cl. G06F 3/16; G06F 3/04815; G06F 3/04845; G06F 3/04847

(52) U.S. Cl. CPC G06F 3/165; G06F 3/04815; G06F 3/04845; G06F 3/04847

(57) ABSTRACT

The present disclosure generally relates to managing audio sources. In accordance with some embodiments, one or more methods for managing controls for changing audio output, managing the prominence of audio, managing audio output based on distance, managing a virtual sound stage, outputting audio at one or more locations in accordance with some embodiments, and outputting audio at one or more locations in accordance with some embodiments.

### CROSS-REFERENCE TO RELATED APPLICATIONS

The present application claims priority to U.S. Provisional Patent Application Ser. No. 63/471,226, entitled “DEVICES, METHOD, AND GRAPHICAL USER INTERFACES FOR MANAGING AUDIO SOURCES” filed Jun. 5, 2023, which is hereby incorporated by reference in its entirety for all purposes.

### TECHNICAL FIELD

The present disclosure relates generally to computer systems that provide computer-generated experiences, including, but not limited to, electronic devices that provide virtual reality and mixed reality experiences via a display and one or more audio output devices.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, overlays, and control elements such as buttons and other graphics. Such virtual objects can indicate what operations the electronic device is capable of performing.

### SUMMARY

Some methods and interfaces for managing audio sources using computer systems are cumbersome, inefficient, and limited. For example, systems often do not have an intelligent management system for audio sources to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with virtual objects displayed via the computer systems more efficient and intuitive for a user. Such methods and interfaces optionally complement or replace conventional methods for managing audio sources. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for computer systems with improved methods and interfaces for managing audio sources. Such methods and interfaces may complement or replace conventional methods for managing audio sources. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a method that is performed at a computer system that is in communication with one or more output devices and a display generation component is described. In some embodiments, the method comprises: while outputting, via the one or more output devices, media corresponding to a first audio source at a first audio level and outputting, via the one or more output devices, media corresponding to a second audio source at a second audio level that is different from the first audio level, displaying, via the display generation component, a control for adjusting an audio level corresponding to multiple audio sources that include the first audio source and the second audio source; while displaying the control for adjusting the audio level corresponding to the multiple audio sources, detecting a first input directed to the control for adjusting the audio level corresponding to the multiple audio sources; in response to detecting the first input, proportionally adjusting output of media corresponding to the multiple audio sources, including: adjusting output of media corresponding to the first audio source by a first amount; and adjusting output of media corresponding to the second audio source by a second amount that is different from the first amount, wherein a difference between the first amount of adjustment and the second amount of adjustment is based on a difference between the first audio level and the second audio level; after proportionally adjusting output of media corresponding to the multiple audio sources, detecting a second input; and in response to detecting the second input: in accordance with a determination that a first set of one or more criteria is satisfied, wherein the first set of one or more criteria includes a criterion that is satisfied when a determination is made that the second input is directed to a control for adjusting an audio level corresponding to the first audio source independently of adjustments to the audio level corresponding to the second audio source, adjusting output of media corresponding to the first audio source without adjusting output of media corresponding to the second audio source and while displaying, via the display generation component, an indication that the audio level corresponding to the multiple audio sources being adjusted based on the second input.

In some embodiments, a non-transitory computer-readable storage medium storing one or more programs configured to be executed by one or more processors of a computer system that is in communication with one or more output devices and a display generation component is described. In some embodiments, the one or more programs includes instructions for: while outputting, via the one or more output devices, media corresponding to a first audio source at a first audio level and outputting, via the one or more output devices, media corresponding to a second audio source at a second audio level that is different from the first audio level, displaying, via the display generation component, a control for adjusting an audio level corresponding to multiple audio sources that include the first audio source and the second audio source; while displaying the control for adjusting the audio level corresponding to the multiple audio sources, detecting a first input directed to the control for adjusting the audio level corresponding to the multiple audio sources; in response to detecting the first input, proportionally adjusting output of media corresponding to the multiple audio sources, including: adjusting output of media corresponding to the first audio source by a first amount; and adjusting output of media corresponding to the second audio source by a second amount that is different from the first amount, wherein a difference between the first amount of adjustment and the second amount of adjustment is based on a difference between the first audio level and the second audio level; after proportionally adjusting output of media corresponding to the multiple audio sources, detecting a second input; and in response to detecting the second input: in accordance with a determination that a first set of one or more criteria is satisfied, wherein the first set of one or more criteria includes a criterion that is satisfied when a determination is made that the second input is directed to a control for adjusting an audio level corresponding to the first audio source independently of adjustments to the audio level corresponding to the second audio source, adjusting output of media corresponding to the first audio source without adjusting output of media corresponding to the second audio source and while displaying, via the display generation component, an indication that the audio level corresponding to the multiple audio sources being adjusted based on the second input.

In some embodiments, a transitory computer-readable storage medium storing one or more programs configured to be executed by one or more processors of a computer system that is in communication with one or more output devices and a display generation component is described. In some embodiments, the one or more programs includes instructions for: while outputting, via the one or more output devices, media corresponding to a first audio source at a first audio level and outputting, via the one or more output devices, media corresponding to a second audio source at a second audio level that is different from the first audio level, displaying, via the display generation component, a control for adjusting an audio level corresponding to multiple audio sources that include the first audio source and the second audio source; while displaying the control for adjusting the audio level corresponding to the multiple audio sources, detecting a first input directed to the control for adjusting the audio level corresponding to the multiple audio sources; in response to detecting the first input, proportionally adjusting output of media corresponding to the multiple audio sources, including: adjusting output of media corresponding to the first audio source by a first amount; and adjusting output of media corresponding to the second audio source by a second amount that is different from the first amount, wherein a difference between the first amount of adjustment and the second amount of adjustment is based on a difference between the first audio level and the second audio level; after proportionally adjusting output of media corresponding to the multiple audio sources, detecting a second input; and in response to detecting the second input: in accordance with a determination that a first set of one or more criteria is satisfied, wherein the first set of one or more criteria includes a criterion that is satisfied when a determination is made that the second input is directed to a control for adjusting an audio level corresponding to the first audio source independently of adjustments to the audio level corresponding to the second audio source, adjusting output of media corresponding to the first audio source without adjusting output of media corresponding to the second audio source and while displaying, via the display generation component, an indication that the audio level corresponding to the multiple audio sources being adjusted based on the second input.

In some embodiments, a computer system that is in communication with one or more output devices and a display generation component is described. In some embodiments, the computer system comprises one or more processors and memory storing one or more programs configured to be executed by the one or more processors. In some embodiments, the one or more programs includes instructions for: while outputting, via the one or more output devices, media corresponding to a first audio source at a first audio level and outputting, via the one or more output devices, media corresponding to a second audio source at a second audio level that is different from the first audio level, displaying, via the display generation component, a control for adjusting an audio level corresponding to multiple audio sources that include the first audio source and the second audio source; while displaying the control for adjusting the audio level corresponding to the multiple audio sources, detecting a first input directed to the control for adjusting the audio level corresponding to the multiple audio sources; in response to detecting the first input, proportionally adjusting output of media corresponding to the multiple audio sources, including: adjusting output of media corresponding to the first audio source by a first amount; and adjusting output of media corresponding to the second audio source by a second amount that is different from the first amount, wherein a difference between the first amount of adjustment and the second amount of adjustment is based on a difference between the first audio level and the second audio level; after proportionally adjusting output of media corresponding to the multiple audio sources, detecting a second input; and in response to detecting the second input: in accordance with a determination that a first set of one or more criteria is satisfied, wherein the first set of one or more criteria includes a criterion that is satisfied when a determination is made that the second input is directed to a control for adjusting an audio level corresponding to the first audio source independently of adjustments to the audio level corresponding to the second audio source, adjusting output of media corresponding to the first audio source without adjusting output of media corresponding to the second audio source and while displaying, via the display generation component, an indication that the audio level corresponding to the multiple audio sources being adjusted based on the second input.

In some embodiments, a computer system that is in communication with one or more output devices and a display generation component is described. In some embodiments, the computer system comprises means for performing each of the following steps: while outputting, via the one or more output devices, media corresponding to a first audio source at a first audio level and outputting, via the one or more output devices, media corresponding to a second audio source at a second audio level that is different from the first audio level, displaying, via the display generation component, a control for adjusting an audio level corresponding to multiple audio sources that include the first audio source and the second audio source; while displaying the control for adjusting the audio level corresponding to the multiple audio sources, detecting a first input directed to the control for adjusting the audio level corresponding to the multiple audio sources; in response to detecting the first input, proportionally adjusting output of media corresponding to the multiple audio sources, including: adjusting output of media corresponding to the first audio source by a first amount; and adjusting output of media corresponding to the second audio source by a second amount that is different from the first amount, wherein a difference between the first amount of adjustment and the second amount of adjustment is based on a difference between the first audio level and the second audio level; after proportionally adjusting output of media corresponding to the multiple audio sources, detecting a second input; and in response to detecting the second input: in accordance with a determination that a first set of one or more criteria is satisfied, wherein the first set of one or more criteria includes a criterion that is satisfied when a determination is made that the second input is directed to a control for adjusting an audio level corresponding to the first audio source independently of adjustments to the audio level corresponding to the second audio source, adjusting output of media corresponding to the first audio source without adjusting output of media corresponding to the second audio source and while displaying, via the display generation component, an indication that the audio level corresponding to the multiple audio sources being adjusted based on the second input.

In some embodiments, a computer program product is described. In some embodiments, the computer program product comprises one or more programs configured to be executed by one or more processors of a computer system that is in communication with one or more output devices and a display generation component. In some embodiments, the one or more programs include instructions for: while outputting, via the one or more output devices, media corresponding to a first audio source at a first audio level and outputting, via the one or more output devices, media corresponding to a second audio source at a second audio level that is different from the first audio level, displaying, via the display generation component, a control for adjusting an audio level corresponding to multiple audio sources that include the first audio source and the second audio source; while displaying the control for adjusting the audio level corresponding to the multiple audio sources, detecting a first input directed to the control for adjusting the audio level corresponding to the multiple audio sources; in response to detecting the first input, proportionally adjusting output of media corresponding to the multiple audio sources, including: adjusting output of media corresponding to the first audio source by a first amount; and adjusting output of media corresponding to the second audio source by a second amount that is different from the first amount, wherein a difference between the first amount of adjustment and the second amount of adjustment is based on a difference between the first audio level and the second audio level; after proportionally adjusting output of media corresponding to the multiple audio sources, detecting a second input; and in response to detecting the second input: in accordance with a determination that a first set of one or more criteria is satisfied, wherein the first set of one or more criteria includes a criterion that is satisfied when a determination is made that the second input is directed to a control for adjusting an audio level corresponding to the first audio source independently of adjustments to the audio level corresponding to the second audio source, adjusting output of media corresponding to the first audio source without adjusting output of media corresponding to the second audio source and while displaying, via the display generation component, an indication that the audio level corresponding to the multiple audio sources being adjusted based on the second input.

In some embodiments, a method that is performed at a computer system that is in communication with one or more audio output devices and a display generation component is described. In some embodiments, the method comprises: while a first object is visible, via the display generation component, outputting, via the one or more audio output devices, audio corresponding to the first object at a first prominence of audio output; while outputting audio corresponding to the first object at the first prominence of audio output, detecting an occurrence of an event that includes detecting attention of a user moving away from being directed to the first object; and in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

In some embodiments, a non-transitory computer-readable storage medium storing one or more programs configured to be executed by one or more processors of a computer system that is in communication with one or more audio output devices and a display generation component is described. In some embodiments, the one or more programs includes instructions for: while a first object is visible, via the display generation component, outputting, via the one or more audio output devices, audio corresponding to the first object at a first prominence of audio output; while outputting audio corresponding to the first object at the first prominence of audio output, detecting an occurrence of an event that includes detecting attention of a user moving away from being directed to the first object; and in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

In some embodiments, a transitory computer-readable storage medium storing one or more programs configured to be executed by one or more processors of a computer system that is in communication with one or more audio output devices and a display generation component is described. In some embodiments, the one or more programs includes instructions for: while a first object is visible, via the display generation component, outputting, via the one or more audio output devices, audio corresponding to the first object at a first prominence of audio output; while outputting audio corresponding to the first object at the first prominence of audio output, detecting an occurrence of an event that includes detecting attention of a user moving away from being directed to the first object; and in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

In some embodiments, a computer system that is in communication with one or more audio output devices and a display generation component is described. In some embodiments, the computer system comprises one or more processors and memory storing one or more programs configured to be executed by the one or more processors. In some embodiments, the one or more programs includes instructions for: while a first object is visible, via the display generation component, outputting, via the one or more audio output devices, audio corresponding to the first object at a first prominence of audio output; while outputting audio corresponding to the first object at the first prominence of audio output, detecting an occurrence of an event that includes detecting attention of a user moving away from being directed to the first object; and in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

In some embodiments, a computer system that is in communication with one or more audio output devices and a display generation component is described. In some embodiments, the computer system comprises means for performing each of the following steps: while a first object is visible, via the display generation component, outputting, via the one or more audio output devices, audio corresponding to the first object at a first prominence of audio output; while outputting audio corresponding to the first object at the first prominence of audio output, detecting an occurrence of an event that includes detecting attention of a user moving away from being directed to the first object; and in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

In some embodiments, a computer program product is described. In some embodiments, the computer program product comprises one or more programs configured to be executed by one or more processors of a computer system that is in communication with one or more audio output devices and a display generation component. In some embodiments, the one or more programs include instructions for: while a first object is visible, via the display generation component, outputting, via the one or more audio output devices, audio corresponding to the first object at a first prominence of audio output; while outputting audio corresponding to the first object at the first prominence of audio output, detecting an occurrence of an event that includes detecting attention of a user moving away from being directed to the first object; and in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

In some embodiments, a method that is performed at a computer system that is in communication with one or more audio output devices and a display generation component is described. In some embodiments, the method comprises: while a user interface object corresponding to an application is visible at a first location in a three-dimensional environment, outputting, via the one or more audio output devices, audio corresponding to the user interface with a first value for a respective audio property; while outputting audio corresponding to the user interface with the first value for the respective audio property, detecting a request to move the user interface relative to a viewpoint of a user; and in response to detecting the request to move the user interface object corresponding to the application relative to the viewpoint of the user in the three-dimensional environment: moving the user interface object corresponding to the application relative to the viewpoint of the user in the three-dimensional environment; and outputting, via the one or more audio output devices, the audio corresponding to the user interface object with a second value for the respective audio property different from the first value for the respective audio property.

In some embodiments, a non-transitory computer-readable storage medium storing one or more programs configured to be executed by one or more processors of a computer system that is in communication with one or more audio output devices and a display generation component is described. In some embodiments, the one or more programs includes instructions for: while a user interface object corresponding to an application is visible at a first location in a three-dimensional environment, outputting, via the one or more audio output devices, audio corresponding to the user interface with a first value for a respective audio property; while outputting audio corresponding to the user interface with the first value for the respective audio property, detecting a request to move the user interface relative to a viewpoint of a user; and in response to detecting the request to move the user interface object corresponding to the application relative to the viewpoint of the user in the three-dimensional environment: moving the user interface object corresponding to the application relative to the viewpoint of the user in the three-dimensional environment; and outputting, via the one or more audio output devices, the audio corresponding to the user interface object with a second value for the respective audio property different from the first value for the respective audio property.

In some embodiments, a transitory computer-readable storage medium storing one or more programs configured to be executed by one or more processors of a computer system that is in communication with one or more audio output devices and a display generation component is described. In some embodiments, the one or more programs includes instructions for: while a user interface object corresponding to an application is visible at a first location in a three-dimensional environment, outputting, via the one or more audio output devices, audio corresponding to the user interface with a first value for a respective audio property; while outputting audio corresponding to the user interface with the first value for the respective audio property, detecting a request to move the user interface relative to a viewpoint of a user; and in response to detecting the request to move the user interface object corresponding to the application relative to the viewpoint of the user in the three-dimensional environment: moving the user interface object corresponding to the application relative to the viewpoint of the user in the three-dimensional environment; and outputting, via the one or more audio output devices, the audio corresponding to the user interface object with a second value for the respective audio property different from the first value for the respective audio property.

In some embodiments, a computer system that is in communication with one or more audio output devices and a display generation component is described. In some embodiments, the computer system comprises one or more processors and memory storing one or more programs configured to be executed by the one or more processors. In some embodiments, the one or more programs includes instructions for: while a user interface object corresponding to an application is visible at a first location in a three-dimensional environment, outputting, via the one or more audio output devices, audio corresponding to the user interface with a first value for a respective audio property; while outputting audio corresponding to the user interface with the first value for the respective audio property, detecting a request to move the user interface relative to a viewpoint of a user; and in response to detecting the request to move the user interface object corresponding to the application relative to the viewpoint of the user in the three-dimensional environment: moving the user interface object corresponding to the application relative to the viewpoint of the user in the three-dimensional environment; and outputting, via the one or more audio output devices, the audio corresponding to the user interface object with a second value for the respective audio property different from the first value for the respective audio property.

In some embodiments, a computer system that is in communication with one or more audio output devices and a display generation component is described. In some embodiments, the computer system comprises means for performing each of the following steps: while a user interface object corresponding to an application is visible at a first location in a three-dimensional environment, outputting, via the one or more audio output devices, audio corresponding to the user interface with a first value for a respective audio property; while outputting audio corresponding to the user interface with the first value for the respective audio property, detecting a request to move the user interface relative to a viewpoint of a user; and in response to detecting the request to move the user interface object corresponding to the application relative to the viewpoint of the user in the three-dimensional environment: moving the user interface object corresponding to the application relative to the viewpoint of the user in the three-dimensional environment; and outputting, via the one or more audio output devices, the audio corresponding to the user interface object with a second value for the respective audio property different from the first value for the respective audio property.

In some embodiments, a computer program product is described. In some embodiments, the computer program product comprises one or more programs configured to be executed by one or more processors of a computer system that is in communication with one or more audio output devices and a display generation component. In some embodiments, the one or more programs include instructions for: while a user interface object corresponding to an application is visible at a first location in a three-dimensional environment, outputting, via the one or more audio output devices, audio corresponding to the user interface with a first value for a respective audio property; while outputting audio corresponding to the user interface with the first value for the respective audio property, detecting a request to move the user interface relative to a viewpoint of a user; and in response to detecting the request to move the user interface object corresponding to the application relative to the viewpoint of the user in the three-dimensional environment: moving the user interface object corresponding to the application relative to the viewpoint of the user in the three-dimensional environment; and outputting, via the one or more audio output devices, the audio corresponding to the user interface object with a second value for the respective audio property different from the first value for the respective audio property.

In some embodiments, a method that is performed at a computer system that is in communication with one or more input device and one or more audio output devices is described. In some embodiments, the method comprises: while outputting, via the one or more input devices, audio corresponding to an object according to a first virtual sound stage for the object, detecting, via the one or more input devices, an input directed to the object that corresponds to a request to change a spatial property of the object; and in response to detecting the input directed to the object that corresponds to the request to change the spatial property of the object: changing the spatial property of the object from having a first value for a respective spatial property to having a second value for the respective spatial property; and outputting, via the one or more input devices, audio corresponding to the object according to a second virtual sound stage different from the first virtual sound stage.

In some embodiments, a non-transitory computer-readable storage medium storing one or more programs configured to be executed by one or more processors of a computer system that is in communication with one or more input device and one or more audio output devices is described. In some embodiments, the one or more programs includes instructions for: while outputting, via the one or more input devices, audio corresponding to an object according to a first virtual sound stage for the object, detecting, via the one or more input devices, an input directed to the object that corresponds to a request to change a spatial property of the object; and in response to detecting the input directed to the object that corresponds to the request to change the spatial property of the object: changing the spatial property of the object from having a first value for a respective spatial property to having a second value for the respective spatial property; and outputting, via the one or more input devices, audio corresponding to the object according to a second virtual sound stage different from the first virtual sound stage.

In some embodiments, a transitory computer-readable storage medium storing one or more programs configured to be executed by one or more processors of a computer system that is in communication with one or more input device and one or more audio output devices is described. In some embodiments, the one or more programs includes instructions for: while outputting, via the one or more input devices, audio corresponding to an object according to a first virtual sound stage for the object, detecting, via the one or more input devices, an input directed to the object that corresponds to a request to change a spatial property of the object; and in response to detecting the input directed to the object that corresponds to the request to change the spatial property of the object: changing the spatial property of the object from having a first value for a respective spatial property to having a second value for the respective spatial property; and outputting, via the one or more input devices, audio corresponding to the object according to a second virtual sound stage different from the first virtual sound stage.

In some embodiments, a computer system that is in communication with one or more input device and one or more audio output devices is described. In some embodiments, the computer system comprises one or more processors and memory storing one or more programs configured to be executed by the one or more processors. In some embodiments, the one or more programs includes instructions for: while outputting, via the one or more input devices, audio corresponding to an object according to a first virtual sound stage for the object, detecting, via the one or more input devices, an input directed to the object that corresponds to a request to change a spatial property of the object; and in response to detecting the input directed to the object that corresponds to the request to change the spatial property of the object: changing the spatial property of the object from having a first value for a respective spatial property to having a second value for the respective spatial property; and outputting, via the one or more input devices, audio corresponding to the object according to a second virtual sound stage different from the first virtual sound stage.

In some embodiments, a computer system that is in communication with one or more input device and one or more audio output devices is described. In some embodiments, the computer system comprises means for performing each of the following steps: while outputting, via the one or more input devices, audio corresponding to an object according to a first virtual sound stage for the object, detecting, via the one or more input devices, an input directed to the object that corresponds to a request to change a spatial property of the object; and in response to detecting the input directed to the object that corresponds to the request to change the spatial property of the object: changing the spatial property of the object from having a first value for a respective spatial property to having a second value for the respective spatial property; and outputting, via the one or more input devices, audio corresponding to the object according to a second virtual sound stage different from the first virtual sound stage.

In some embodiments, a computer program product is described. In some embodiments, the computer program product comprises one or more programs configured to be executed by one or more processors of a computer system that is in communication with one or more input device and one or more audio output devices. In some embodiments, the one or more programs include instructions for: while outputting, via the one or more input devices, audio corresponding to an object according to a first virtual sound stage for the object, detecting, via the one or more input devices, an input directed to the object that corresponds to a request to change a spatial property of the object; and in response to detecting the input directed to the object that corresponds to the request to change the spatial property of the object: changing the spatial property of the object from having a first value for a respective spatial property to having a second value for the respective spatial property; and outputting, via the one or more input devices, audio corresponding to the object according to a second virtual sound stage different from the first virtual sound stage.

In some embodiments, a method that is performed at a computer system that is in communication with one or more audio output devices and one or more display generation components is described. In some embodiments, the method comprises: detecting a request to play audio corresponding to an audio source; and in response to detecting the request to play audio corresponding to the audio source: in accordance with a determination that the audio source corresponding to an object that has an associated location in a three-dimensional environment that is visible via the one or more display generation components, outputting, via the one or more audio output devices, audio corresponding to the object, such that the audio corresponding to the object is output with respect to a first location that is associated with the object in the three-dimensional environment; and in accordance with a determination that the audio source does not correspond to an object that has an associated location in the three-dimensional environment, outputting, via the one or more audio output devices, the audio corresponding to the object, such that the audio corresponding to the object is output with respect to a second location that is a system selected location that is different from the first location in the three-dimensional environment.

In some embodiments, a non-transitory computer-readable storage medium storing one or more programs configured to be executed by one or more processors of a computer system that is in communication with one or more audio output devices and one or more display generation components is described. In some embodiments, the one or more programs includes instructions for: detecting a request to play audio corresponding to an audio source; and in response to detecting the request to play audio corresponding to the audio source: in accordance with a determination that the audio source corresponding to an object that has an associated location in a three-dimensional environment that is visible via the one or more display generation components, outputting, via the one or more audio output devices, audio corresponding to the object, such that the audio corresponding to the object is output with respect to a first location that is associated with the object in the three-dimensional environment; and in accordance with a determination that the audio source does not correspond to an object that has an associated location in the three-dimensional environment, outputting, via the one or more audio output devices, the audio corresponding to the object, such that the audio corresponding to the object is output with respect to a second location that is a system selected location that is different from the first location in the three-dimensional environment.

In some embodiments, a transitory computer-readable storage medium storing one or more programs configured to be executed by one or more processors of a computer system that is in communication with one or more audio output devices and one or more display generation components is described. In some embodiments, the one or more programs includes instructions for: detecting a request to play audio corresponding to an audio source; and in response to detecting the request to play audio corresponding to the audio source: in accordance with a determination that the audio source corresponding to an object that has an associated location in a three-dimensional environment that is visible via the one or more display generation components, outputting, via the one or more audio output devices, audio corresponding to the object, such that the audio corresponding to the object is output with respect to a first location that is associated with the object in the three-dimensional environment; and in accordance with a determination that the audio source does not correspond to an object that has an associated location in the three-dimensional environment, outputting, via the one or more audio output devices, the audio corresponding to the object, such that the audio corresponding to the object is output with respect to a second location that is a system selected location that is different from the first location in the three-dimensional environment.

In some embodiments, a computer system that is in communication with one or more audio output devices and one or more display generation components is described. In some embodiments, the computer system comprises one or more processors and memory storing one or more programs configured to be executed by the one or more processors. In some embodiments, the one or more programs includes instructions for: detecting a request to play audio corresponding to an audio source; and in response to detecting the request to play audio corresponding to the audio source: in accordance with a determination that the audio source corresponding to an object that has an associated location in a three-dimensional environment that is visible via the one or more display generation components, outputting, via the one or more audio output devices, audio corresponding to the object, such that the audio corresponding to the object is output with respect to a first location that is associated with the object in the three-dimensional environment; and in accordance with a determination that the audio source does not correspond to an object that has an associated location in the three-dimensional environment, outputting, via the one or more audio output devices, the audio corresponding to the object, such that the audio corresponding to the object is output with respect to a second location that is a system selected location that is different from the first location in the three-dimensional environment.

In some embodiments, a computer system that is in communication with one or more audio output devices and one or more display generation components is described. In some embodiments, the computer system comprises means for performing each of the following steps: detecting a request to play audio corresponding to an audio source; and in response to detecting the request to play audio corresponding to the audio source: in accordance with a determination that the audio source corresponding to an object that has an associated location in a three-dimensional environment that is visible via the one or more display generation components, outputting, via the one or more audio output devices, audio corresponding to the object, such that the audio corresponding to the object is output with respect to a first location that is associated with the object in the three-dimensional environment; and in accordance with a determination that the audio source does not correspond to an object that has an associated location in the three-dimensional environment, outputting, via the one or more audio output devices, the audio corresponding to the object, such that the audio corresponding to the object is output with respect to a second location that is a system selected location that is different from the first location in the three-dimensional environment.

In some embodiments, a computer program product is described. In some embodiments, the computer program product comprises one or more programs configured to be executed by one or more processors of a computer system that is in communication with one or more audio output devices and one or more display generation components. In some embodiments, the one or more programs include instructions for: detecting a request to play audio corresponding to an audio source; and in response to detecting the request to play audio corresponding to the audio source: in accordance with a determination that the audio source corresponding to an object that has an associated location in a three-dimensional environment that is visible via the one or more display generation components, outputting, via the one or more audio output devices, audio corresponding to the object, such that the audio corresponding to the object is output with respect to a first location that is associated with the object in the three-dimensional environment; and in accordance with a determination that the audio source does not correspond to an object that has an associated location in the three-dimensional environment, outputting, via the one or more audio output devices, the audio corresponding to the object, such that the audio corresponding to the object is output with respect to a second location that is a system selected location that is different from the first location in the three-dimensional environment.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some examples.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some examples.

FIG. 3 is a block diagram illustrating a display generation component of a computer system that is configured to provide a visual component of the XR experience to the user in accordance with some examples.

FIG. 4 is a block diagram illustrating a hand tracking unit of a computer system that is configured to capture gesture inputs of the user in accordance with some examples.

FIG. 5 is a block diagram illustrating an eye tracking unit of a computer system that is configured to capture gaze inputs of the user in accordance with some examples.

FIG. 6 is a flow diagram illustrating a glint-assisted gaze tracking pipeline in accordance with some examples.

FIGS. 7A-7R illustrate exemplary user interfaces for managing controls for changing audio output in accordance with some embodiments.

FIGS. 8A-8B are a flow diagram for illustrating a method for managing controls for changing audio output in accordance with some embodiments.

FIGS. 9A-9H illustrate exemplary user interfaces for managing the prominence of audio in accordance with some embodiments.

FIG. 10 is a flow diagram for illustrating a method for managing the prominence of audio in accordance with some embodiments.

FIGS. 11A-11F illustrate exemplary user interfaces for managing audio output based on distance in accordance with some embodiments.

FIG. 12 is a flow diagram for illustrating a method for managing audio output based on a viewpoint of a user in accordance with some embodiments.

FIG. 13 is a flow diagram for illustrating a method for managing a virtual sound stage in accordance with some embodiments.

FIGS. 14A-14K illustrate exemplary user interfaces for outputting audio at one or more locations in accordance with some embodiments.

FIG. 15 is a flow diagram for illustrating a method for outputting audio at one or more locations in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

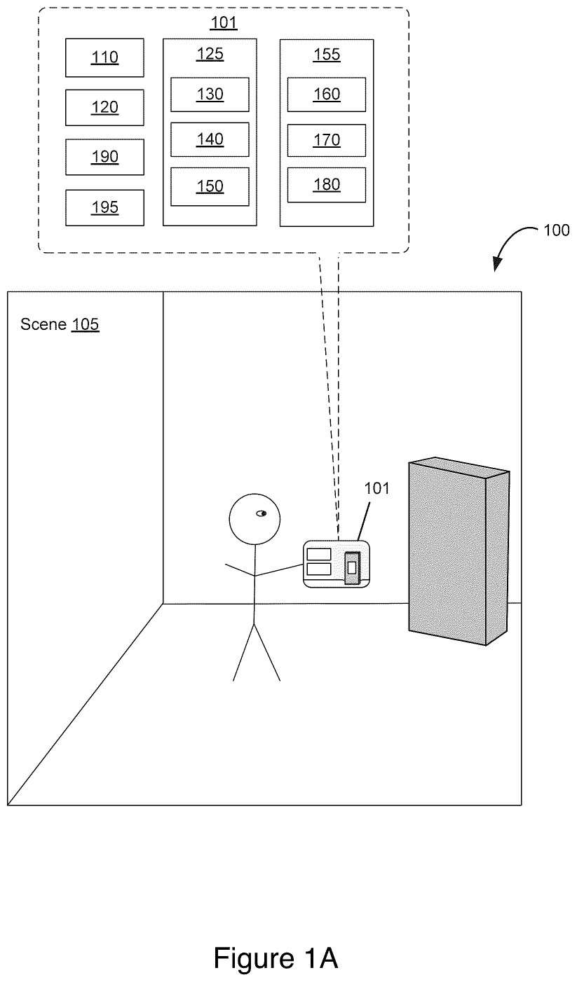

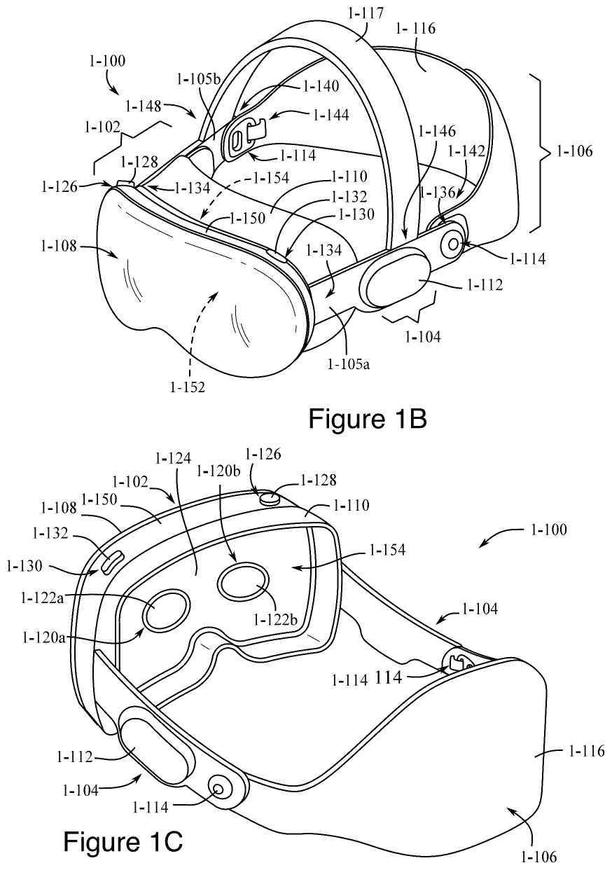

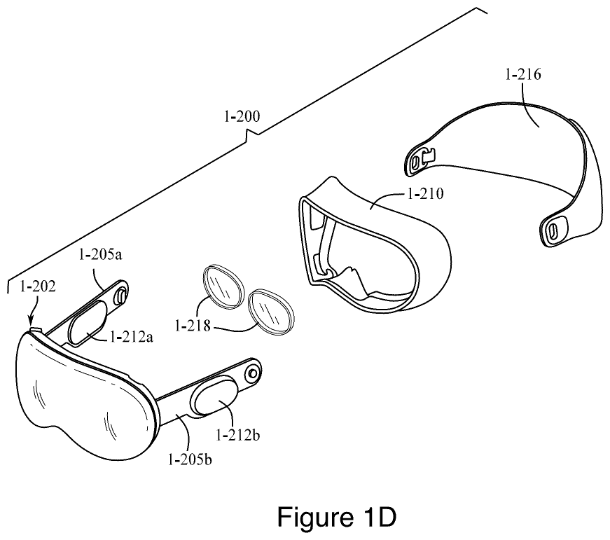

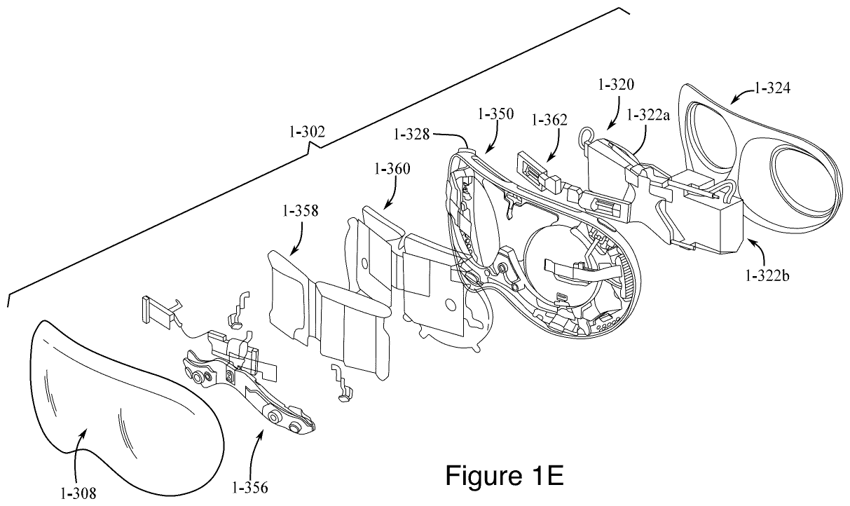

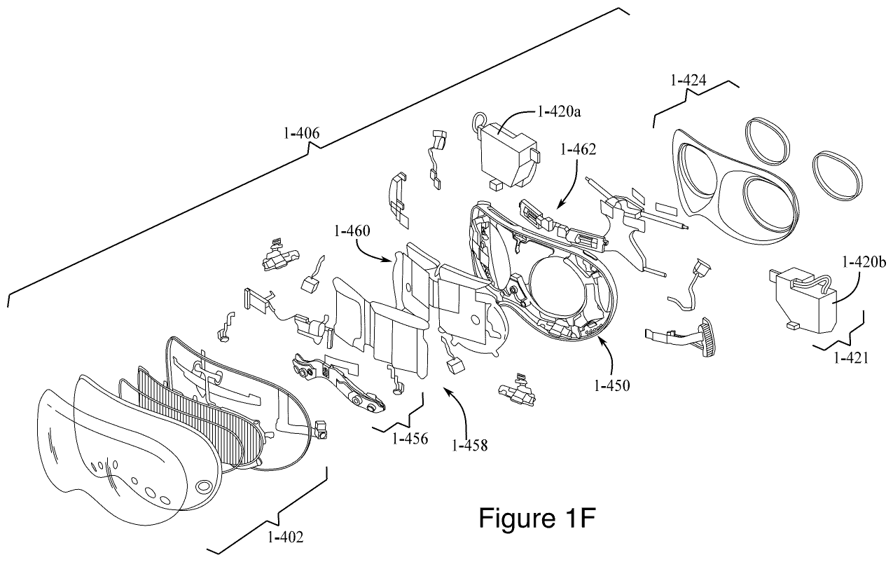

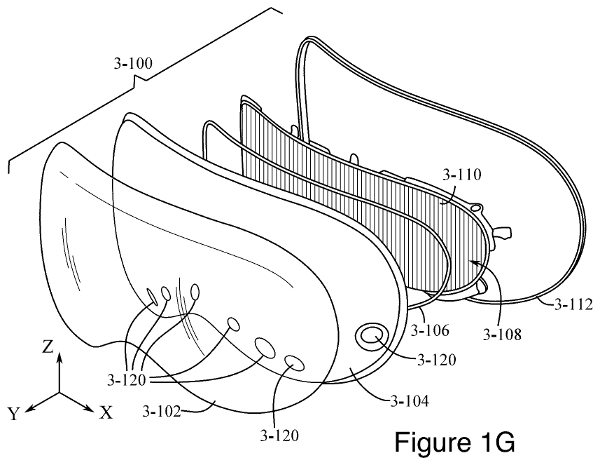

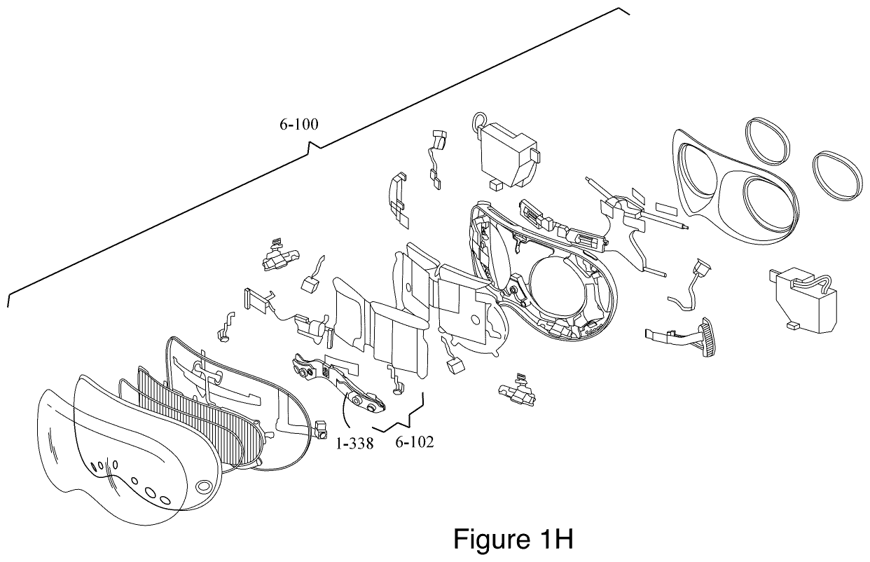

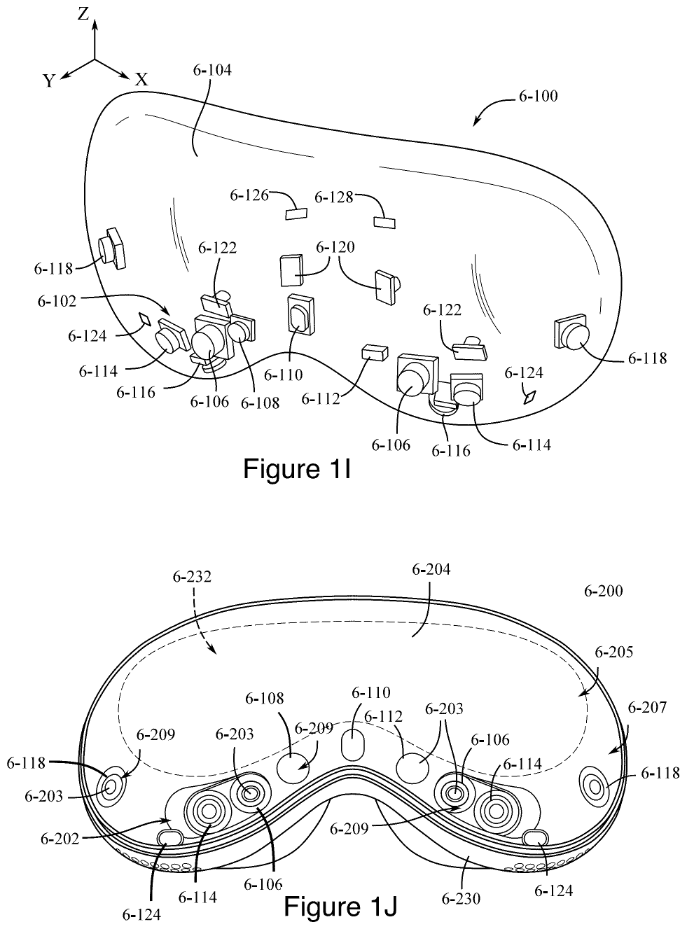

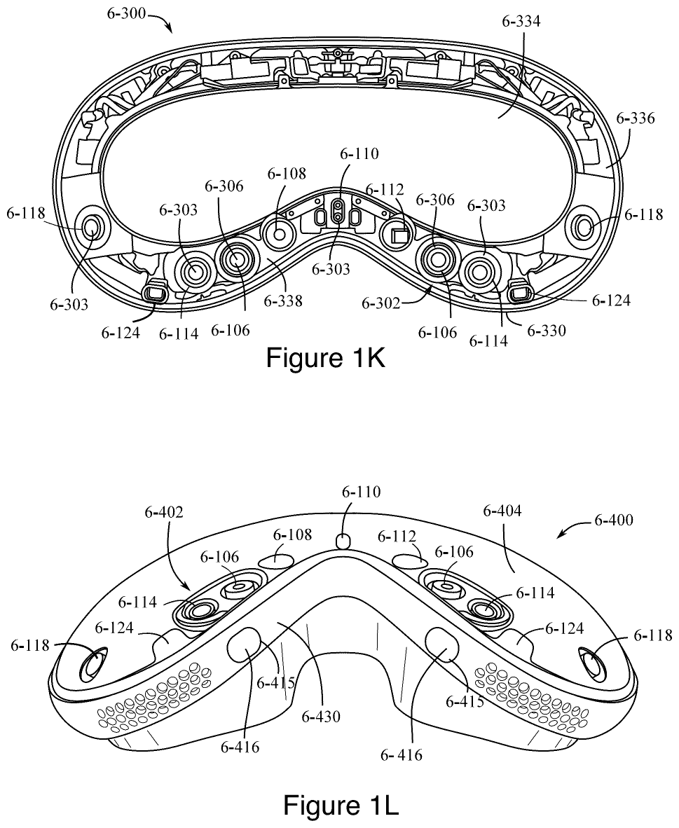

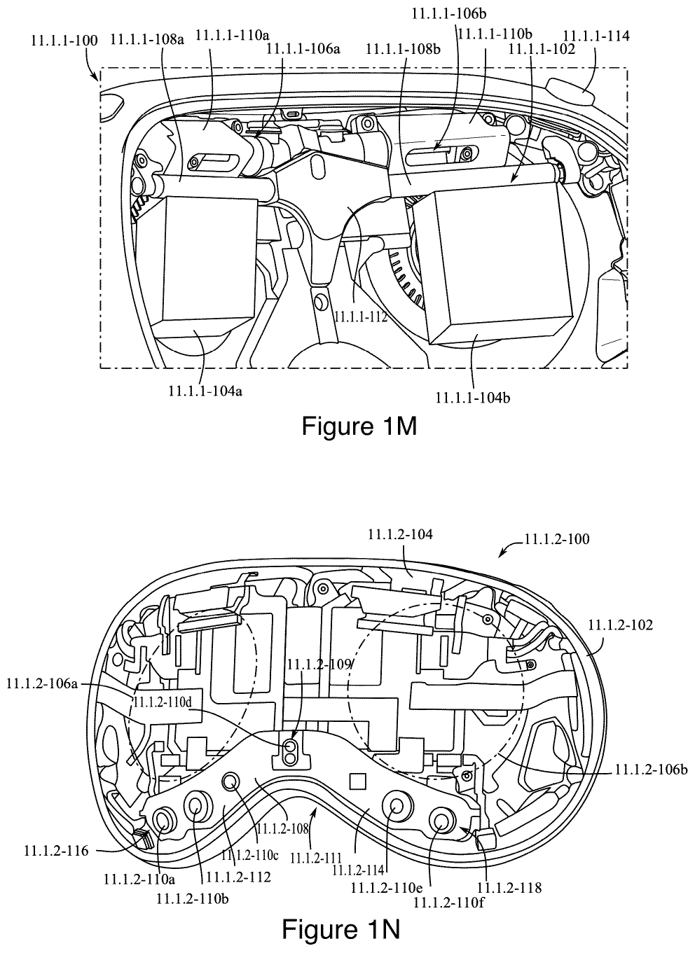

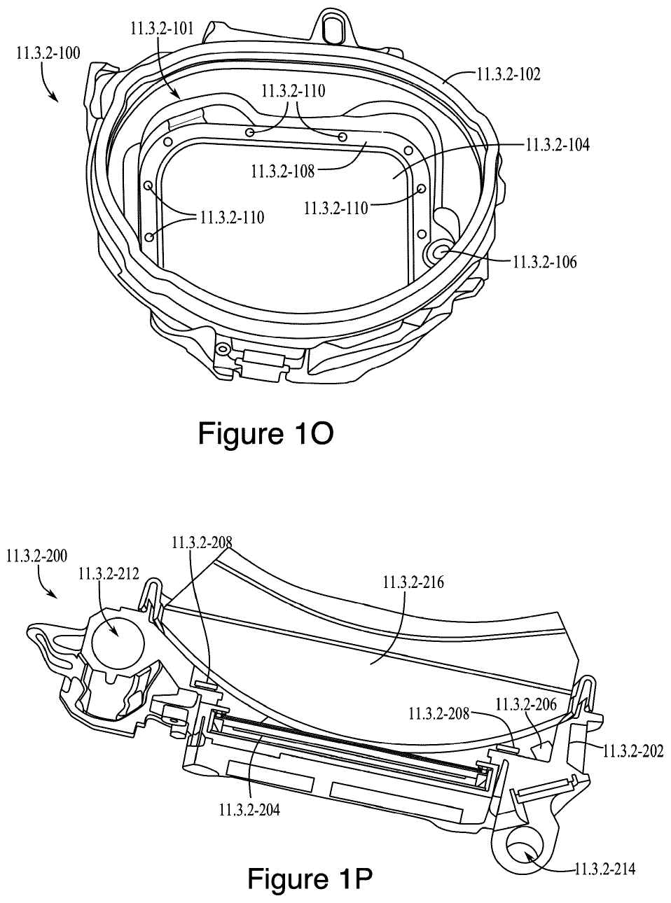

FIGS. 1A-6 provide a description of example computer systems for providing XR experiences to users (such as described below with respect to methods 800, 1000, 1200, 1300, and 1500).

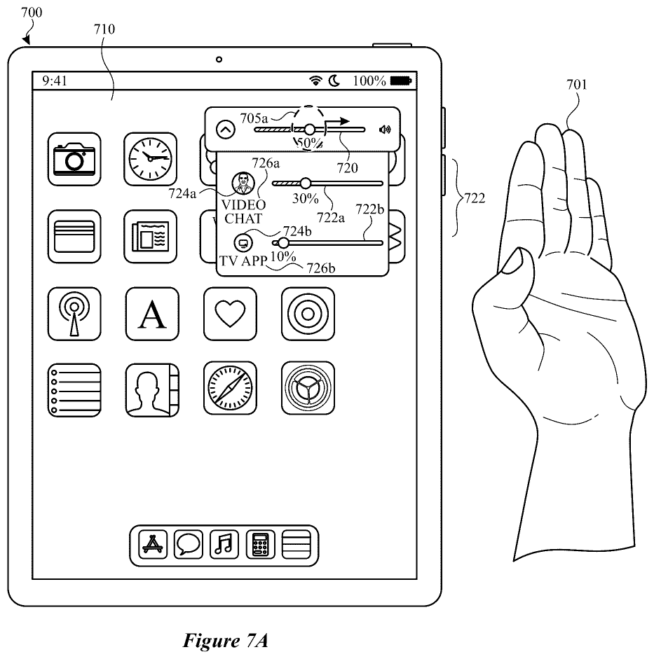

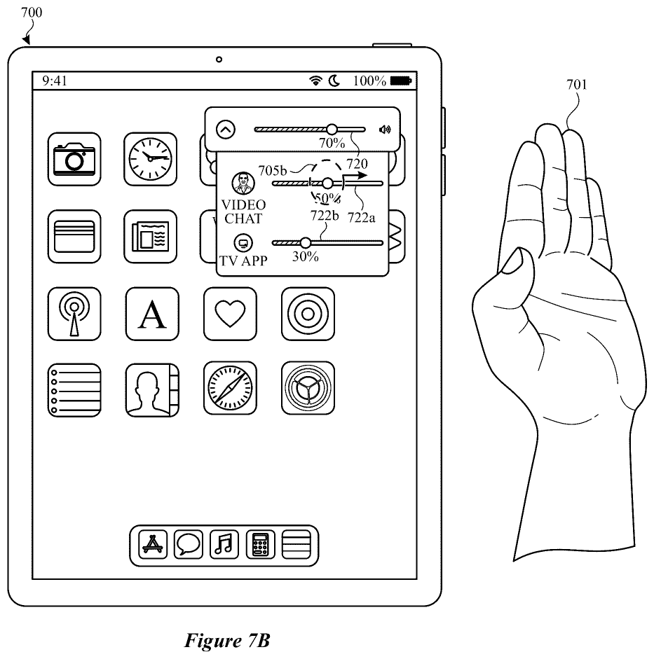

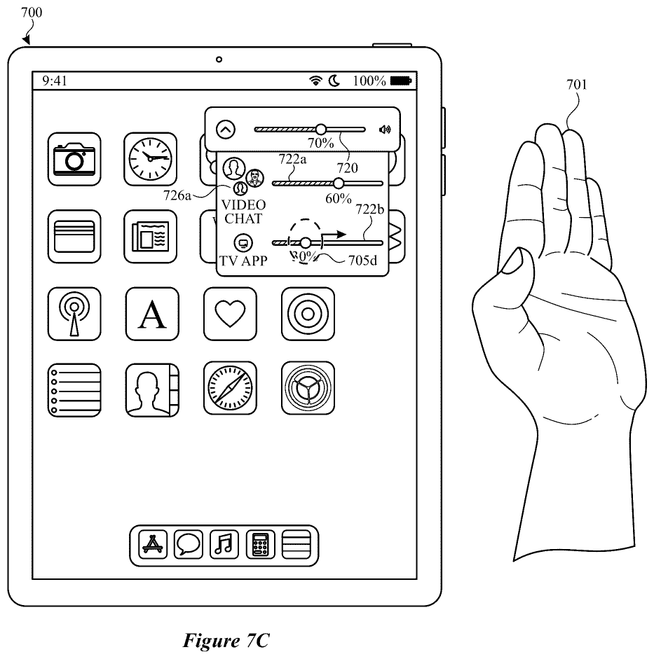

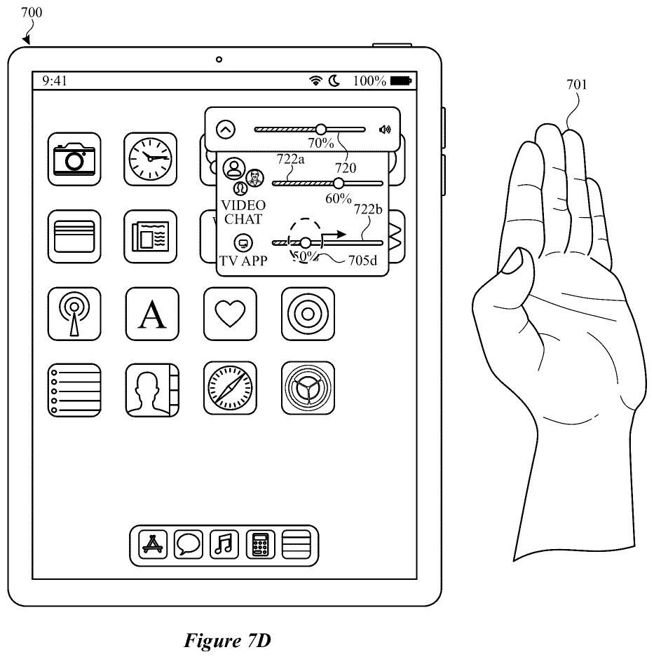

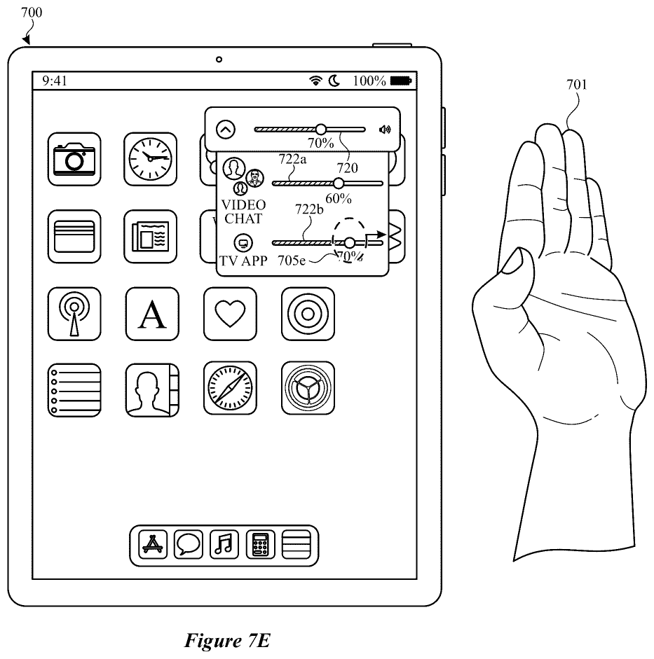

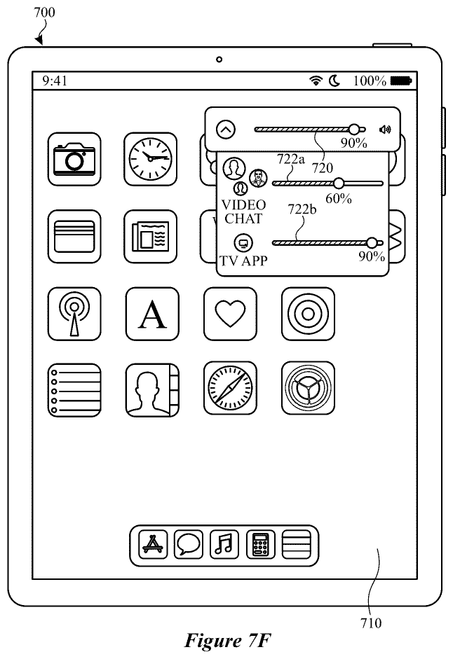

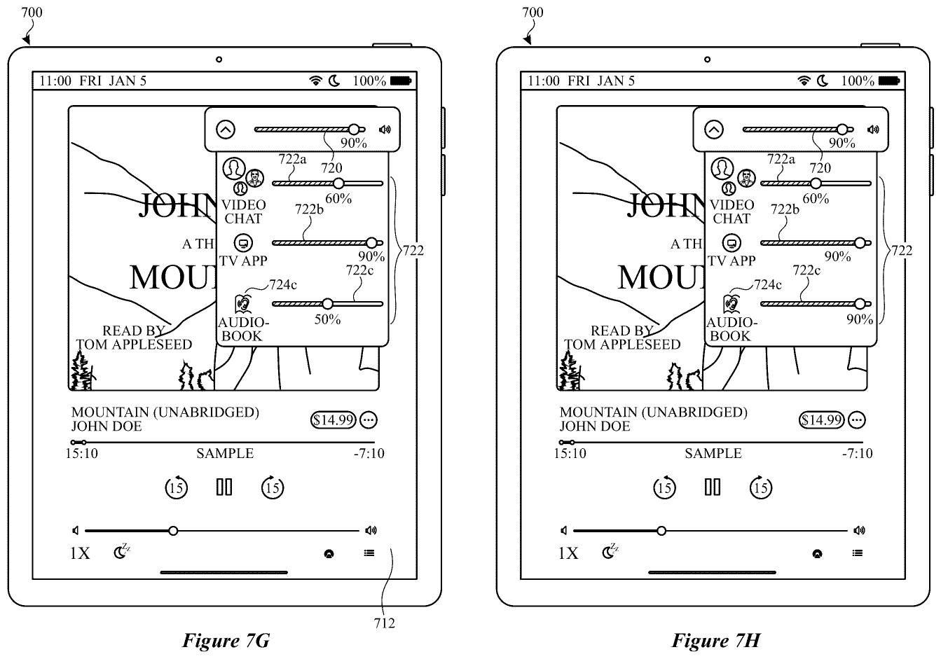

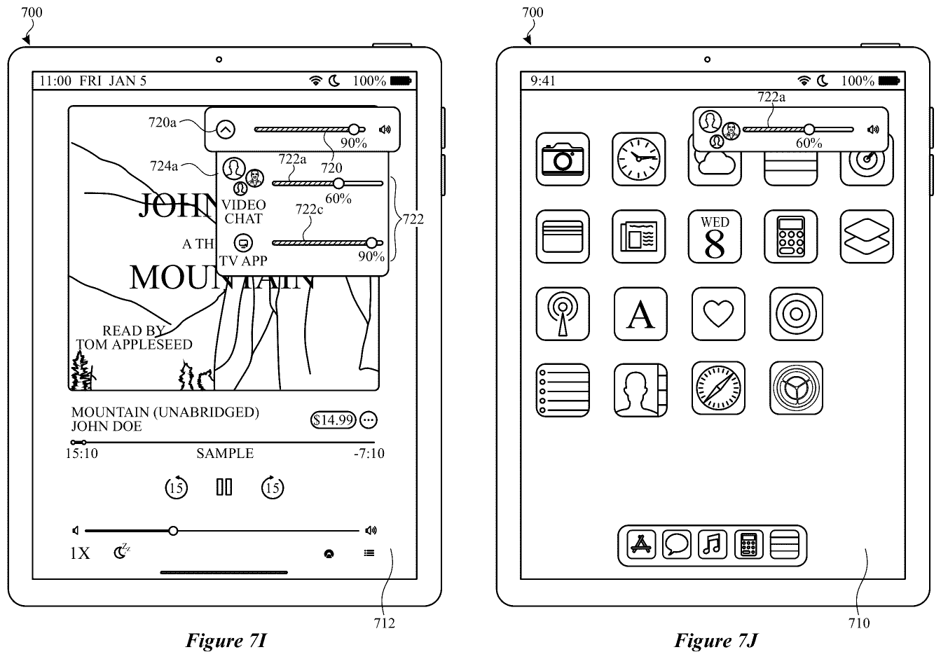

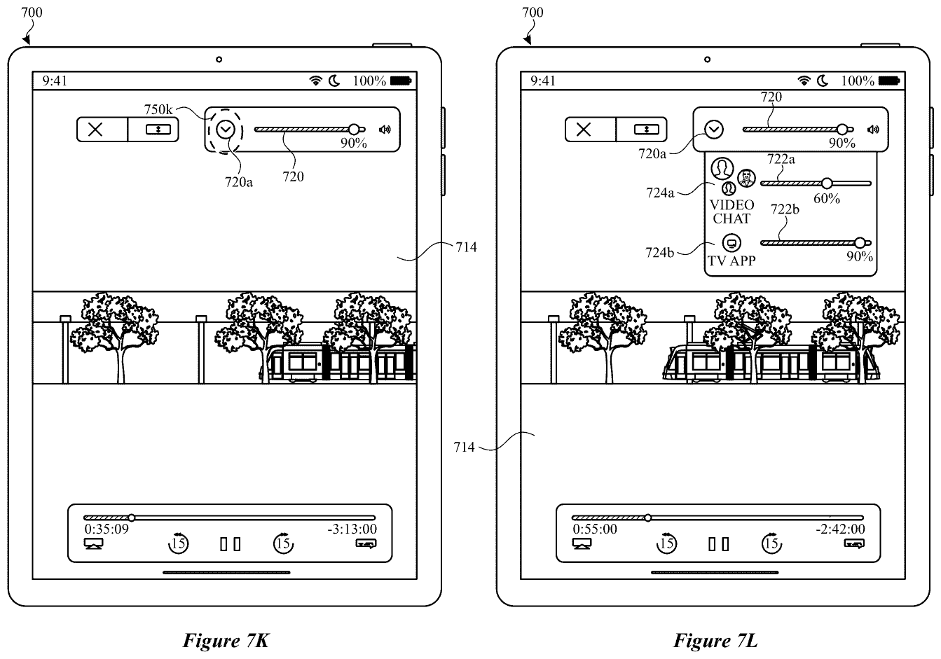

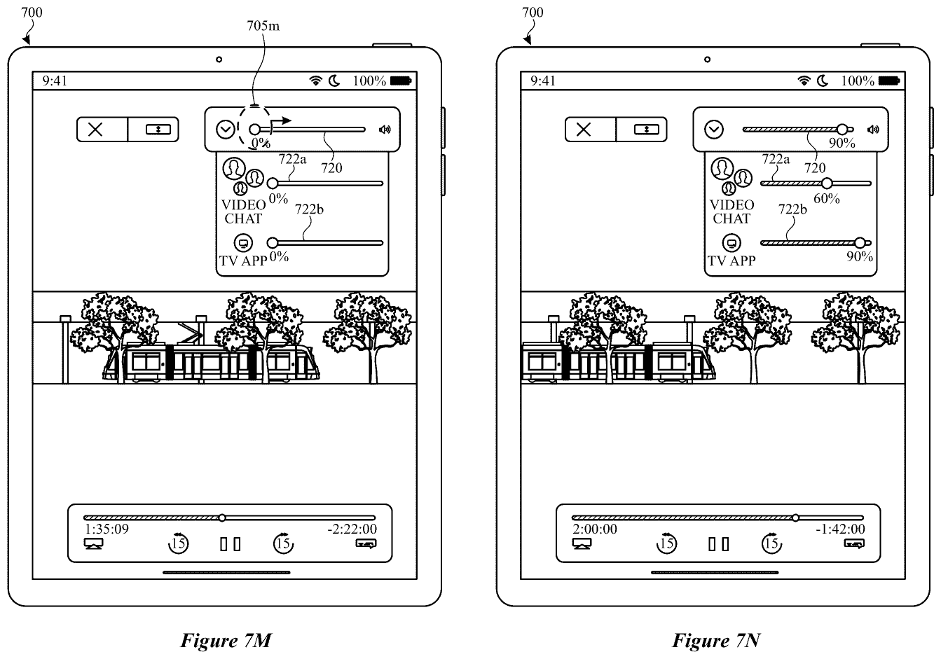

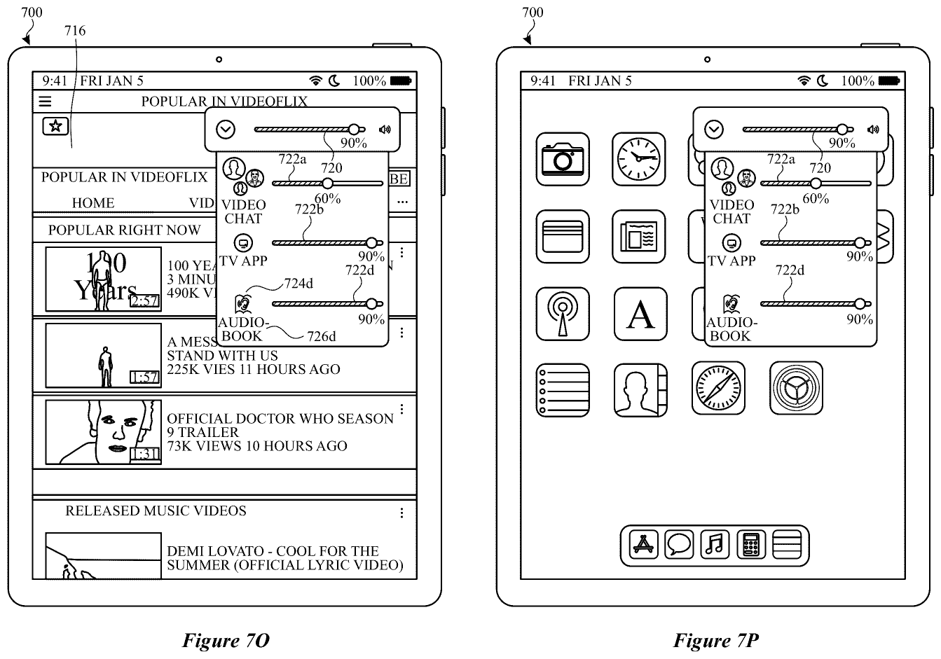

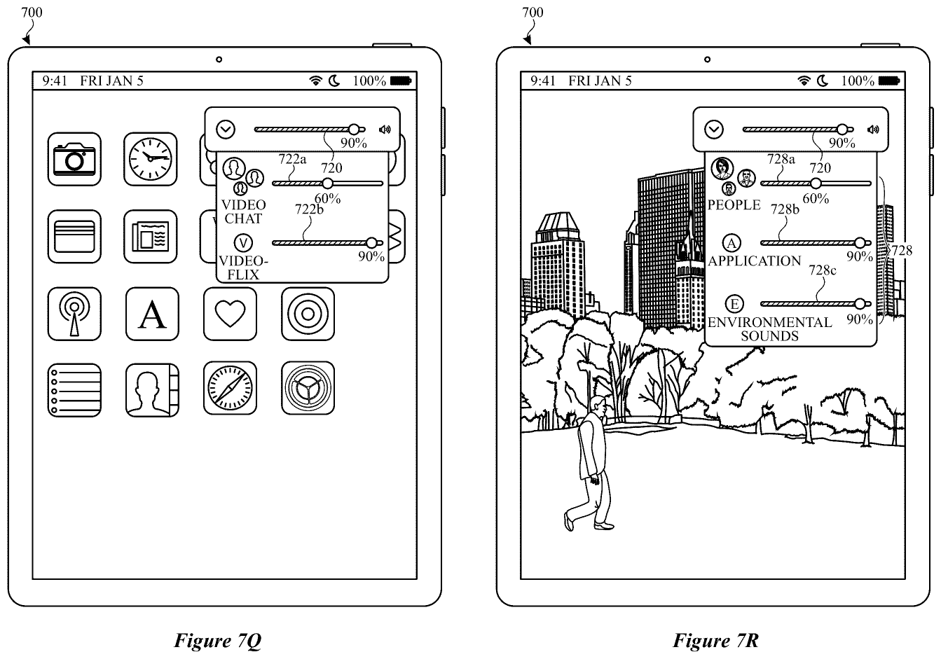

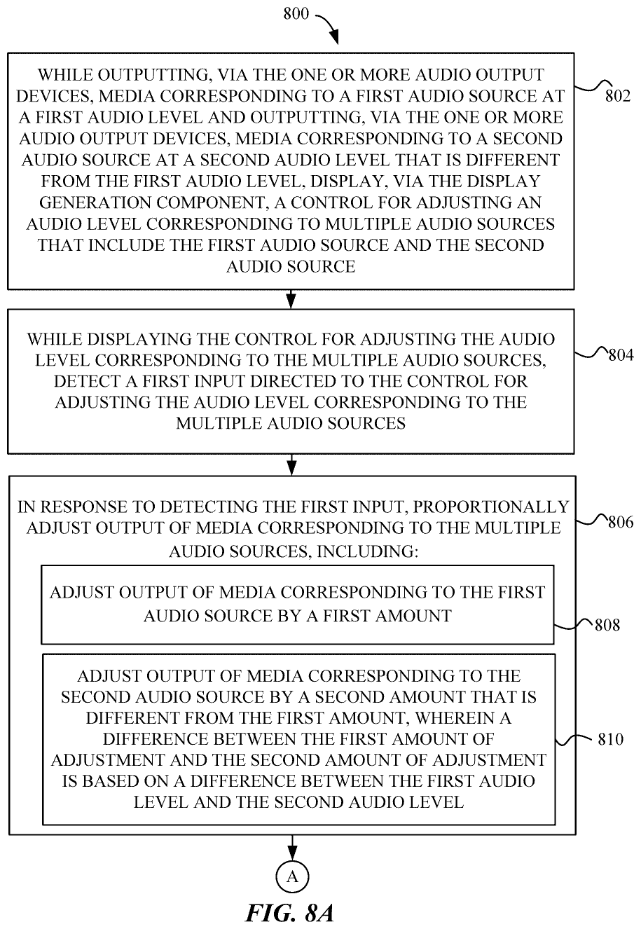

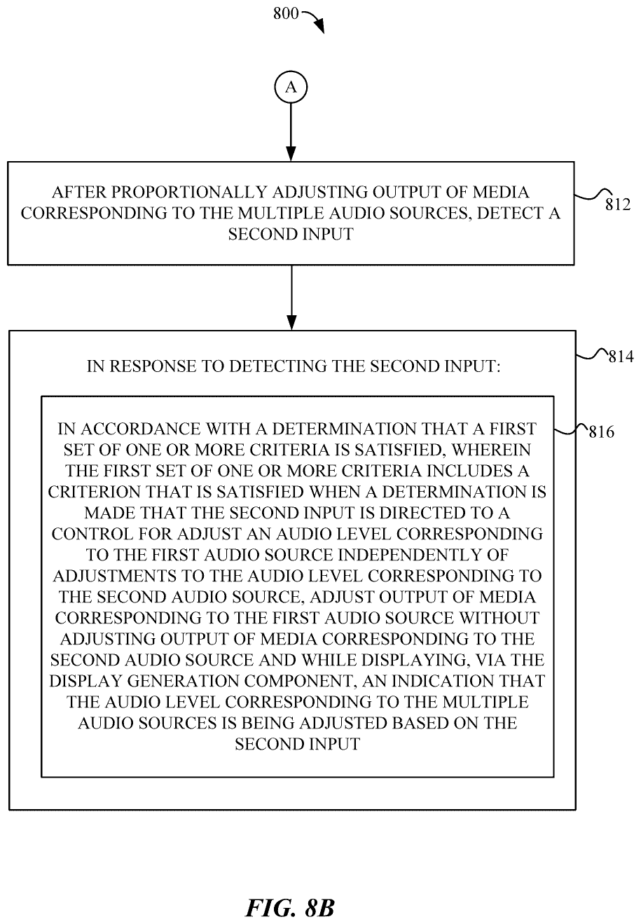

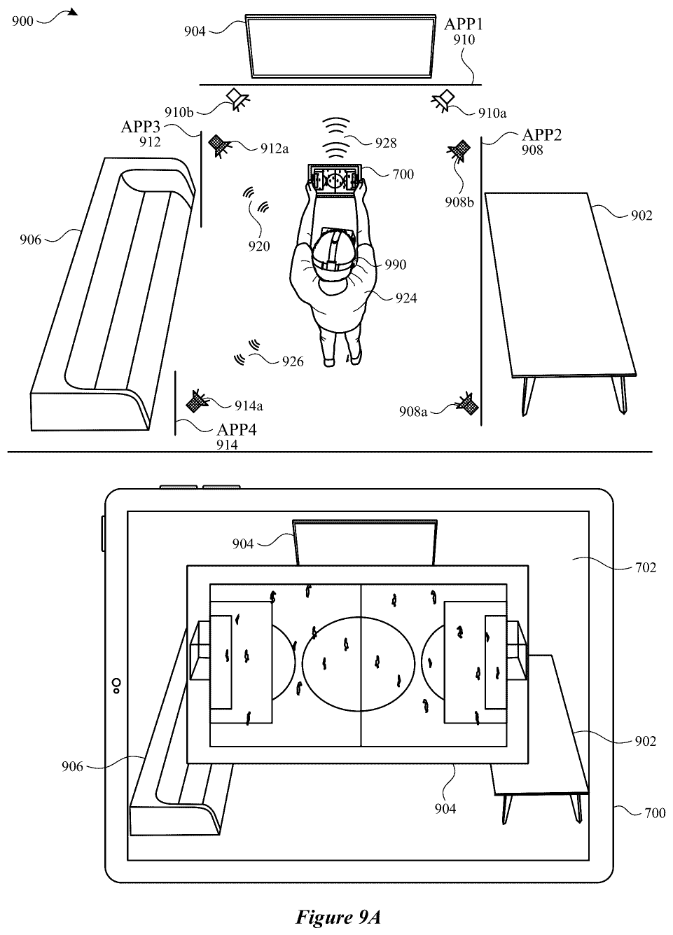

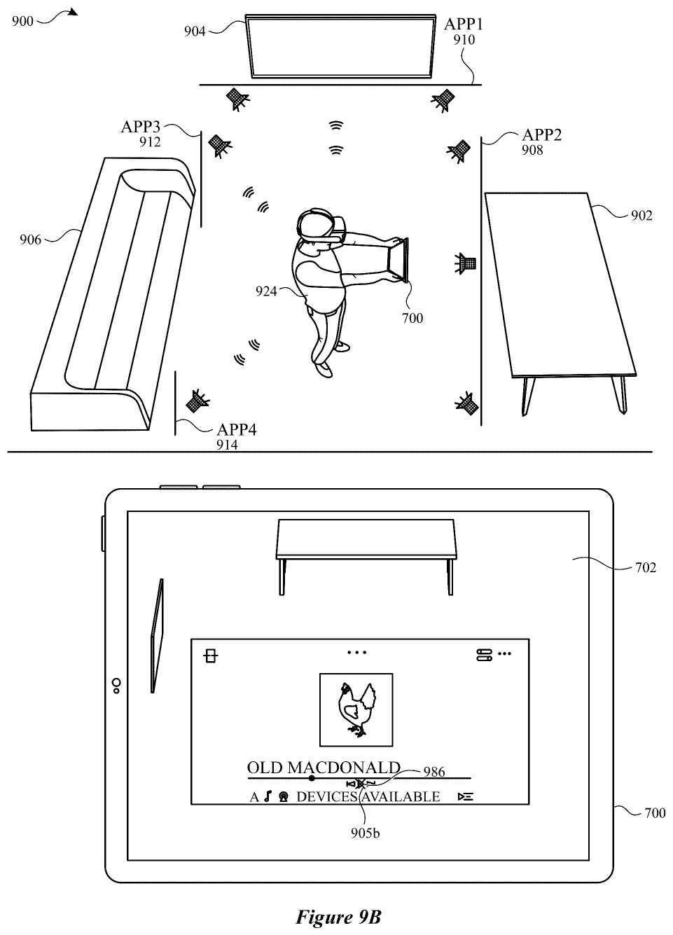

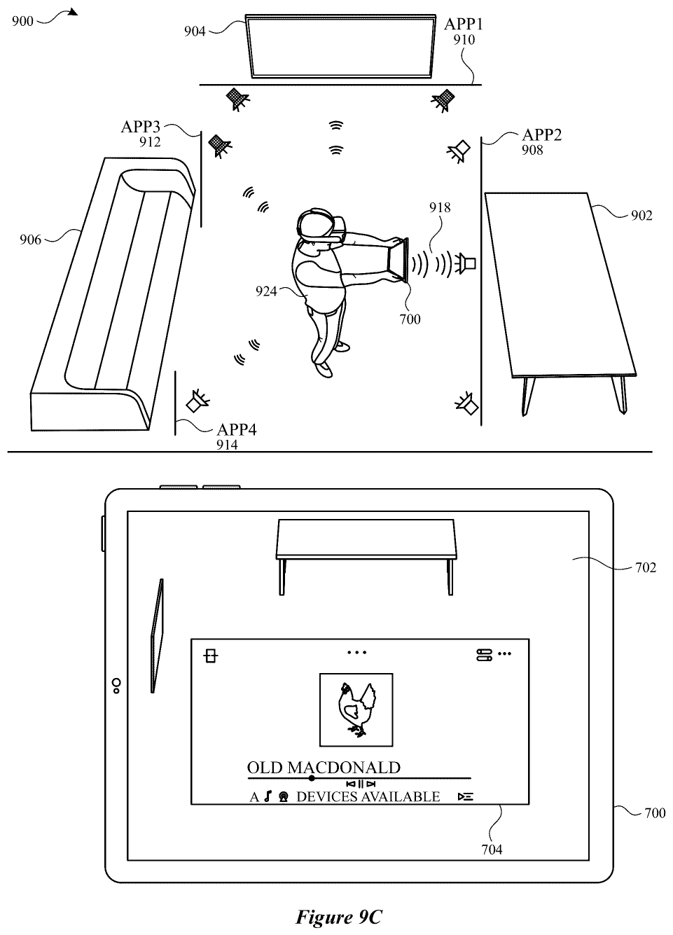

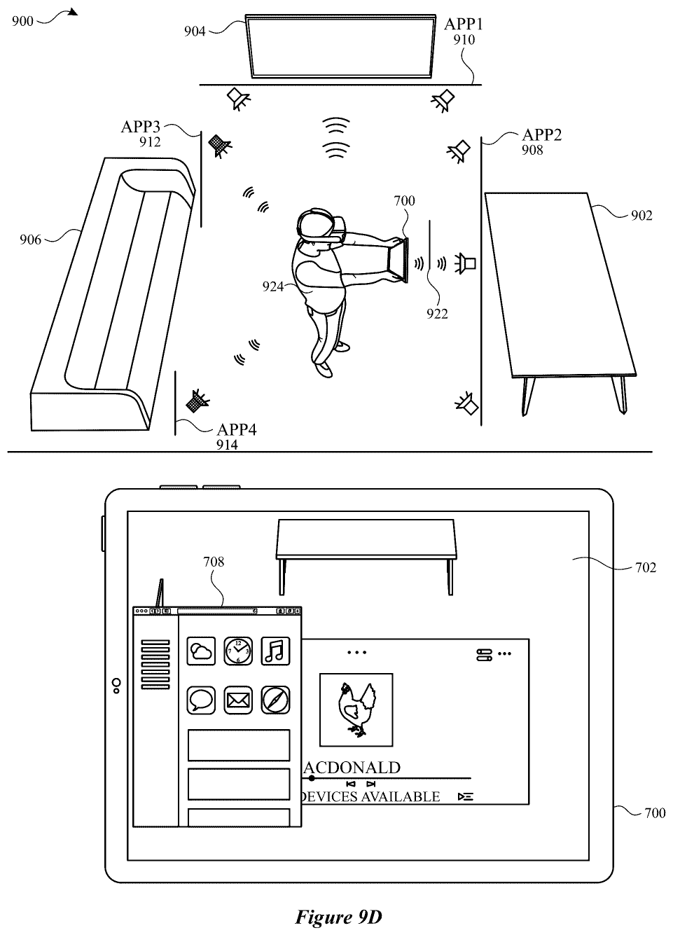

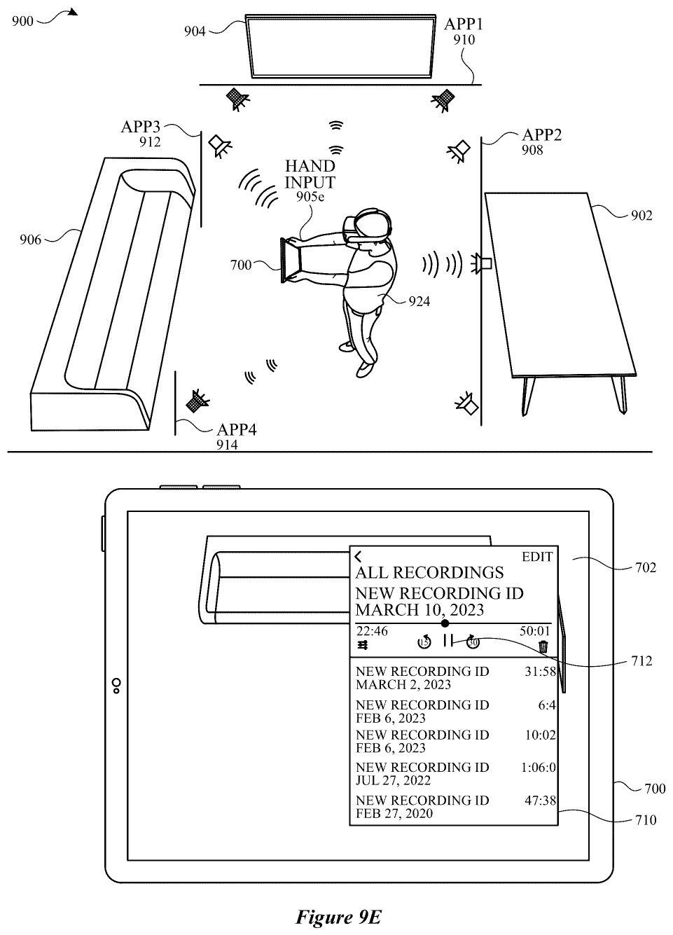

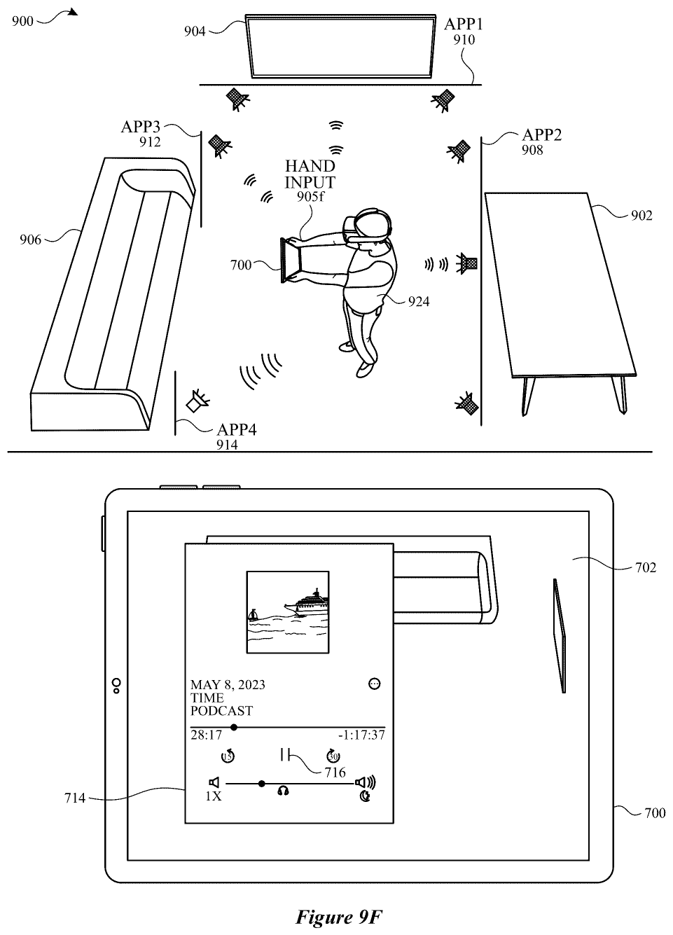

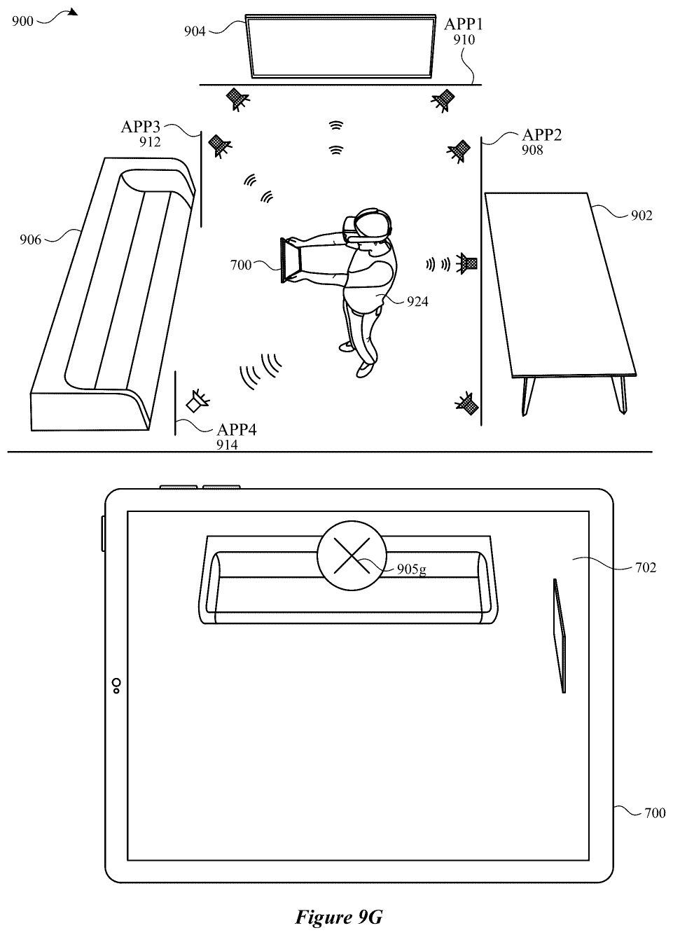

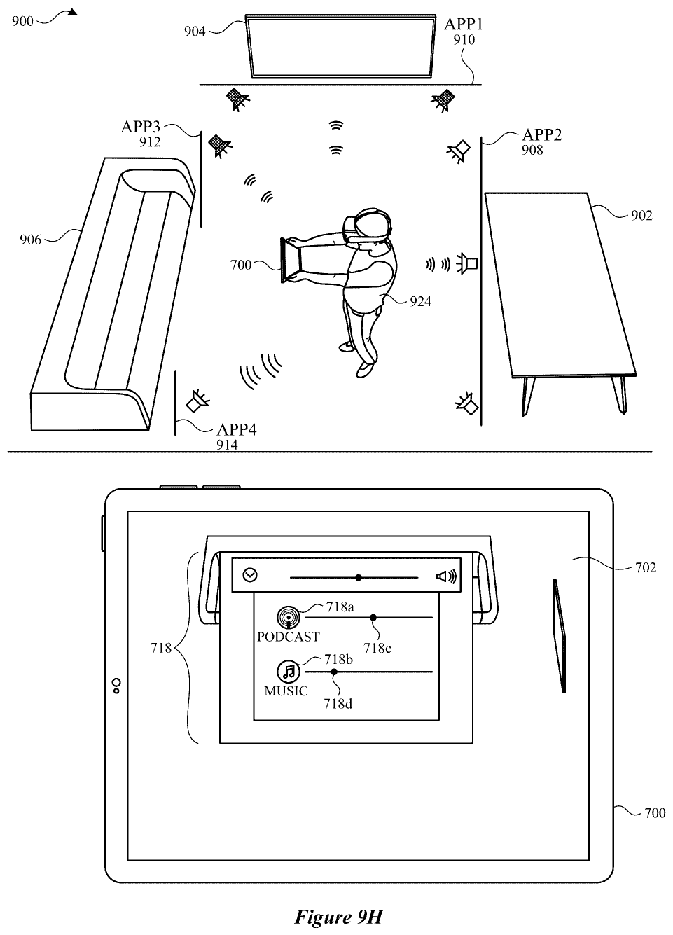

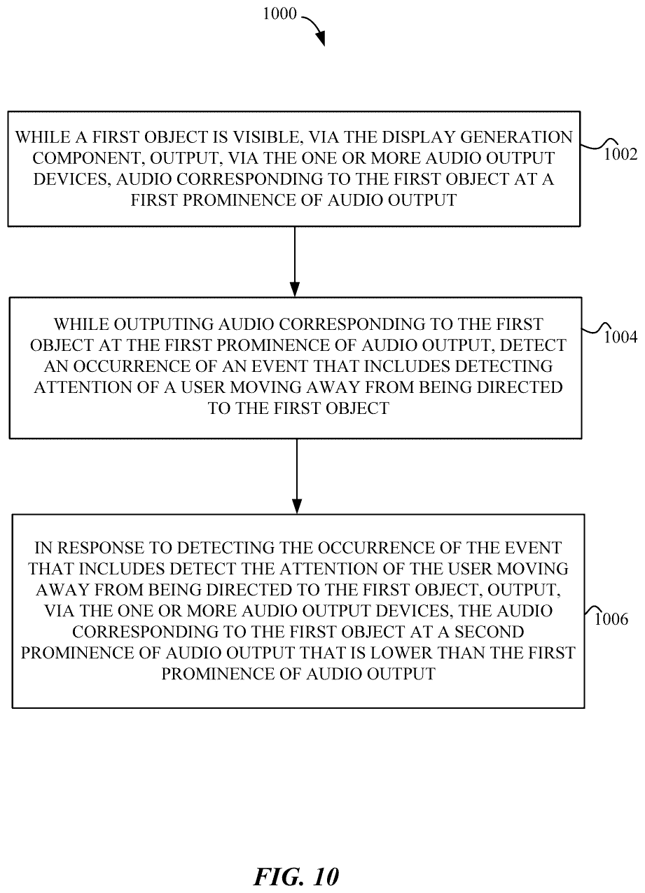

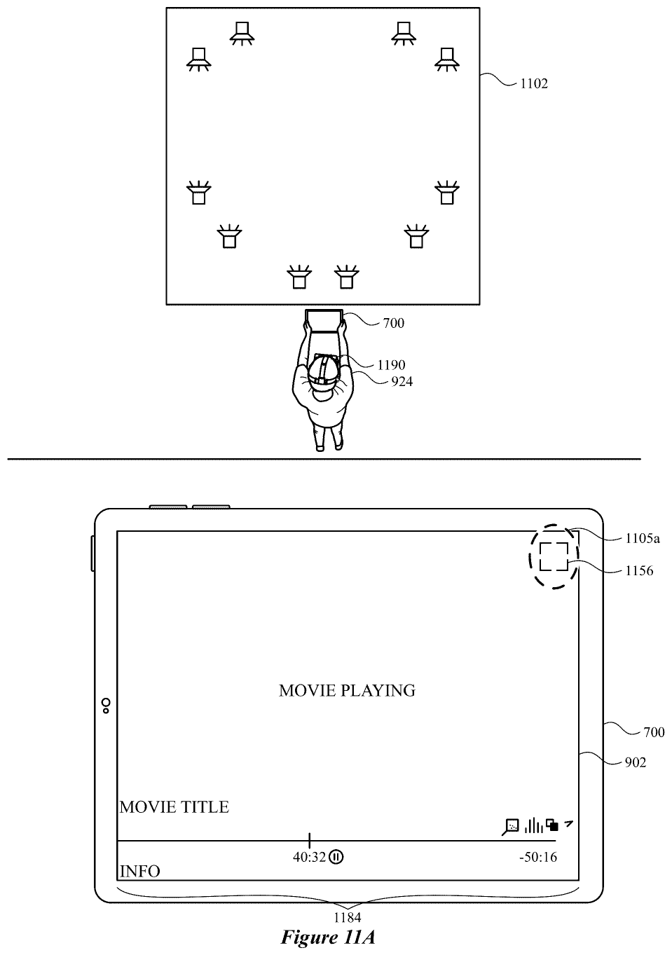

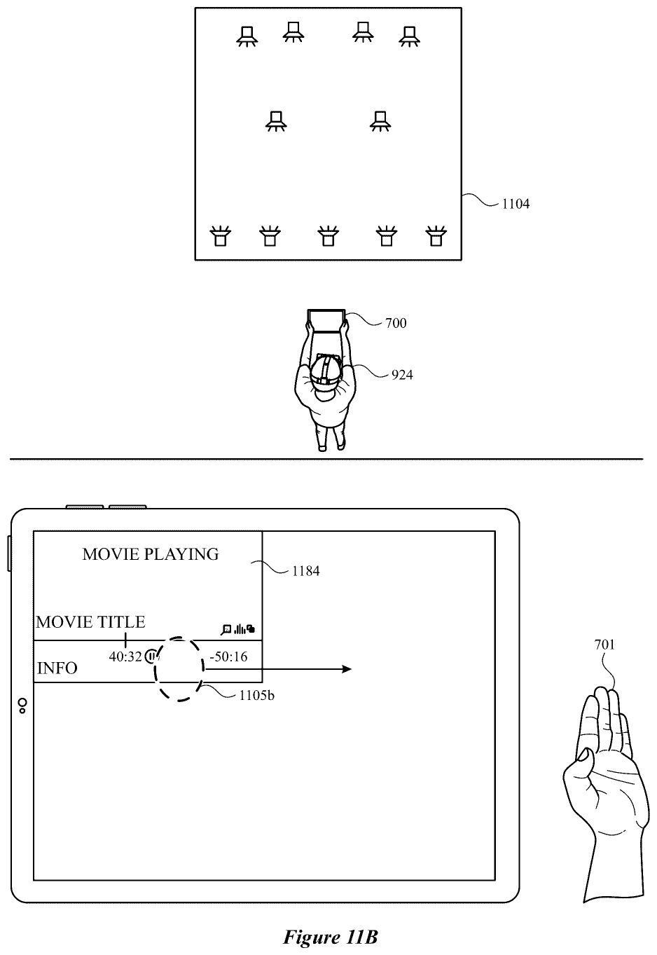

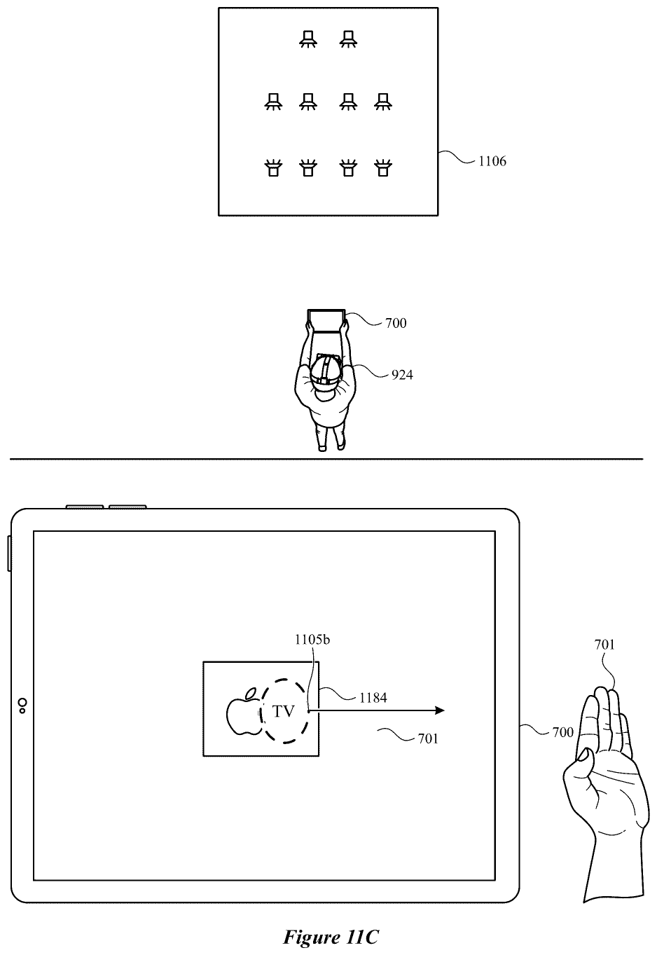

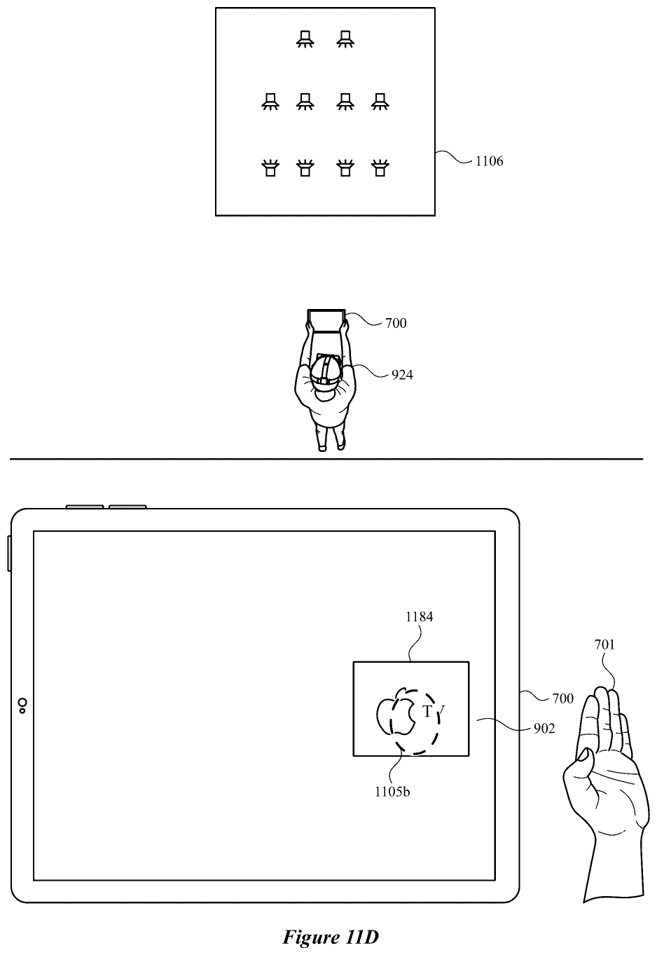

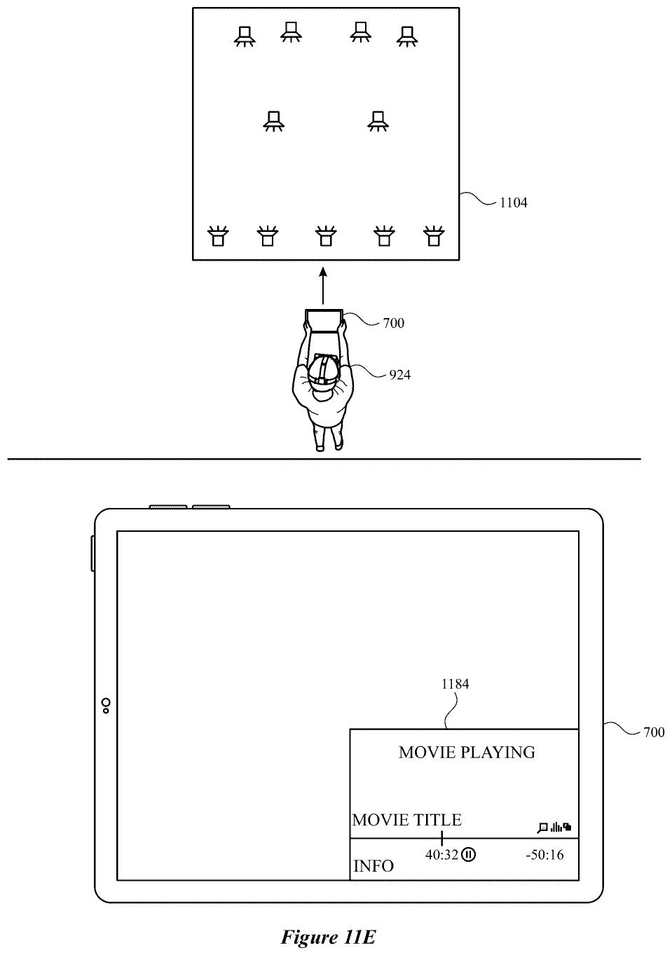

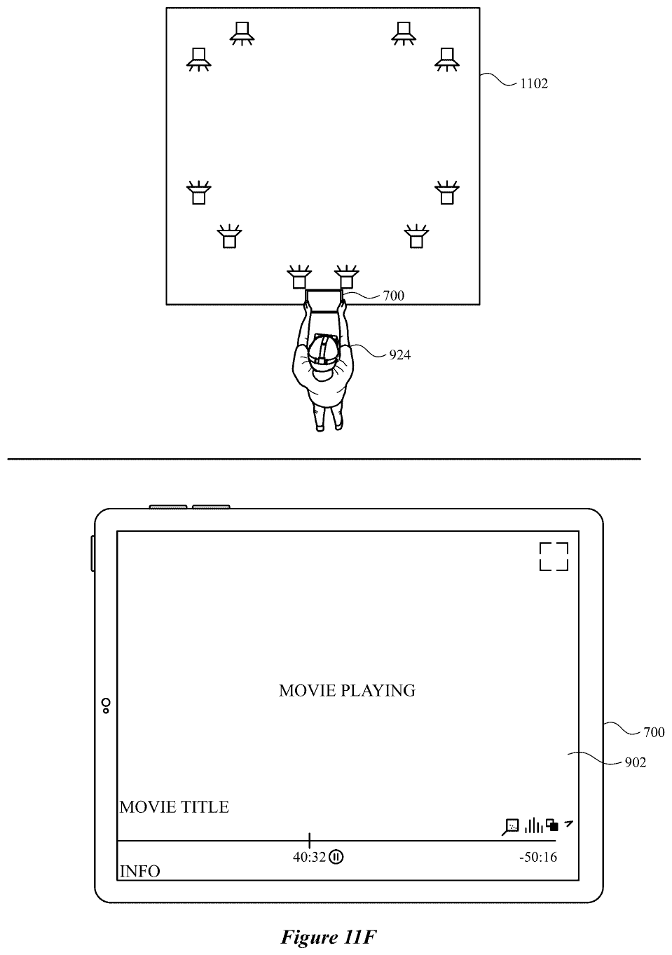

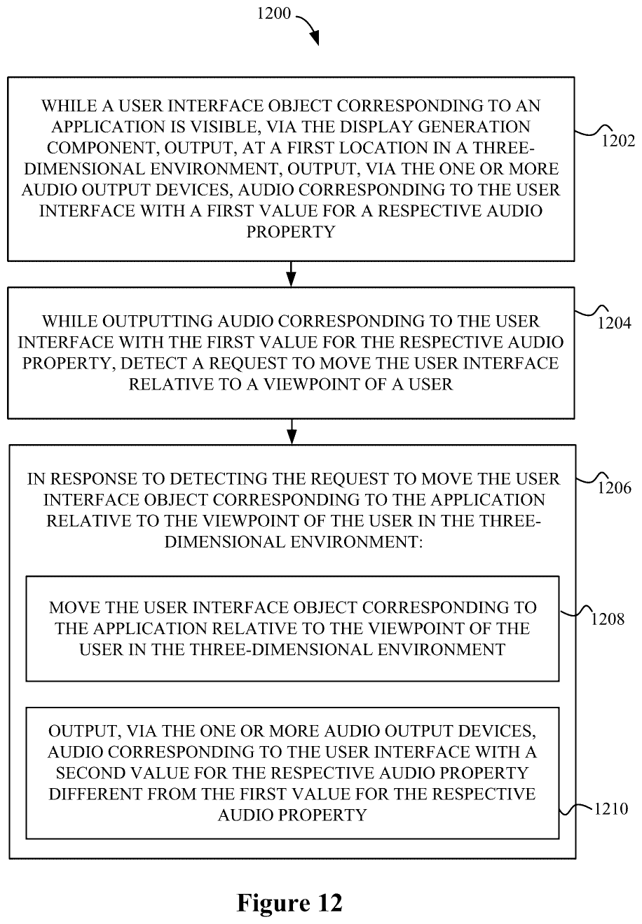

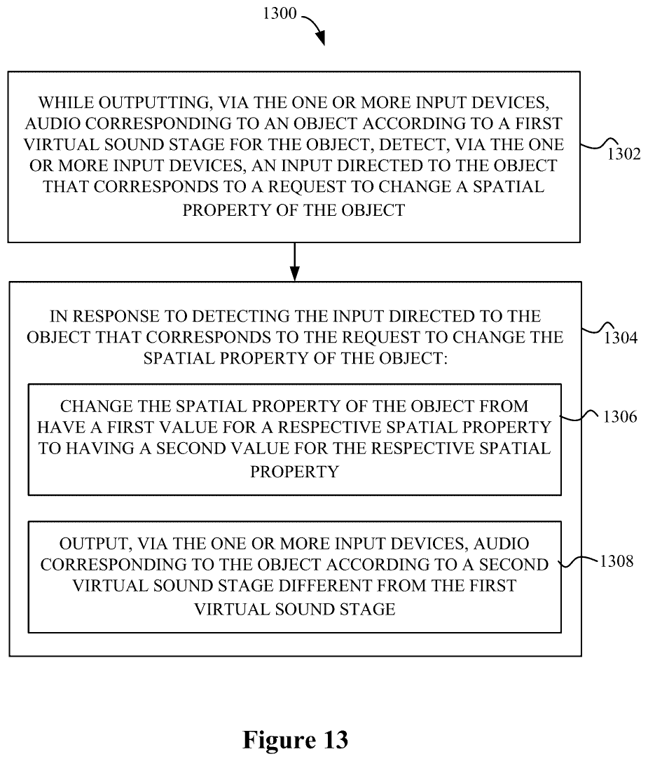

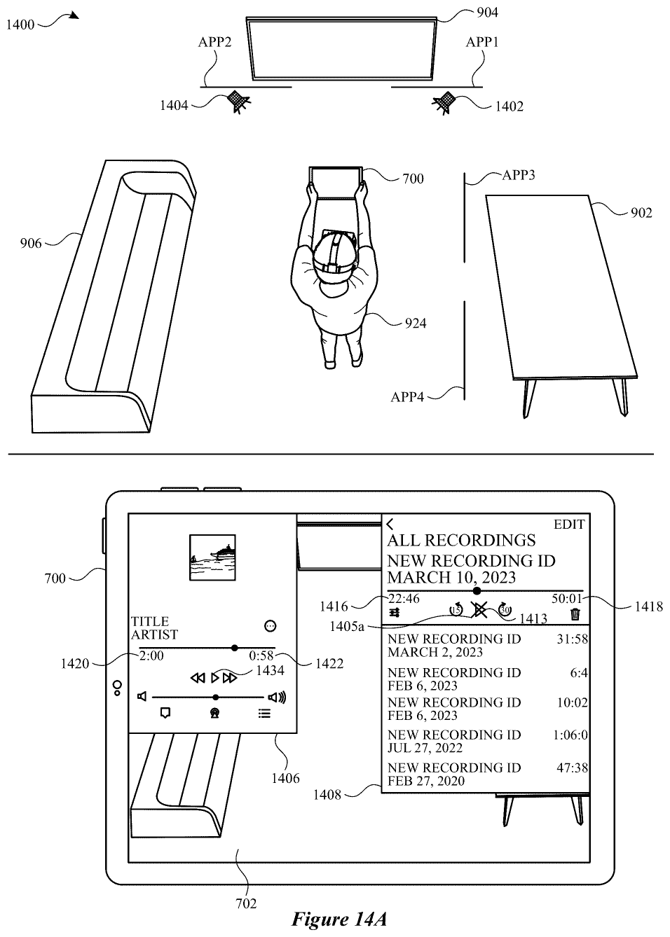

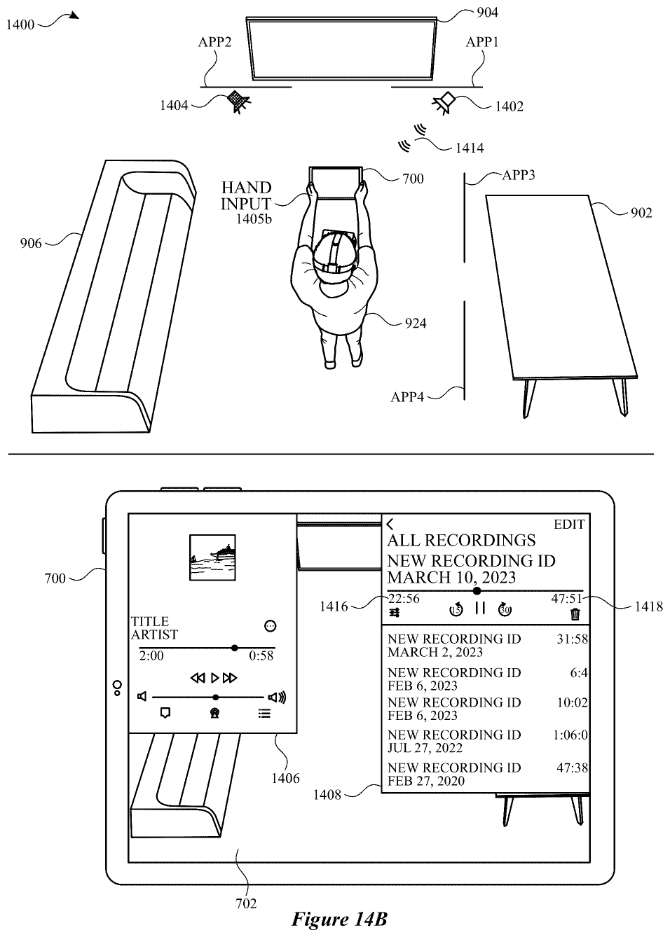

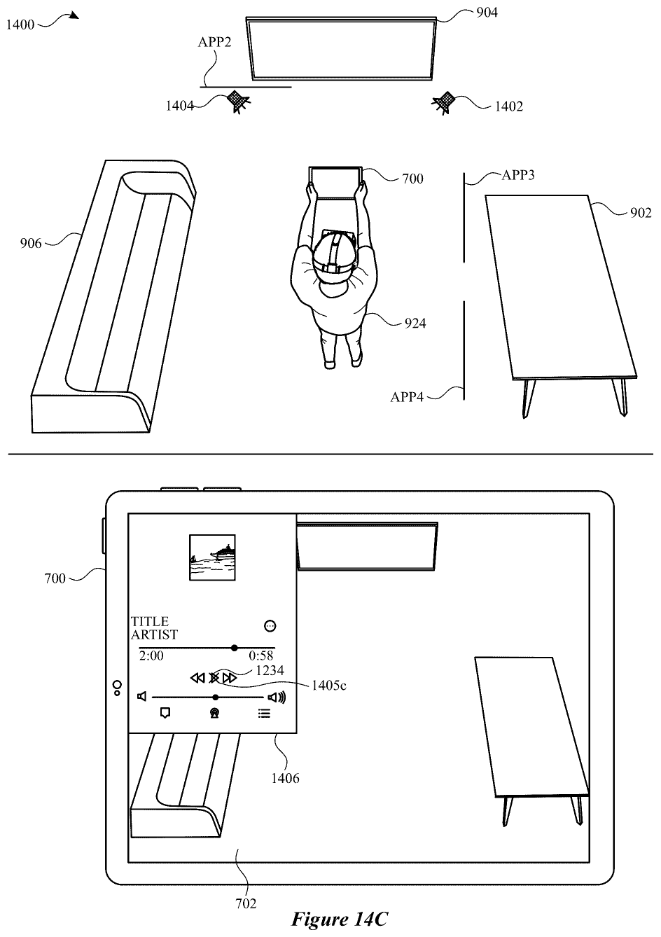

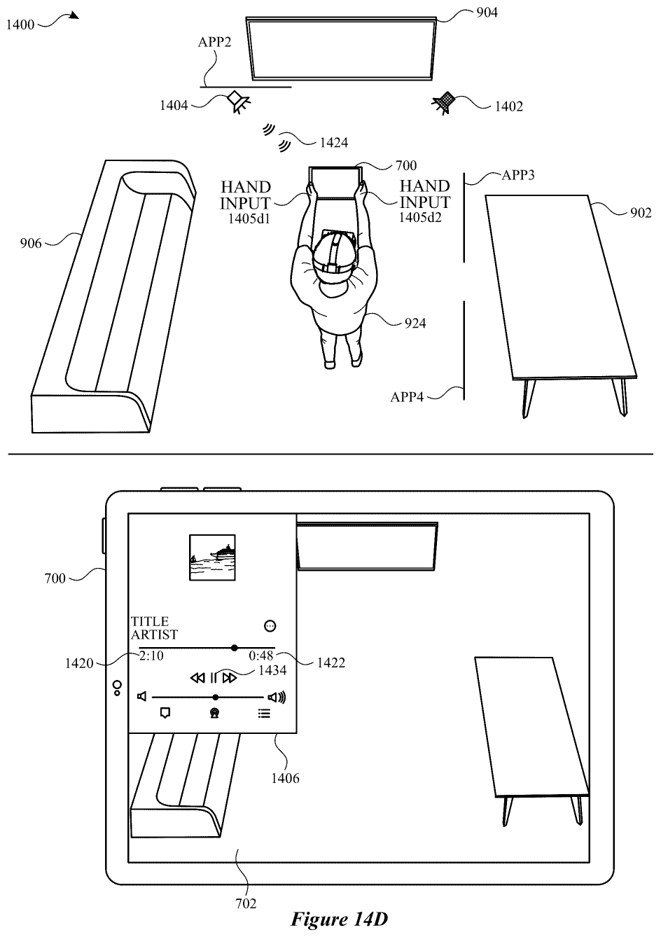

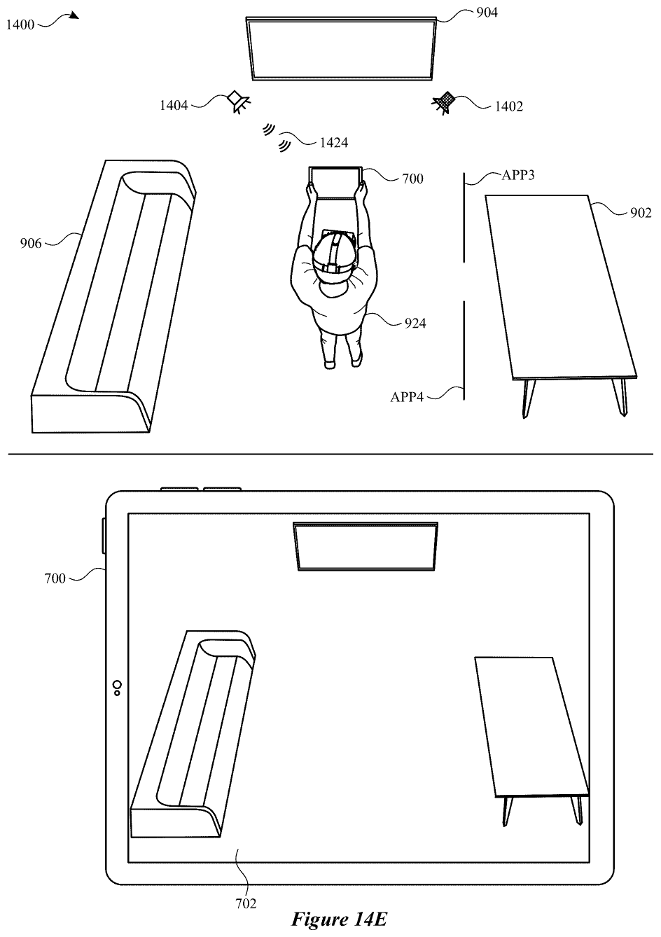

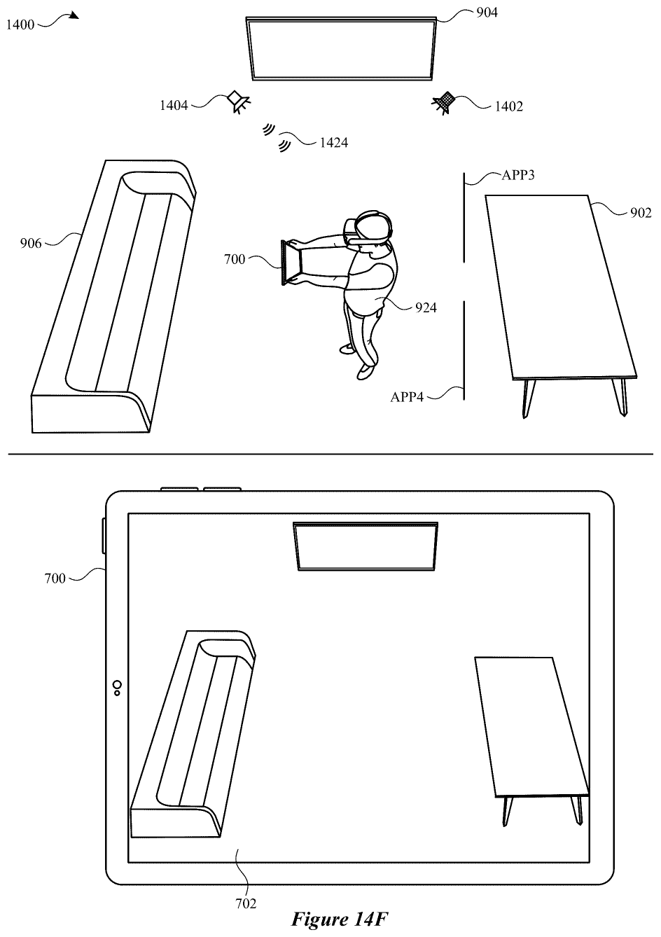

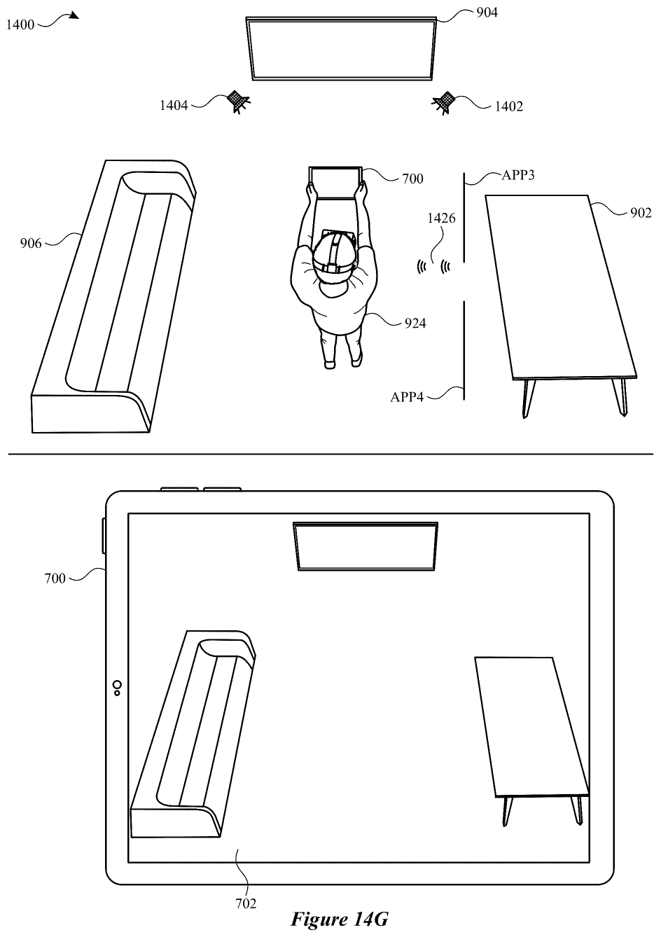

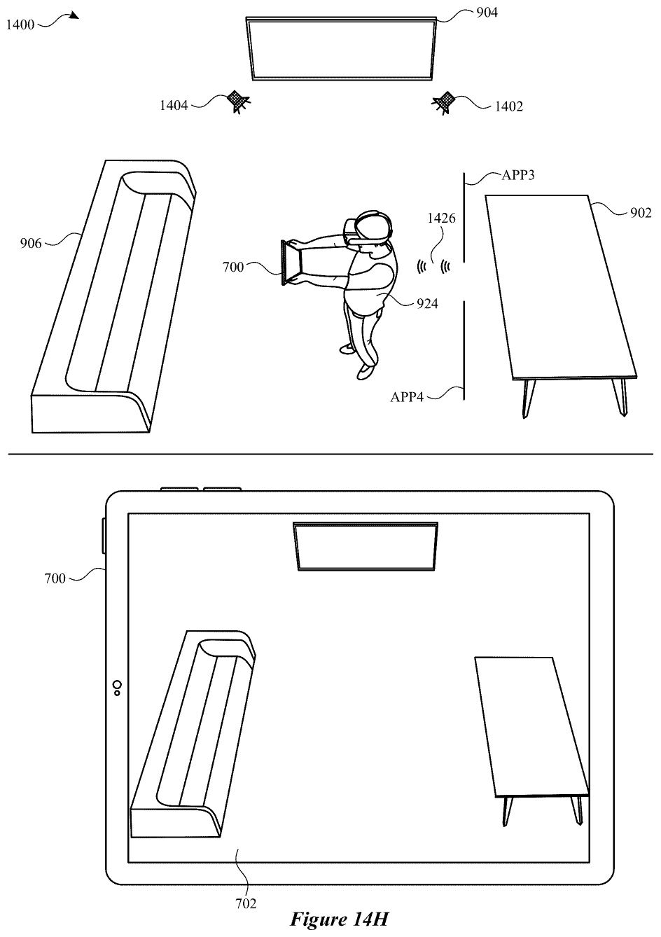

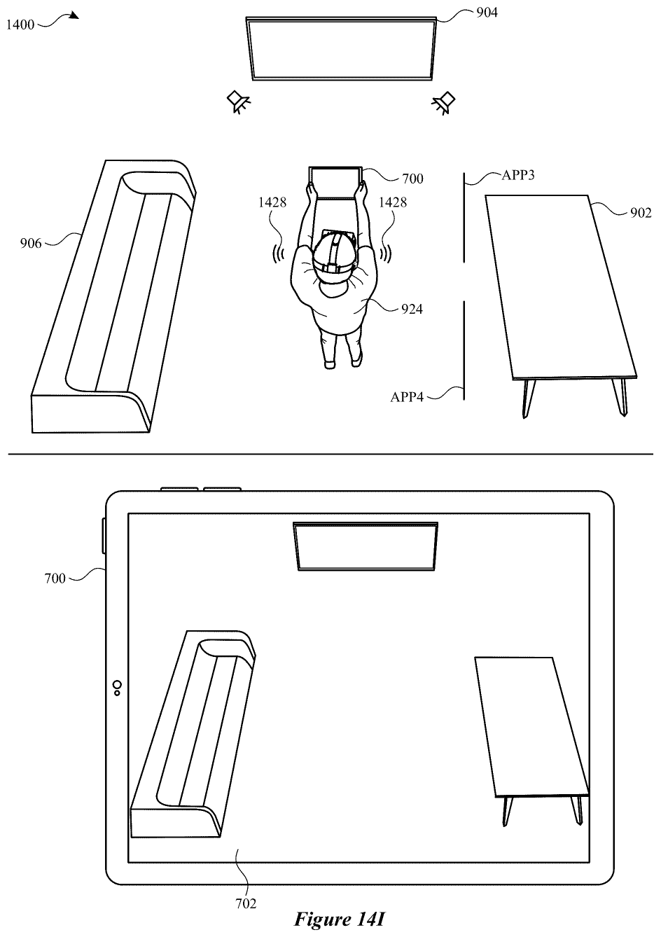

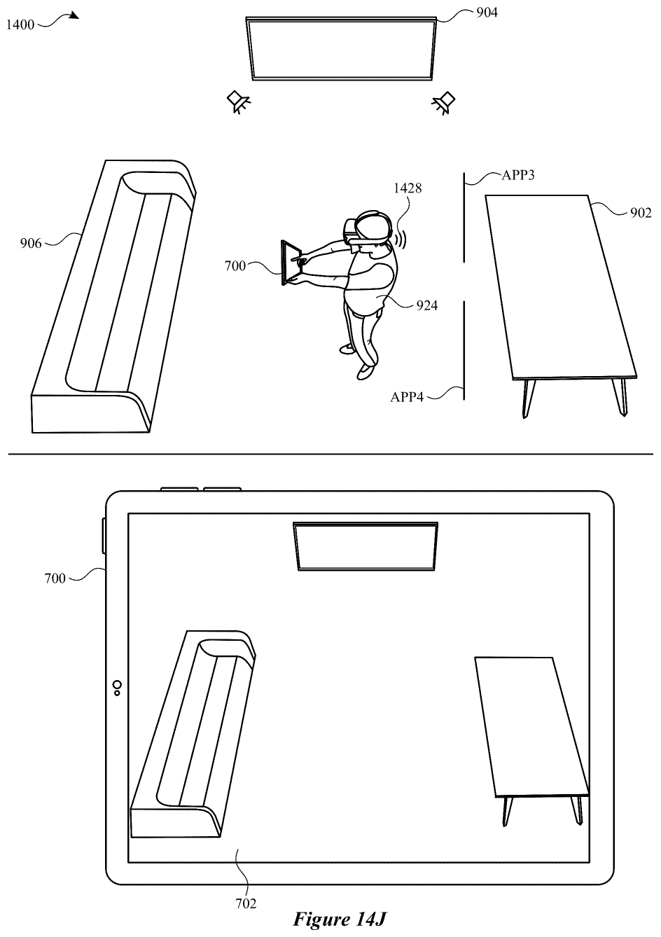

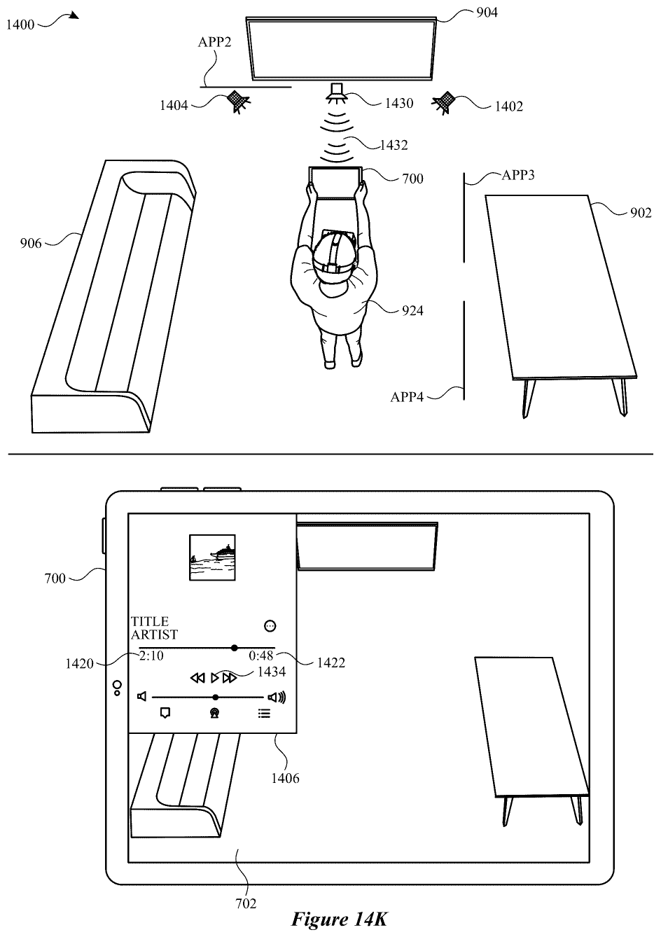

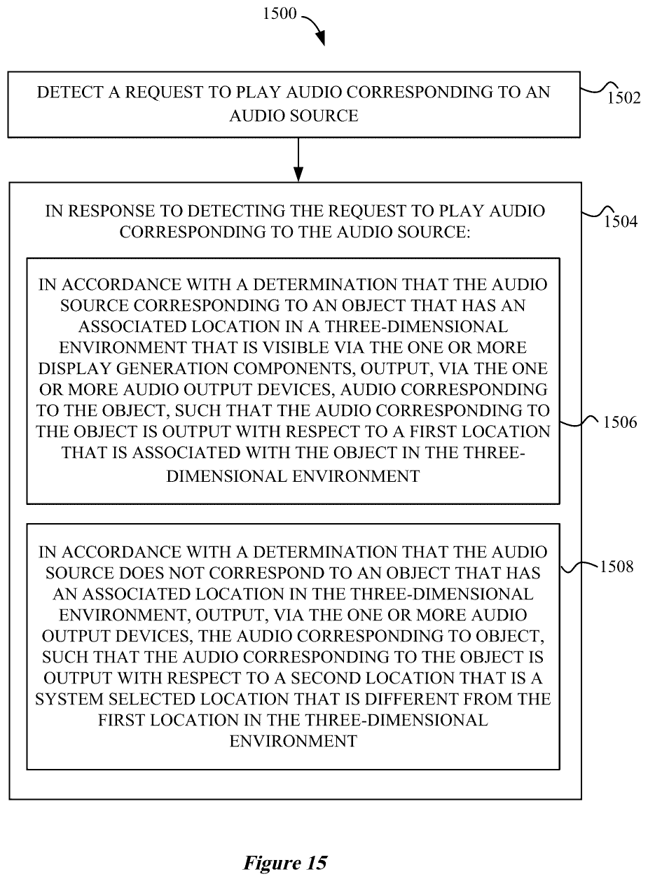

FIGS. 7A-7R illustrate exemplary user interfaces for managing controls for changing audio output in accordance with some embodiments. FIGS. 8A-8B are a flow diagram for illustrating a method for managing controls for changing audio output in accordance with some embodiments. The user interfaces in FIGS. 7A-7R are used to illustrate the processes described below, including the processes in FIGS. 8A-8B. FIGS. 9A-9H illustrate exemplary user interfaces for managing the prominence of audio in accordance with some embodiments. FIG. 10 is a flow diagram for illustrating a method for managing the prominence of audio in accordance with some embodiments. The user interfaces in FIGS. 9A-9H are used to illustrate the processes described below, including the processes in FIG. 10. FIGS. 11A-11F illustrate exemplary user interfaces for managing audio output based on distance in accordance with some embodiments. FIG. 12 is a flow diagram for illustrating a method for managing audio output based on a viewpoint of a user in accordance with some embodiments. FIG. 13 is flow diagram for illustrating a method for managing a virtual sound stage in accordance with some embodiments. The user interfaces in FIGS. 11A-11F are used to illustrate the processes described below, including the processes in FIGS. 12 and 13. FIGS. 14A-14K illustrate exemplary user interfaces for outputting audio at one or more locations in accordance with some embodiments. FIG. 15 is a flow diagram for illustrating a method for outputting audio at one or more locations in accordance with some embodiments. The user interfaces in FIGS. 14A-14K are used to illustrate the processes described below, including the processes in FIG. 15.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a×R system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

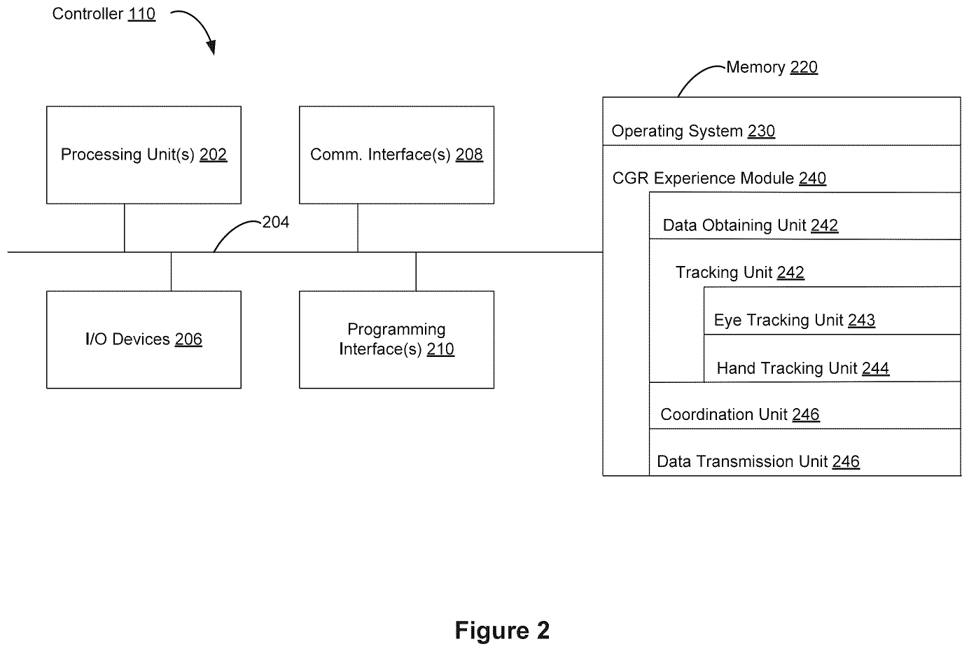

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

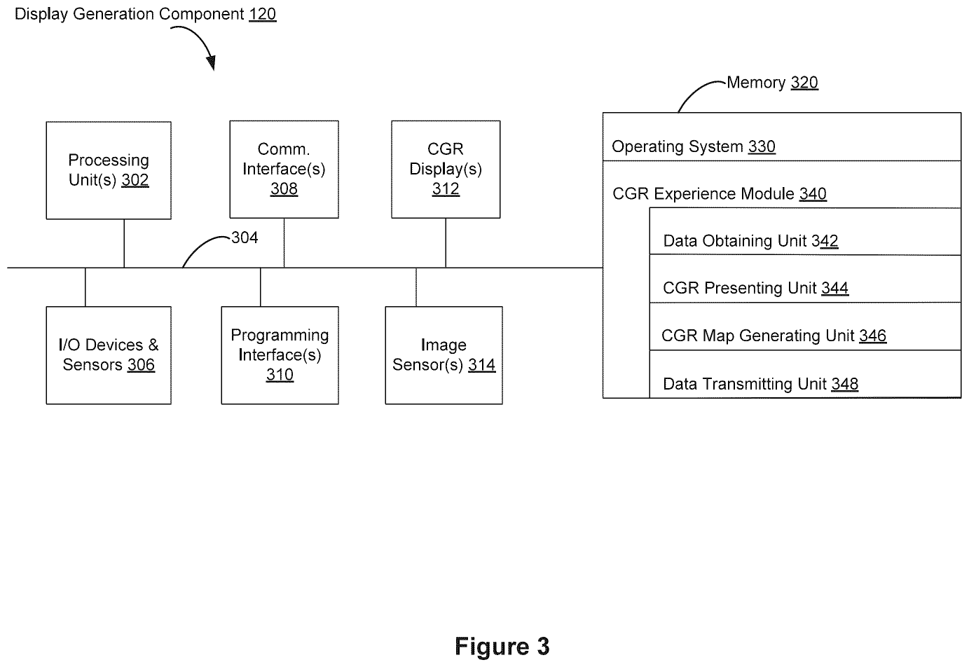

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-IF and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-IF and described herein. Likewise, any of the features, components, and/or parts, including the arrangements and configurations thereof shown and described with reference to FIGS. 1B, 1C, and 1E-IF can be included, either alone or in any combination, in the example of the devices, features, components, and parts shown in FIG. 1D.

FIG. 1E illustrates an exploded view of an example of a display unit 1-306 of an HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and IF and described herein. Likewise, any of the features, components, and/or parts, including the arrangements and configurations thereof shown and described with reference to FIGS. 1B-1D and IF can be included, either alone or in any combination, in the example of the devices, features, components, and parts shown in FIG. 1E.

FIG. 1F illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100.

The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin, for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some embodiments, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, cither alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some embodiments, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some embodiments, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

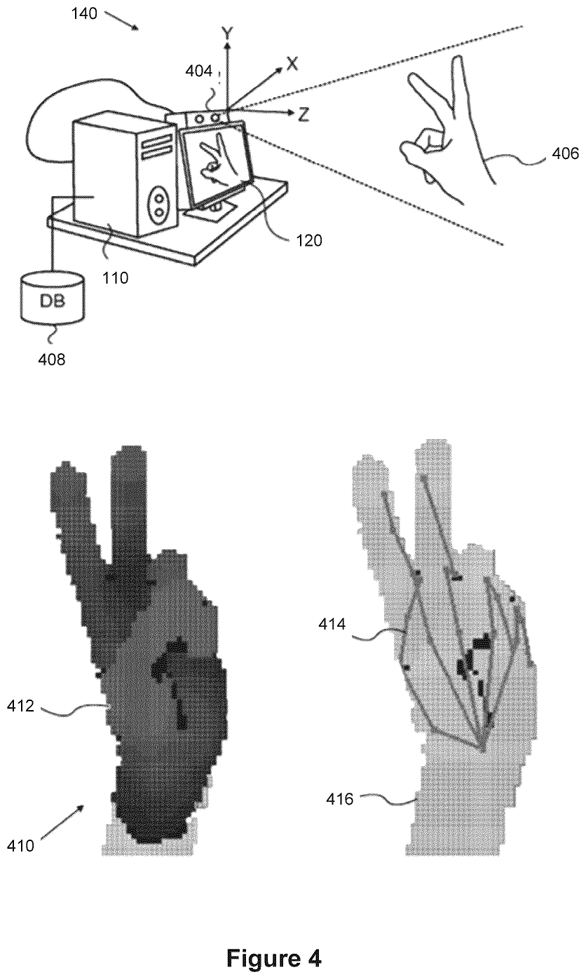

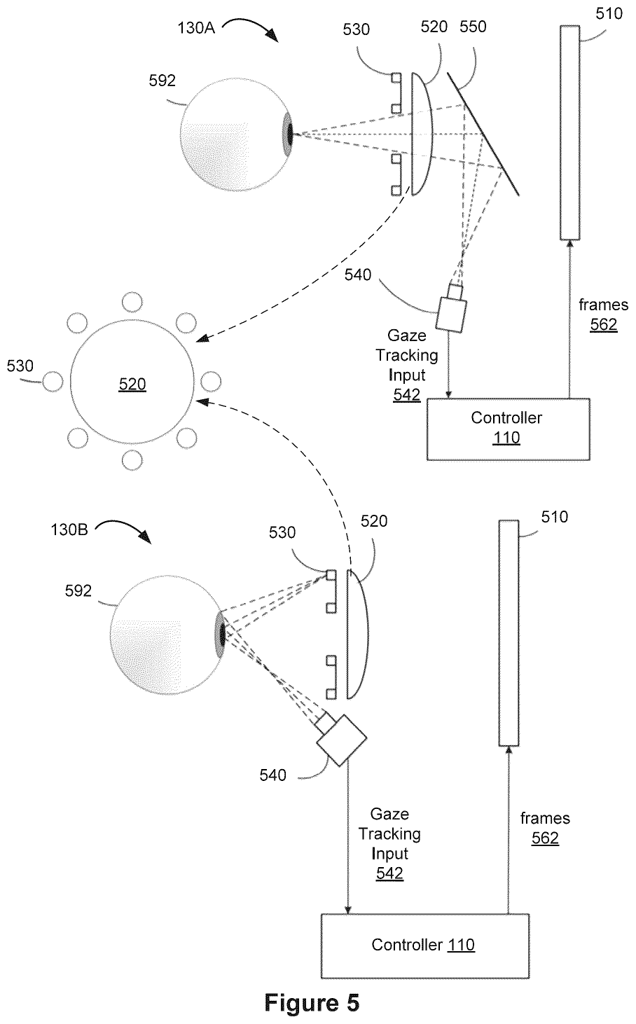

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively, or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

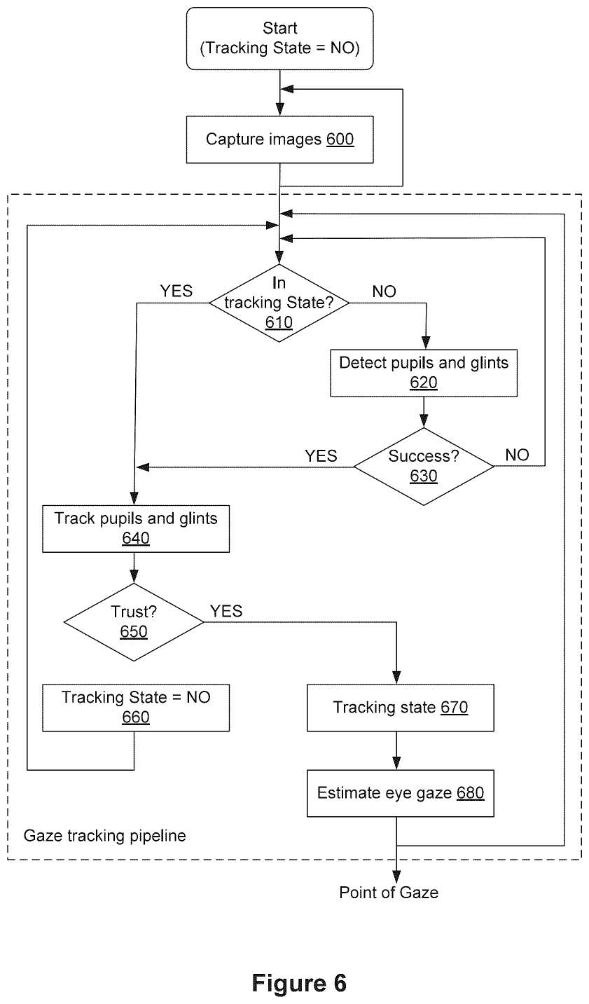

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze (e.g., via 130) of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7R illustrate exemplary user interfaces for managing controls for changing audio output in accordance with some embodiments. The user interfaces in these figures are used to illustrate the processes described below, including the processes in FIGS. 8A-8B.

FIG. 7A illustrates computer system 700 as a tablet. However, In some embodiments, computer system 700 is a different computer system, such as an HMD device, smart phone, tablet, fitness tracking device, and/or smart watch. In some embodiments, computer system 700 includes a display generation component that is a translucent and/or transparent display that allows one or more physical objects to “pass-through,” such that one or more physical objects are visible to the user (e.g., in an AR environment or an XR environment). In some embodiments, computer system 700 displays one or more virtual objects in the physical environment that is allowed to “pass-through” the viewpoint of computer system 700. In some embodiments, the display generation component operates in a mode, where the display generation component does not allow one or more physical objects to “pass-through,” and the display generation component displays one or more virtual objects in a virtual environment. In some embodiments, computer system 700 includes one or more sensors and/or input/output devices, such as an audio output device. It should be understood that while FIGS. 7A-7R use the detection of tap inputs, drag inputs, and/or other touch inputs to explain the one or more techniques described herein, one or more other types of gestures, such as air gestures, mouse clicks, voice commands, and/or gaze inputs can be substituted for and/or added to the one or more tap inputs, drag inputs, and/or other touch inputs described herein to perform the described one or more operations. It should also be understood that a discussion of computer system 700 adjusting an audio control also includes computer system 700 adjusting the audio level corresponding to the control, such an audio level of an application, a system audio level, an environmental sound, and/or a communication medium (e.g., a telephone call and/or a video call).

FIGS. 7A-7R illustrate one or more scenarios for adjusting various audio levels. In some embodiments, when a main audio level is adjusted, one or more individual audio levels is adjusted proportionally to the main audio level and/or each other. In some embodiments, when an individual audio level is adjusted, one or more other individual audio levels are not adjusted and, in addition, the main audio level can be adjusted when a determination is made that a set of one or more conditions are met. In some embodiments, after one of the individual audio levels are adjusted, the ratio between the adjusted audio level and another audio level is different. As illustrated in FIG. 7A, computer system 700 displays home screen user interface 710 that includes one or more icons. Overlayed on home screen user interface is audio control center 718 that includes main audio control 720 and individual audio controls 722. Main audio control 720 is an audio control that causes computer system 700 to adjust the audio level of multiple applications and/or to adjust a system level audio. Individual audio controls 722 are controls for controlling individual applications, environmental sounds, and/or communications (e.g., people and/or communication applications, such as a telephone call and/or a voice call). As a part of individual audio controls 722, computer system 700 displays video chat audio control 722a and television application audio control 722b. As illustrated in FIG. 7A, computer system 700 displays application icon 724a on the left side of video chat control 722a. Application icon 724a includes avatar of a person who is currently communicating with the user of computer system 700 via a video chat application. Likewise, computer system 700 displays application icon 724b to the left side of television application audio control 722b, where application icon 724b is an icon for the television application that corresponds to television application audio control 722b. At FIG. 7A, computer system 700 detects rightward drag input 705a directed to (e.g., on and/or at a location corresponding to) main audio control 720.

At FIG. 7B, in response to detecting rightward drag input 705a, computer system 700 adjusts main audio control 720 by 20%, where main audio control 720 is moved from a (e.g., a position corresponding to a) 50% audio level in FIG. 7A to a 70% audio level in FIG.. 7B. At FIG. 7B, in response to detecting rightward drag input 705a, computer system 700 proportionally adjusts the audio levels of applications corresponding to individual controls 722 based on the adjustment of main audio control 720 (and/or the adjustment of the main audio level). As illustrated in FIG. 7B, computer system 700 has adjusted video chat audio control 722a by 20% from a 30% audio level in FIG. 7A to a 50% audio level in FIG. 7B. Moreover, as illustrated in FIG. 7B, computer system 700 has also adjusted television audio control 722b by 20% from a 10% audio level in FIG. 7A to a 30% audio level in FIG. 7B. As shown in FIGS. 7A-7B, video chat audio control 722a and television audio control 722b (and the audio that corresponds to these controls) have been proportionally adjusted in response to detecting an input directed to main audio control 720 and not in response to detecting an input directed to each individual control. In some embodiments, in response to detecting an air gesture (e.g., an air swipe, an air flick gesture, and/or an air gestures that is detected based on a body part moving from one position in an environment to another position in the environment) made by hand 701 at FIGS. 7A-7B, computer system 700 performs the one or more operations described above in relation detecting input 705a, such as adjusting the audio level of one or more applications. At FIG. 7B, computer system 700 detects rightward drag input 705b directed to video chat audio control 722a (e.g., while a gaze or attention of the user is directed to video chat audio control 722a).

As illustrated in FIG. 7C, in response to detecting rightward drag input 705b, computer system 700 adjusts video chat audio control 722a by 10% (e.g., from a 50% audio level in FIG. 7B to a 60% audio level in FIG. 7C) without adjusting main audio control 720 and television application audio control 722b. Thus, at FIGS. 7B-7C, computer system 700 adjusts an audio level corresponding to an individual application without adjusting the audio levels corresponding to other applications. As shown in FIG. 7C, computer system 700 detects that one or more people have joined the video chat application and updates application icon 724a to reflect a current status of the video application (e.g., that three people are in the video chat). In some embodiments, in response to detecting an air gesture (e.g., an air swipe, an air flick gesture, and/or an air gestures that is detected based on a body part moving from one position in an environment to another position in the environment) made by hand 701 at FIGS. 7B, computer system 700 performs the one or more operations described above in relation detecting input 705b, such as adjusting the audio level of one or more applications (e.g., while a gaze or attention of the user is directed to an audio level control), or moving a user interface of one or more applications (e.g., while a gaze or attention of the user is directed to the user interface for the application or an application movement affordance for moving the application).

FIGS. 7D-7F illustrate a scenario where computer system 700 adjusts the main audio level when an individual audio level is adjusted to have a greater value than the main audio level. At FIG. 7C, computer system 700 detects a first portion of rightward drag input 705d directed to television application audio control 722b. As illustrated in FIG. 7D, in response to detecting the first portion of rightward drag input 705d, computer system 700 adjusts the audio level of the television application, which corresponds to television application audio control 722b, and displays television application audio control 722b being adjusted by 20% (e.g., from the 30% audio level in FIG. 7C to a 50% audio level in FIG. 7D). As shown in FIG. 7D, neither video chat application control 722a nor main audio control 720 are adjusted in response to detecting rightward drag input 705d. At FIG. 7D, computer system 700 detects a second portion of rightward drag input 705d directed to television application audio control 722b. As illustrated in FIG. 7E, in response to detecting the second portion of rightward drag input 705d, computer system 700 adjusts the audio level of the television application and displays television application audio control 722b being adjusted by 20% (e.g., from the 50% audio level in FIG. 7D to a 70% audio level in FIG. 7E). In response to detecting the second portion of rightward drag input 705d, computer system 700 still does not adjust the audio level of audio corresponding to main audio level and the audio level of the audio corresponding to video chat application control 722a. At FIG. 7E, computer system 700 detects a third portion of rightward drag input 705d directed to television application audio control 722b. As illustrated in FIG. 7F, in response to detecting the third portion of rightward drag input 705d, computer system 700 adjusts the audio level of the television application and displays television application audio control 722b being adjusted by 20% (e.g., from the 70% audio level in FIG. 7E to a 90% audio level in FIG. 7F). However, at FIG. 7F, a determination is made that the television application is outputting audio at the highest audio level among the audio sources that have audio being output by computer system 700. Based on this determination, computer system 700 updates the main audio level, such that main audio level is adjusted to match the audio level corresponding to television application audio control 722b. In some embodiments, as computer system 700 detects the third portion of rightward drag input 705d, computer system 700 displays television application audio control 722b and main audio control 720 adjusting in tandem after the value of television application audio control 722b reaches the value (e.g., comes within a certain amount of the value and/or surpasses the value by a certain amount) of main audio control 720. In some embodiments, in response to detecting an air gesture (e.g., an air swipe, an air flick gesture, and/or an air gestures that is detected based on a body part moving from one position in an environment to another position in the environment) made by hand 701 at FIGS. 7C-7E, computer system 700 performs the one or more operations described above in relation detecting input 705d, such as adjusting the audio level of one or more applications (e.g., while a gaze or attention of the user is directed to an audio level control), or moving a user interface of one or more applications (e.g., while a gaze or attention of the user is directed to the user interface for the application or an application movement affordance for moving the application).

FIG. 7G-7H illustrates alternative scenarios for a displaying a newly detected audio source. In some embodiments, computer system 700 displays an audio control for the newly detected audio source after detecting one or more inputs, such as a voice command, air gesture, and/or touch gesture. In some embodiments, computer system 700 displays an audio control for the newly detected audio source without detecting user input, such as after detecting that someone has initiated a video call and/or telephone call with the user of computer system 700.

FIG. 7G illustrates computer system 700 displaying audiobook application audio control 722c and audiobook application icon 724c in response to computer system 700 detecting an audiobook application has started causing computer system 700 to output audio (e.g., as indicated by audiobook application user interface 712 being displayed). At FIG. 7G, computer system 700 initially displays audiobook application audio control 722c at (and/or the audio application is outputting audio at) an historical audio level that is associated with audiobook application audio control 722c. In some embodiments, the historical audio level is determined based on the most recent audio level that the audiobook application caused computer system 700 to output (e.g., when the audiobook application was last active). In some embodiments, the historical audio level is determined based on the most frequent audio level that the audiobook application causes computer system 700 to output (e.g., over a predetermined period of time (e.g., a week, a month, a year, etc.)).

As an alternative, FIG. 7H illustrates computer system 700 displaying audiobook audio control 722c at the same audio level (e.g., 90%) that corresponds to main audio control 720 in response to computer system 700 detecting an audiobook application has started causing computer system 700 to output audio. Here, computer system 700 outputs newly detected audio sources at the audio level corresponding to main audio controls instead an audio level corresponding to an historical audio level for the particular audio control. In some embodiments, whether computer system 700 outputs newly detected audio at an historical audio level or the audio level corresponding to the main audio control is determined by the state of a setting. In some embodiments, in response to selection of the setting, computer system 700 is transitioned between outputting newly detected audio at the historical audio level and outputting newly detected audio at the main audio level.

FIGS. 7H-7K illustrate one or more scenarios, where the number of currently detected audio sources impacts the display of the main audio control. At FIG. 7H, computer system 700 has detected that the audiobook application is no longer active (and/or ceased to output audio). As illustrated in FIG. 7I, in response to detecting that the audiobook application is no longer active, computer system 700 ceases to display audiobook audio control 722c of FIG. 7H. At FIG. 7I, computer system 700 subsequently detects that the television application is no longer active. As illustrated in FIG. 7J, in response to detecting that the television application is no longer active, computer system 700 ceases display of television application audio control 722b of FIG. 7I. In addition, at FIG. 7I, a determination is made that the video chat application is the only application audio source that is actively causing computer system 700 to output audio (and/or that less than a predetermined number of audio sources (e.g., 1-10) are causing computer system 700 to output audio). Thus, at FIG. 7J, computer system 700 displays video chat audio control 722a in the position of main audio control 720 of FIG. 7H and ceases to display main audio control 720. In addition to ceasing to display main audio control 720, computer system 700 also ceases to display optional view control 720a of FIG. 7H. At FIG. 7K, computer system 700 detects that the television application has become active (e.g., has started causing computer system 700 to output audio).

As illustrated in FIG. 7K, in response to detecting that the television application has become active, computer system 700 ceases to display video chat audio control 722a of FIG. 7J and re-displays main audio control 720. Here, computer system 700 re-displays main audio control 720 because a determination is made that the video chat application is no longer the only application audio source that is actively causing computer system 700 to output audio (and/or that more than a predetermined number of audio sources (e.g., 1-10) are causing computer system 700 to output audio). As illustrated in FIG. 7K, in response to detecting that the television application has become active, computer system 700 also re-displays optional view control 720a. At FIG. 7K, computer system 700 detects tap input 705k directed to optional view control 720a. As illustrated in FIG. 7L, in response to detecting tap input 705k, computer system 700 expands audio control center 718 from collapsed state (e.g., in FIG. 7K, where only main audio control 720 was displayed) to an expanded state (e.g., in FIG. 7L, where multiples audio controls are displayed). While in the expanded state, computer system 700 displays video chat audio control 722a, application icon 724a, television application audio control 722b, and application icon 724b along with main audio control 720 (e.g., using one or more techniques as described above in relation to FIGS. 7A-7F). Thus, when more than a predetermined number of audio sources are causing computer system 700 to output audio and/or are concurrently configured to cause computer system 700 to output audio, computer system 700 provides a mechanism to collapse and/or expand audio control center 718. In some embodiments, in response to detecting an input on optional view control 720a, computer system 700 collapses audio control center 718 to display audio control center 718 of FIG. 7K.

FIGS. 7L-7M illustrate a scenario where the main audio control set to the lowest audio level (e.g., 0%). At FIG. 7L, computer system 700 detects leftward drag input 705l directed to main audio control 720. As illustrated in FIG. 7M, in response to detecting drag input 705l, computer system 700 adjusts main audio control 720 to a 0% audio level. While adjusting main audio control 720 to a 0%, computer system 700 also adjusts video chat audio control 722a and television application audio control 722b to a 0% audio level. Thus, at FIG. 7L, computer system 700 is not outputting corresponding to the video chat application and the television application. Moreover, because audio corresponding to main audio control was adjusted to 0%, computer system 700 is also not outputting environmental sounds and/or other system sounds, such as voice assistant and/or one or more ambient sounds in the environment surround computer system 700.

FIGS. 7M-7N illustrate a scenario where the main audio control is adjusted from the lowest audio level to another audio level. At FIG. 7M, computer system 700 detects rightward drag input 705m directed to main control 720. As illustrated in FIG. 7M, computer system 700 has adjusted main audio control 720, video chat audio control 722a, television application audio control 722b and their respective corresponding audio back to the levels at which they were before main audio control 720 was adjusted to the 0% audio level. As shown in FIG. 7M, computer system 700 returns the individual controls and their corresponding audio outputs back to their original output ratios and/or begins proportionally adjusting each individual control, such that the individual controls are set back to their pre-adjusted audio levels when main audio control 720 is set to its pre-adjusted audio level.

FIGS. 70-7Q illustrate alternative scenarios, where computer system 700 continues to display an audio control for an application that is determined to be a first type of application but does not continue to display an audio control for an application that is determined to be a second type of application. In some embodiments, the first type of application is a persistent application, and the second type of application is a non-persistent application. In some embodiments, a persistent application is an application for which computer system 700 will continue to output audio while the application is not displayed via computer system 700 and/or is not visible in an environment. In some embodiments, persistent applications include video applications, podcast applications, music applications, and/or other media applications. In some embodiments, persistent applications are commonly used to play audio in the background while the user's attention is away from the application. In some embodiments, a persistent application is an important application and/or an application that is designated by computer system 700 to be a persistent application. FIG. 70 illustrates computer system 700 displays video application audio control 722d along with main audio control 720, video chat audio control 722a, and television application audio control 722b. As illustrated in FIG. 70, computer system 700 is displaying video application audio control 722d while video application user interface 716. In some embodiments, video application user interface 716 is visible in the environment.

As illustrated in FIG. 7P, in response to detecting the request to cease displaying video application user interface 716, computer system 700 ceases to display video application user interface 716 and displays home user interface 710 (e.g., using one or more techniques as described above in relation to FIG. 6A). At FIGS. 7P, a determination is made that the application that corresponds to video application user interface 716 is a persistent application. In response to this determination, computer system 700 continues to display video application audio control 722d and output audio corresponding to the application that corresponds to video application user interface 716. However, at FIG. 7Q, a determination is made that the application that corresponds to video application user interface 716 is not a persistent application; and therefore, computer system 700 ceases to display video application audio control 722d and stops outputting audio corresponding to the application that corresponds to video application user interface 716.

FIG. 7R illustrates an alternative example of computer system 700 displaying group audio controls 728 along with main audio control 720. Group audio controls includes people audio control 728a, applications audio control 728b, and environmental sounds audio control 728c. People audio control 728a is an audio control that is used to adjust the audio of different applications surrounding communication with people and/or one or more communication applications, such as a telephone call application, a video call application, and/or the like. Applications audio control 728 is an audio control that is used to adjust the audio of different applications (e.g., other than or including communication applications), such as video applications, audio recording applications, and/or notetaking applications. Environmental sounds audio 728c is an audio control that used to adjust the audio of one or more environmental sounds, such as ambient noise in the background of an environment surrounding computer system 700. As shown in FIG. 7R, computer system 700 is displaying audio control center 718 as being overlaid on a physical environment that includes physical objects, such as trees and a person. Thus, at FIG. 7R, computer system 700 is displaying audio control center 718 using a pass-through display generation component, where the virtual objects are passing-through the display. In some embodiments, computer system 700 displays audio control center 718 in an entirely virtual environment and, in some embodiments, audio control center 718 is environment-lock or viewpoint-locked, as described above.

FIGS. 8A-8B is a flow diagram illustrating a method (e.g., method 800) for managing controls for changing audio output in accordance with some examples. Some operations in method 800 are, optionally, combined, the orders of some operations are, optionally, changed, and some operations are, optionally, omitted.

As described below, method 800 provides an intuitive way for managing controls for changing audio output. Method 800 reduces the cognitive burden on a user for managing controls for changing audio output, thereby creating a more efficient human-machine interface. For battery-operated computing devices, enabling a user to manage controls for changing audio output faster and more efficiently conserves power and increases the time between battery charges. In some embodiments, method 800 is performed at a computer system that is in communication with one or more output devices (e.g., one or more speakers, camera, and/or sensors) and a display generation component (e.g., a display, a touch-sensitive display, a projector, a light, and/or a set of one or more light emitting diodes). In some embodiments, the computer system is a phone, a watch, a tablet, a fitness tracking device, a wearable device, a television, a multi-media device, an accessory, a speaker, a head-mounted display (HMD), and/or a personal computing device. In some embodiments, the computer system is in communication with input/output devices, such as one or more cameras, speakers, microphones, sensors (e.g., heart rate sensor, monitors, antennas (e.g., using Bluetooth and/or Wi-Fi), and/or near-field communication sensors).

At 802, while outputting, via the one or more output devices, media (e.g., audio media, video media, prerecorded media, live media (e.g., captured (real-time and/or near real-time capture of) sound and/or captured video)) corresponding to a first audio source (e.g., an application corresponding to one or more of 722a-722d) (e.g., 724a) (e.g., an application (e.g., a music application, a live communication application, a live video application, a video application, a live messaging application, an audiobook application, an entertainment application, and/or an educational application), a system process, a device in communication with the computer system, and/or a system sound (e.g., environmental sounds, ambient sounds, and/or a sound of a voice assistant)) at a first audio level (e.g., as shown by 722a set to 30%) (e.g., a volume level, a sound level, and/or a level measured in decibels) (and/or, In some embodiments, while configured to output media corresponding to the first audio source (e.g., an application corresponding to one or more of 722a-722d) at the first audio level, where, In some embodiments, the computer system is not actively outputting media but will output media (e.g., in response to receiving and/or detecting input)) and outputting, via the one or more output devices, media corresponding to a second audio source (e.g., an application corresponding to one or more of 722a-722d) (e.g., 724b) (e.g., an application, a system process, and/or a device in communication with the computer system, and/or a system sound) at a second audio level that is different from (e.g., higher than or lower than) the first audio level (e.g., as shown by 724b set to 10%), the computer systems displays, via the display generation component, a control (e.g., a volume slider that includes a selector, an increase volume control and/or button, and/or a decrease volume control and/or button) for adjusting an audio level (e.g., a main audio level, a maximum output audio level (e.g., where a user sets the maximum output level that is desired by the user and/or not necessarily the maximum audio level that the computer system can theoretically output via the one or more output devices), a maximum and/or capped output audio level, and/or a primary audio level) corresponding to multiple audio sources audio source (e.g., corresponding to one or more of 722a-722d) (e.g., 720) that include the first audio source (e.g., an application corresponding to one or more of 722a-722d) (e.g., 724a) and the second audio source (e.g., an application corresponding to one or more of 722a-722d) (e.g., 726b). In some embodiments, the first audio source is different from the second audio source. In some embodiments, the first audio source corresponds to a first application that is different from the second application. In some embodiments, the first audio source is a first type of audio source (e.g., a first-party application, a third-party application, a video application, a music application, an audiobook application, and/or a live application (e.g., a live communication session application (e.g., video communication session and/or a messaging communication session) and/or live event application), an active application, an application that is running in the foreground, and/or an application that is running in the background) and the second audio source is a second type of audio source that is different from the first type of audio source. In some embodiments, the multiple audio sources include one or more audio sources that are different from the first audio source and/or the second audio source.

At 804, while displaying the control for adjusting the audio level corresponding to the multiple audio sources 7Q (e.g., 720) (e.g., corresponding to one or more of 722a-722d), the computer system detects a first input (e.g., 705a) (e.g., a swipe input and/or a dragging input or, In some embodiments, a non-swipe and/or dragging input, such as an air input (e.g., a pointing air gesture, a waving air gesture, and/or a moving air gesture), a gaze input, a mouse click-and-drag input, a voice command, and/or a moving input (e.g., such as moving the computer system in a particular direction)) directed to the control for adjusting the audio level corresponding to the multiple audio sources.

At 806, in response to detecting the first input (e.g., 705a and/or as discussed above in relation to 701), proportionally adjusting output of media corresponding to the multiple audio sources, including: adjusting (e.g., increasing and/or decreasing) (at 808) output of media corresponding to the first audio source (e.g., 724a) by a first amount (e.g., as shown in 722a of FIG. 7B); and adjusting (at 810) output of media corresponding to the second audio source (e.g., 726b) by a second amount that is different from the first amount (e.g., as shown in 722a of FIG. 7B), wherein a difference between the first amount of adjustment and the second amount of adjustment is based on a difference between the first audio level and the second audio level (e.g., a ratio between the first audio level and the second audio level is equal to, approximately equal to (e.g., within 5% of being equal to) a ratio between the first amount of adjustment and the second amount of adjustment). In some embodiments, output of media corresponding to the multiple audio sources is proportionally adjusted based on the movement (e.g., speed, direction, acceleration, rate, force, and/or velocity of movement) of the first input). In some embodiments, an indication on a control that corresponds to the first audio source is moved as output of media corresponding to the first audio source is adjusted from the first audio level to the third audio level. In some embodiments, an indication on a control that corresponds to the second audio source is moved as output of media corresponding to the second audio source is adjusted from the second audio level to the fourth audio level. In some embodiments, movement of the indication on the control that corresponds to the first audio source is proportional to movement (and, In some embodiments, is in the same direction as) of the indication on the control that corresponds to the second audio source.

At 812, after proportionally adjusting output of media corresponding to the multiple audio sources (and, In some embodiments, while the first audio source is at the third audio level and/or the second audio source is at the fourth audio level), the computer system detects a second input (e.g., 705b and/or as discussed above in relation to 701) (e.g., a swipe input and/or a dragging input or, In some embodiments, a non-swipe and/or dragging input, such as an air input (e.g., a pointing air gesture, a waving air gesture, and/or a moving air gesture), a gaze input, a mouse click-and-drag input, a voice command, and/or a moving input (e.g., such as moving the computer system in a particular direction)). In some embodiments, the second input is different from (e.g., occurs after releasing and/or no longer detecting) the first input.

At 814, in response to detecting the second input (e.g., 705b and/or 705d and/or as discussed above in relation to 701) and in accordance with a determination that a first set of one or more criteria is satisfied, wherein the first set of one or more criteria includes a criterion that is satisfied when a determination is made that the second input is directed to a control (e.g., a volume slider that includes a selector, an increase volume control and/or button, and/or a decrease volume control and/or button) for adjusting an audio level corresponding to the first audio source (e.g., 724a) independently of adjustments to the audio level corresponding to the second audio source, the computer system adjusts output of media corresponding to the first audio source (and, In some embodiments, moving an indication (e.g., a selector, a text number that represents an audio level value, and/or a slider bar) on a control corresponding to the first audio source) without adjusting output of media corresponding to the second audio source (and, In some embodiments, without moving an indication on a control corresponding to the second audio source) and while displaying, via the display generation component, an indication that the audio level corresponding to the multiple audio sources (e.g., 720) being adjusted (e.g., increased and/or decreased) (e.g., moved to the right and/or move to the left; moved up and/or moved down) based on the second input (e.g., based on the movement of the second input) (and, In some embodiments, while adjusting a main computer system audio level and/or while adjusting one or more audio levels of one or more multiple audio sources that are not the first audio source and/or the second audio source) (and, In some embodiments, while adjusting the audio level corresponding to the multiple audio sources). Proportionally adjusting output of media corresponding to the multiple audio sources (e.g., in response to detecting the first input directed to the control for adjusting the audio level corresponding to the multiple audio sources) and adjusting output of media corresponding to the first audio source without adjusting output of media corresponding to the second audio source (e.g., in response to detecting the second input directed to a control for adjusting an audio level corresponding to the first audio source independently of adjustments to the audio level corresponding to the second audio source) allows the computer system to provide the user with different control options for adjusting multiple audio sources and adjusting an audio source independently of other audio sources, thereby reducing the number of inputs needed to perform an operation and providing additional control options.

In some embodiments, in response to detecting the first input (e.g., 705a) and in accordance with a determination that a second set of one or more criteria is satisfied, wherein the second set of one or more criteria includes a criterion that is satisfied when a determination is made that the second input (e.g., 705b and/or 705d and/or as discussed above in relation to 701) is directed to a first control (e.g., a volume slider that includes a selector, an increase volume control and/or button, and/or a decrease volume control and/or button) for adjusting an audio level corresponding to the second audio source (e.g., 726b) independently of adjustments to the audio level corresponding to the first audio source (e.g., 724a), the computer system adjusts output of media corresponding to the second audio source (and, In some embodiments, moving an indication on a control corresponding to the second audio source) without adjusting output of media corresponding to the first audio source (e.g., as shown in FIG. 7C and FIG. 7D) (and, In some embodiments, without moving an indication on a control corresponding to the first audio source) and while displaying, via the display generation component, the indication that the audio level corresponding to the multiple audio sources (e.g., 720) being adjusted based on the second input (and, In some embodiments, while adjusting a main computer system audio level and/or while adjusting one or more audio levels of one or more multiple audio sources that are not the first audio source and/or the second audio source) (and, In some embodiments, while adjusting the audio level corresponding to the multiple audio sources). Proportionally adjusting output of media corresponding to the multiple audio sources (e.g., in response to detecting the first input directed to the control for adjusting the audio level corresponding to the multiple audio sources) and adjusting output of media corresponding to the second audio source without adjusting output of media corresponding to the first audio source (e.g., in response to detecting the second input directed to a control for adjusting an audio level corresponding to the second audio source independently of adjustments to the audio level corresponding to the second audio source) allows the computer system to provide the user with different control options for adjusting multiple audio sources and adjusting an audio source independently of other audio sources, thereby reducing the number of inputs needed to perform an operation and providing additional control options.

In some embodiments, after adjusting output of media corresponding to the first audio source (e.g., 724a) without adjusting output of media corresponding to the second audio source (e.g., 726b), media corresponding to the first audio source is output at a third audio level that is different from the first audio level and media corresponding to the second audio source is output at the second audio level. In some embodiments, after adjusting output of media corresponding to the first audio source (e.g., 724a) without adjusting output of media corresponding to the second audio source (e.g., 726b) and while displaying the control for adjusting the audio level corresponding to the multiple audio sources (e.g., 720) (and while media corresponding to the first audio source is output at a third audio level that is different from the first audio level and media corresponding to the second audio source is output at the second audio level), the computer system detects a third input (e.g., 705m) (e.g., a swipe input and/or a dragging input or, In some embodiments, a non-swipe and/or dragging input, such as an air input (e.g., a pointing air gesture, a waving air gesture, and/or a moving air gesture), a gaze input, a mouse click-and-drag input, a voice command, and/or a moving input (e.g., such as moving the computer system in a particular direction)) directed to the control for adjusting the audio level corresponding to the multiple audio sources. In some embodiments, in response to detecting the third input (e.g., 705m) (e.g., 705b and/or 705d and/or as discussed above in relation to 701), the computer system proportionally adjusts output of media corresponding to the multiple audio sources, including: adjusting output of media corresponding to the first audio source (e.g., 724a) by a third amount; and adjusting output of media corresponding to the second audio source (e.g., 726b) by a fourth amount that is different from the third amount, wherein a difference between the third amount of adjustment and the fourth amount of adjustment is based on a difference between the third audio level and the second audio level prior to detecting the third input (e.g., 705m), and wherein the difference between the first amount of adjustment and the second amount of adjustment is different from the difference between the third amount of adjustment and the fourth amount of adjustment (e.g., the ratio that was maintained and/or continued to exist when adjusting the media corresponding to the first audio source and the media corresponding to the first audio source in response to the first input is different from the ratio that was maintained and/or continued to exist when the media corresponding to the first audio source in response to the third input). In some embodiments, before adjusting output of media corresponding to the first audio source without adjusting output of media corresponding to the second audio source and while displaying the control for adjusting the audio level corresponding to the multiple audio sources, the computer system detects another input directed to the control for adjusting the audio level corresponding to the multiple audio sources; and in response to detecting the other input, the computer system proportionally adjusts output of media corresponding to the multiple audio sources, including: adjusting output of media corresponding to the first audio source by a first respective amount (e.g., the first amount or a different amount than the first amount); and adjusting output of media corresponding to the second audio source by a second respective amount (e.g., the second amount or a different amount than the second amount) that is different from the first respective amount. In some embodiments, a difference between the first respective amount of adjustment and the second respective amount of adjustment is based on the difference between the first audio level and the second audio level. In some embodiments, the difference between the first amount of adjustment and the second amount of adjustment is the same as the difference between the first respective amount of adjustment and the second respective amount of adjustment and/or the same ratio is maintained between an audio level of media corresponding to the first audio source and an audio level of media corresponding to the second audio source. Proportionally adjusting output of media corresponding to the multiple audio sources where the values have a difference related to the previous audio levels of the audio sources allows the computer system to provide the user with a control option to proportionally adjust output of media corresponding to the multiple audio sources based on the ratio of audio levels corresponding to the audio sources before the proportional adjustment started, thereby reducing the number of inputs needed to perform an operation and providing additional control options.

In some embodiments, the first set of one or more criteria includes a criterion that is satisfied when a determination is made that an indication corresponding to the first audio level (e.g., 722a) is within a predetermined distance (and/or a range of distances) (e.g., 0.1-10 centimeters) from an indication corresponding to the multiple audio sources (e.g., 720). In some embodiments, in response to detecting the second input (e.g., 705b and/or 705d and/or as discussed above in relation to 701) and in accordance with a determination that a third set of one or more criteria is satisfied, where the third set of one or more criteria includes a criterion that is satisfied when a determination is made that the indication corresponding to the first audio level (e.g., 722a) is not within a predetermined distance (and/or a range of distances) (e.g., 0.1-10 centimeters) from the indication corresponding to the multiple audio sources (e.g., 720), the computer system adjusts output of media corresponding to the first audio source (and/or, In some embodiments, while displaying an indication that the he audio level corresponding to the first audio source being adjusted) without adjusting output of media corresponding to the second audio source (e.g., 726b) (and/or, In some embodiments, without displaying an indication that the audio level corresponding to the second audio source being adjusted) and without displaying, via the display generation component, the indication that the audio level corresponding to the multiple audio sources (e.g., 720) being adjusted based on the second input (and/or, In some embodiments, without adjusting the audio level corresponding to the multiple audio sources). In some embodiments, displaying the indication that the audio level corresponding to the multiple audio sources (e.g., 720) being adjusted includes displaying that the indication corresponding to the multiple audio sources is being moved (e.g., in relation to, at the speed of, and/or via movement of the second input). In some embodiments, the first set of one or more criteria includes a criterion that is satisfied when a determination is made that the audio level corresponding to the first audio source is higher than the audio level corresponding to the second audio source (and/or when a determination is made that an audio level corresponding to the first audio source is and/or is designed to be the highest audio level for an individual audio source and/or system source (e.g., a system effects source as described below) of audio). In some embodiments, the second set one or more criteria includes a criterion that is satisfied when a determination is made that the audio level corresponding to the first audio source is not higher (or, In some embodiments, higher) than the audio level corresponding to the second audio source (and/or when a determination is made that an audio level corresponding to the first audio source is and/or is designed to be the highest audio level for an individual audio source and/or system source of audio). In some embodiments, the first set of one or more criteria includes a criterion that is satisfied when a determination is made that an audio level corresponding to the first audio source being adjusted in a first direction (and, In some embodiments, not in a second direction) (e.g., to the right, to the left, up, and/or down). In some embodiments, the first set of one or more criteria includes a criterion that is satisfied when a determination is made that the indication that audio level corresponding to the first audio source being adjusted is within a predetermined distance (e.g., 0.1-3 centimeters) from the indication that the audio level corresponding to the multiple audio sources (and/or a value corresponding to the position of the indication of the audio level corresponding to the first audio source is within a predetermined range of values (e.g., 1-10 volume and/or sound levels) from a value corresponding to the position of the indication of the multiple audio sources)). In some embodiments, the second set of one or more criteria includes a criterion that is satisfied when a determination is made that the indication that the audio level corresponding to the first audio source being adjusted is not within the predetermined distance from the indication that the audio level corresponding to the multiple audio sources (and/or a value corresponding to the position of the indication of the audio level corresponding to the first audio source is not within a predetermined range of values from a value corresponding to the position of the indication of the multiple audio sources). In some embodiments, the second input causes the computer system to move the indication corresponding to the first audio source from one position to another position. Choosing whether to display, via the display generation component, the indication that the audio level corresponding to the multiple audio sources being adjusted based on whether a set of one or more criteria is satisfied allows the computer system to automatically choose when to show that the multiple audio sources being adjusted based on the audio level corresponding to the first audio source being adjusted to be within the range of the audio level corresponding to the multiple audio sources, thereby reducing the number of inputs needed to perform an operation, providing additional control options, and performing an operation when a set of one or more conditions has been satisfied without requiring further user input.

In some embodiments, after proportionally adjusting output of media corresponding to the multiple audio sources, the computer system detects a fourth input (e.g., 705b and/or 705d and/or as discussed above in relation to 701) (e.g., a swipe input and/or a dragging input or, In some embodiments, a non-swipe and/or dragging input, such as an air input (e.g., a pointing air gesture, a waving air gesture, and/or a moving air gesture), a gaze input, a mouse click-and-drag input, a voice command, and/or a moving input (e.g., such as moving the computer system in a particular direction)) directed to the control for adjusting the audio level corresponding to the first audio source independently of adjustments to the audio level corresponding to the second audio source. In some embodiments, in response to detecting the fourth input, the computer system adjusts output (e.g., the audio level and/or volume of the media) of media corresponding to the first audio source (and, In some embodiments, without adjusting output of media corresponding to the second audio source) without displaying, via the display generation component, an indication that the audio level corresponding to the multiple audio sources being adjusted. In some embodiments, while adjusting output (e.g., the audio level and/or volume of the media) of media corresponding to the first audio source (and, In some embodiments, without adjusting output of media corresponding to the second audio source) without displaying, via the display generation component, an indication that the audio level corresponding to the multiple audio sources being adjusted, the computer system detects a fifth input (e.g., 705b and/or 705d and/or as discussed above in relation to 701) (e.g., a swipe input and/or a dragging input or, In some embodiments, a non-swipe and/or dragging input, such as an air input (e.g., a pointing air gesture, a waving air gesture, and/or a moving air gesture), a gaze input, a mouse click-and-drag input, a voice command, and/or a moving input (e.g., such as moving the computer system in a particular direction)) directed to the control for adjusting the audio level corresponding to the first audio source independently of adjustments to the audio level corresponding to the second audio source. In some embodiments, in response to detecting the fifth input, the computer system adjusts (and/or continuing to adjust) output (e.g., the audio level and/or volume of the media) of media corresponding to the first audio source (and, In some embodiments, without adjusting output of media corresponding to the second audio source) while displaying, via the display generation component, the indication that the audio level corresponding to the multiple audio sources being adjusted. In some embodiments, the fourth input and the fifth input are different portions of another input (e.g., an input that moves from a first position to a second position and an input that moves from the second position to a third portion) and/or the same input. In some embodiments, the fourth input and the fifth input are not different portions of another input, are not the same input, and/or are separate inputs. Adjusting output of media corresponding to the first audio source without displaying, via the display generation component, an indication that the audio level corresponding to the multiple audio sources being adjusted in response to one input and adjusting output of media corresponding to the first audio source while displaying, via the display generation component, an indication that the audio level corresponding to the multiple audio sources being adjusted in response to another input allows the computer system to choose when to display the indication that the audio level corresponding to the multiple audio sources being adjusted when appropriate and reduces a user's confusion as to which audio levels are being adjusted, thereby reducing the number of inputs needed to perform an operation, providing additional control options, and performing an operation when a set of one or more conditions has been satisfied without requiring further user input.

In some embodiments, in response to detecting the fifth input (e.g., 705b and/or 705d and/or as discussed above in relation to 701) and in accordance with a determination than the computer system is causing the audio level corresponding to the first audio source to be adjusted outside of a range with respect to (e.g., 0.1-10 volume levels between and/or away from) a current audio level corresponding to the multiple audio sources in response to detecting a portion of the fifth input (e.g., movement of the fifth input from one position to another position, irrespective of whether liftoff of the fifth input is detected after the fifth input is moved), the computer system displays, via the display generation component, the indication that the audio level corresponding to the multiple audio sources being adjusted (and, in some embodiments, while detecting the portion of the fifth input). In some embodiments, in accordance with a determination than the computer system is causing the audio level corresponding to the first audio source to be adjusted outside of a range with respect to a current audio level corresponding to the multiple audio sources in response to detecting a portion of the fifth input, the computer system causes the audio level corresponding to the multiple audio sources being adjusted. In some embodiments, in response to detecting the fifth input and in accordance with a determination that the computer system is not causing the audio level corresponding to the first audio source to be adjusted outside of the range with respect to the current audio level corresponding to the multiple audio sources in response to detecting the portion of the fifth input, the computer system forgoes displaying the indication that the audio level corresponding to the multiple audio sources being adjusted (and, in some embodiments, while detecting the portion of the fifth input). In some embodiments, in accordance with a determination than the computer system is not causing the audio level corresponding to the first audio source to be adjusted outside of a range with respect to a current audio level corresponding to the multiple audio sources in response to detecting a portion of the fifth input, the computer system does not cause the audio level corresponding to the multiple audio sources being adjusted. Choosing whether to display, via the display generation component, the indication that the audio level corresponding to the multiple audio sources being adjusted based on whether a set of one or more criteria is satisfied allows the computer system to automatically choose when to show that the multiple audio sources being adjusted based on the audio level corresponding to the first audio source being adjusted to be outside of the range of the audio level corresponding to the multiple audio sources, thereby reducing the number of inputs needed to perform an operation, providing additional control options, and performing an operation when a set of one or more conditions has been satisfied without requiring further user input.

In some embodiments, after outputting, via the output of output devices, media corresponding to the first audio source and outputting, via the one or more output devices, media corresponding to the second audio source: in accordance with a determination that a current number of active audio sources (and, In some embodiments, after detecting the change in the number of active audio sources) is greater than (and, In some embodiments, or equal to) a threshold number of audio sources (e.g., one or more) (e.g., a threshold number of audio source outputting media and/or that are active to output media), the computer system displays, via the display generation component, a first indication (e.g., a carrot and/or an indication that a user interface component (e.g., a user interface, a list, a menu, and/or a portion of a user interface) can be expanded and/or contracted), wherein the first indication is displayed concurrently with the control for adjusting the audio level corresponding to the multiple audio sources. In some embodiments, the first indication is displayed on, near, adjacent to, to right of, to left of, and/or inside of the control for adjusting the audio level corresponding to the multiple audio sources (e.g., closer to the control for adjusting the audio level corresponding to the multiple audio sources than another control and/or any other control). Displaying a first indication concurrently with the control for adjusting the audio level corresponding to the multiple audio sources provides the user with visual feedback that multiple audio sources are active and provides the user with control over the user interface to display or to cease to display additional controls, thereby performing an operation when a set of one or more conditions has been satisfied without requiring further user input, providing additional control options, and providing feedback.

In some embodiments, after displaying the first indication and in accordance with a determination that the current number of active audio sources (and, In some embodiments, after detecting the change in the number of active audio sources) is less than (and, In some embodiments, or equal to) the threshold number of audio sources (e.g., one or more) (e.g., a threshold number of audio source outputting media and/or that are active to output media), the computer system forgoes displaying the first indication. In some embodiments, in accordance with a determination that the current number of audio sources are outputting media (and, In some embodiments, after detecting the change in the number of audio sources outputting media) and/or the current number of active audio sources is greater than (and, In some embodiments, or equal to) threshold number of audio sources, the computer system continues to display the first indication. In some embodiments, after displaying the first indication, the computer system detects a change (and/or a deduction and/or decrease) in a number of active (and/or available) audio sources (e.g., a number of audio sources outputting media (e.g., from zero to one, from one to two, from two to one, from three to zero, and/or from five to six) and/or associated with media that is being output). In some embodiments, the computer system detects a change in the number of audio sources outputting media includes detecting that an audio source has transitioned from being active (e.g., an application associated with the audio source is opened, media associated with an audio source has started being played back, and/or a live communication session has started) to being inactive (e.g., an application associated with the audio source is closed, media associated with an audio source has stopped being played back, and/or a live communication session has ended) and/or vice-versa. Not displaying the first indication in accordance with a determination that a current number of active audio source is less than a threshold number of audio sources allows the computer system to automatically cease to display the first indication when less than a number of audio sources are active, thereby performing an operation when a set of one or more conditions has been satisfied without requiring further user input and providing feedback.

In some embodiments, while the first indication (e.g., in accordance with a determination that the current number of audio sources are outputting media (and, In some embodiments, after detecting the change in the number of audio sources outputting media) is less than (and, In some embodiments, or equal to) a threshold number of audio sources) is not displayed, the computer system detects that media corresponding to a third audio source (e.g., the first audio source, the audio source, and/or a different audio source) is active (e.g., has started to be output, media corresponding to the third audio source has started to be output and/or media corresponding to the third audio source has begun to be output). In some embodiments, in response to detecting that the third audio source is active (and, In some embodiments, in accordance with a determination that the current number of audio sources are outputting media (and, In some embodiments, after detecting the change in the number of audio sources outputting media) is greater than (and, In some embodiments, or equal to) threshold number of audio sources), the computer system displays (e.g., re-displaying and/or displaying again) the first indication. Displaying the first indication in response to detecting that the third audio source is active allows the computer system to automatically display the first indication when the third audio source becomes active (and, in some embodiments, when greater than a number of audio sources are active), thereby performing an operation when a set of one or more conditions has been satisfied without requiring further user input and providing feedback.

In some embodiments, while displaying the first indication (and, In some embodiments, while the media corresponding to the first audio source and/or the media corresponding to the second audio source is not being output), the computer system detects that a fourth audio source is inactive (e.g., has become inactive and/or media corresponding to the fourth audio source (e.g., the first audio source, the audio source, and/or a different audio source) has ceased being output). In some embodiments, in response to detecting that media corresponding to the fourth audio source is inactive (and, In some embodiments, in accordance with a determination that a current number of active audio sources are outputting media (and, In some embodiments, after detecting the change in the number of audio sources outputting media) is less than a threshold number (e.g., one, two, or more) of audio sources), the computer system ceases to display the first indication. In some embodiments, after the computer system has removed a respective audio source and/or ceased to display the respective audio source while one or more controls (e.g., one or more volume controls (e.g., sliders and/or buttons)) for the audio source is not displayed, the computer system does not display the indication corresponding to the audio source when the one or more controls for the audio source are redisplayed. Ceasing to display the first indication allows the computer system to automatically indicate when an audio source becomes inactive (and, in some embodiments, when less than a number of audio sources are active), thereby performing an operation when a set of one or more conditions has been satisfied without requiring further user input and providing feedback.

In some embodiments, while displaying the first indication, the computer system detects a sixth input (e.g., 705b and/or 705d and/or as discussed above in relation to 701 (e.g., a swipe input and/or a dragging input or, In some embodiments, a non-swipe and/or dragging input, such as an air input (e.g., a pointing air gesture, a waving air gesture, and/or a moving air gesture), a gaze input, a mouse click-and-drag input, a voice command, and/or a moving input (e.g., such as moving the computer system in a particular direction)) directed to the first indication. In some embodiments, in response to detecting the sixth input: the computer system displays, via the display generation component, a plurality of controls for adjusting audio levels, including the control for adjusting the audio level corresponding to the first audio source independently of adjustments to the audio level corresponding to the second audio source; and a second control for adjusting the audio level corresponding to the second audio source independently of adjustments to the audio level corresponding to the first audio source. In some embodiments, in response to detecting an input directed to the second control for adjusting the audio level corresponding to the second audio source independently of adjustments to the audio level corresponding to the first audio source, the computer system performs one or more operations that the computer system performs in response to detecting an input directed to the first control for adjusting the audio level corresponding to the second audio source independently of adjustments to the audio level corresponding to the first audio source as described above. Displaying the plurality of controls in response to detecting the sixth input directed to the first indication allows the computer system to provide the user with an option to display additional controls, thereby providing additional control options.

In some embodiments, while displaying the control for adjusting the audio level corresponding to the first audio source and the second control for adjusting the audio level corresponding to the second audio source, the computer system detects a seventh input (e.g., 705b and/or 705d and/or as discussed above in relation to 701) (e.g., a swipe input and/or a dragging input or, In some embodiments, a non-swipe and/or dragging input, such as an air input (e.g., a pointing air gesture, a waving air gesture, and/or a moving air gesture), a gaze input, a mouse click-and-drag input, a voice command, and/or a moving input (e.g., such as moving the computer system in a particular direction)). In some embodiments, in response to detecting the seventh input and in accordance with a determination that the seventh input is directed to the control for adjusting the audio level corresponding to the first audio source, the computer system adjusts output of media corresponding to the first audio source without adjusting output of media corresponding to the second audio source (and/or adjusting an audio level of media corresponding to the first audio source without adjusting an audio level of media corresponding to the second audio source). In some embodiments, in accordance with a determination that the seventh input is directed to the second control for adjusting the audio level corresponding to the second audio source, the computer system adjusts output of media corresponding to the second audio source without adjusting output of media corresponding to the first audio source (and/or adjusting the audio level of media corresponding to the second audio source without adjusting the audio level of media corresponding to the first audio source). Adjusting output of media corresponding to a particular audio source without adjusting output of media corresponding to another audio source when certain conditions are satisfied allows the computer system to provide the user with separate controls options for adjusting a respective audio source independently from another respective audio source, thereby reducing the number of inputs needed to perform an operation and providing additional control options.

In some embodiments, while outputting, via the one or more output devices, media corresponding to the first audio and outputting, via the one or more output devices, media corresponding to the second audio source, the computer system displays the control for adjusting the audio level corresponding to the first audio source independently of adjustments to the audio level corresponding to the second audio source concurrently with a first indication (e.g., an application icon and/or a representation (e.g., an avatar, a set of one or more initials corresponding to, and/or a face representation) of a participant in a real-time communication session) corresponding to the first audio source. In some embodiments, while outputting, via the one or more output devices, media corresponding to the first audio and outputting, via the one or more output devices, media corresponding to the second audio source, the computer system displays a third control for adjusting the audio level corresponding to the second audio source independently of adjustments to the audio level corresponding to the first audio source concurrently with a first indication (e.g., an application icon and/or a representation (e.g., an avatar, an initial corresponding to, and/or a face representation) of a participant in a real-time communication session) corresponding to the second audio source, wherein the first indication corresponding to the second audio source has a different visual appearance (e.g., a different avatar, representation, and/or set of one or more initials, and/or application icons) from a visual appearance of the first indication corresponding to the first audio source. In some embodiments, the control for adjusting the audio level corresponding to the first audio source is displayed concurrently with the third control for adjusting the audio level corresponding to the second audio source. Displaying different controls for adjusting the audio level for different audio sources with different indications independently provides feedback to the user concerning the audio source that will be adjusted based on input directed to a particular control, which reduces the number of potential errors made when providing input, thereby reducing the number of inputs needed to perform an operation and providing feedback.

In some embodiments, while displaying the control for adjusting the audio level corresponding to the first audio source independently of adjustments to the audio level corresponding to the second audio source concurrently with the first indication corresponding to the first audio source, the computer system detects a change with respect to the first audio source. In some embodiments, detecting the change with respective to the first audio source includes detecting that a first media for the first audio source has ceased playing and a second media for the second audio source has started playing, detecting that a person in the live communication session (e.g., video and/or audio communication session (e.g., a group communication session and/or multi-participant communication session)) has left the live communication session, and/or detecting that the person in the live communication session has joined the live communication session. In some embodiments, in response to detecting the change with respect to the first audio source, the computer system displays a second indication corresponding to the first audio source that has a different visual appearance from a visual appearance of the first indication corresponding to the first audio source. In some embodiments, in response to detecting the change with respect to the first audio source, the computer system ceases displaying the first indication corresponding to the first audio source. In some embodiments, in response to detecting the change with respective to the first audio source, the computer system shrinks and/or enlarges the first indication corresponding to the first audio source. In some embodiments, in response to detecting the change with respective to the first audio source, the computer system continues to display (and/or does not cease to display and/or alter the display of) the first indication corresponding to the second audio sources. In some embodiments, while displaying the third control for adjusting the audio level corresponding to the second audio source independently of adjustments to the audio level corresponding to the first audio source concurrently with the first indication corresponding to the second audio source, the computer system detects a change with respect to the second audio source. In some embodiments, in response to detecting the change with respective to the second audio source, the computer system displays a second indication corresponding to the second audio source that is visually different from the second indication corresponding to the second audio source. Displaying a second indication corresponding to the first audio source that is visually different from the first indication corresponding to the first audio source in response to detecting the change with respective to the first audio source allows the computer system to automatically update the indication corresponding to the first audio source based on a change with respect to the first audio source, thereby performing an operation when a set of one or more conditions has been satisfied without requiring further user input and providing improved feedback.

In some embodiments, the computer system detects a request to output media corresponding to a fifth audio source (e.g., different from the first audio source and the second audio source). In some embodiments, the request to output media corresponding to the fifth audio source is a request to initiate output of media corresponding to the fifth audio source, a request to launch an application, a request to initiate playback of media, a request to answer of a phone call, a request to enter a live communication session (e.g., a video communication session and/or an audio communication session), and/or a request to interact with a media application (e.g., a television, video, and/or audio application). In some embodiments, in response to detecting the request to output media corresponding to the fifth audio source, the computer system outputs, via the one or more output devices, media corresponding to the fifth audio source at an audio level that is based on (and/or, In some embodiments, is) the last-used audio level for the fifth audio source (e.g., an audio level that was previously used with the fifth audio source before output of media corresponding to the fifth audio source ceased to be output). In some embodiments, the audio level that is based on the last-used audio level for the fifth audio source is not the audio level corresponding to the multiple audio sources. Outputting, via the one or more output devices, media corresponding to the fifth audio source at an audio level that is based on the last-used audio level for the fifth audio source in response to detecting the request to output media corresponding to the fifth audio source allows the computer system to automatically cause media to be output based on a last-used audio level for a particular audio source when media corresponding to the particular audio source begin outputting media, thereby performing an operation when a set of one or more conditions has been satisfied without requiring further user input and providing improved feedback.

In some embodiments, the computer system detects a request to output media corresponding to a sixth audio source (e.g., different from the first audio source and the second audio source). In some embodiments, the request to output media corresponding to the fifth audio source is a request to initiate output of media corresponding to the fifth audio source, a request to launch an application, a request to initiate playback of media, a request to answer of a phone call, a request to enter a live communication session (e.g., a video communication session and/or an audio communication session), and/or a request to interact with a media application (e.g., a television, video, and/or audio application). In some embodiments, in response to detecting the request to output media corresponding to the sixth audio source, the computer system outputs, via the one or more output devices, media corresponding to the sixth audio source at the audio level corresponding to the multiple audio sources (and not a last-used audio level for the sixth audio source). In some embodiments, the audio level corresponding to the multiple audio sources corresponds to the highest, current audio level for an active audio source. Outputting, via the one or more output devices, media corresponding to the sixth audio source at the audio level corresponding to the multiple audio source allows the computer system to automatically cause media to be output based on the audio level of the main audio source, thereby performing an operation when a set of one or more conditions has been satisfied without requiring further user input and providing improved feedback.

In some embodiments, the first audio level and the second audio level has a first ratio. In some embodiments, an audio level of the output of media corresponding to the first audio source that is adjusted by first amount of adjustment and an audio level of the output of media corresponding to the second audio source that is adjusted by the second amount of adjustment has the first ratio. In some embodiments, the ratio between different audio sources is determined based on the current difference between the levels of the different audio sources. Proportionally adjusting output of media corresponding to the multiple audio sources (e.g., in response to detecting the first input) based on a ratio allows the computer system to provide the user with control options for proportionally adjusting multiple audio sources, thereby reducing the number of inputs needed to perform an operation and providing additional control options.

In some embodiments, after adjusting output of media corresponding to the first audio source without adjusting output of media corresponding to the second audio source in response to detecting the second input (e.g., 705b and/or 705d and/or as discussed above in relation to 701), an audio level of the output of media corresponding to the first audio source adjusted in response to detecting the second input and an audio level of the output of media corresponding to the second audio source that was not adjusted in response to detecting the second input has a second ratio that is different from the first ratio. In some embodiments, the ratio (e.g., ratio of adjustment and/or ratio of audio levels) between two audio sources changes after an audio level corresponding an audio source is adjusted (e.g., independently of the other audio source). Changing the ratio that audio sources are proportionally adjusted when an audio source is adjusted independent of another allows the computer system to provide the user with control options for proportionally adjusting multiple audio sources, thereby reducing the number of inputs needed to perform an operation and providing additional control options.

In some embodiments, in response to detecting the first input (and/or, In some embodiments, in response to detecting the second input) (and, In some embodiments, while proportionally adjusting output of media corresponding to the multiple audio sources) and in accordance with a determination that the audio level corresponding to the multiple audio sources is within a first range (e.g., a range (e.g., a non-zero range) of audio, volume, and/or sound levels (e.g., between 0-10 volume levels)) (e.g., a range that includes and/or is a minimum value and/or a maximum value) of audio levels, the computer system adjusts an audio level corresponding to a first set of one or more system sound effects while adjusting one or more audio levels in accordance with the first input (and/or one or more audio levels corresponding to one or more sets of system sound effects). In some embodiments, in response to detecting the first input and in accordance with a determination that the audio level corresponding to the multiple audio sources is within a second range (e.g., a range (e.g., a non-zero range) of audio, volume, and/or sound levels (e.g., 5-100 volume levels)) (e.g., a range that includes and/or is not a minimum value and/or a maximum value) of audio levels that is different from the first range of audio levels, the computer system forgoes adjusting the audio level corresponding to the first set of one or more system sound effects while adjusting one or more audio levels in accordance with the first input. In some embodiments, the first range of audio levels does not overlap with the second range of audio levels. In some embodiments, the first range includes a minimum and/or terminal audio level, and the second range does not include a minimum and/or terminal audio level. Choosing whether to adjust the audio level corresponding to the first set of one or more system sound effects based on whether the audio level corresponding to the multiple audio sources is in a particular range of audio levels allows the computer system to choose whether to adjust the audio level corresponding to one or more sound effects, thereby reducing the number of inputs needed to perform an operation and performing an operation when a set of one or more conditions has been satisfied without requiring further user input.

In some embodiments, the first set of one or more system sound effects include one or more user interface sound effects (e.g., one or more operating system sound effects, virtual control feedback, object selection feedback, focus movement feedback, and/or hardware control feedback). Choosing whether to adjust the audio level corresponding to the first set of one or more system sound effects that include one or more user interface sound effects based on whether the audio level corresponding to the multiple audio sources is in a particular range allows the computer system to choose whether to adjust the audio level corresponding to one or more user interface sound effects, thereby reducing the number of inputs needed to perform an operation and performing an operation when a set of one or more conditions has been satisfied without requiring further user input.

In some embodiments, the first set of one or more system sound effects include one or more ambient sounds effects (e.g., sound effects that go along with a virtual background or a virtual, three-dimensional environment). In some embodiments, the first set of one or more system sound effects include one or more virtual assistant sound effects (e.g., the audio level and/or sound level of one or more virtual assistants). Choosing whether to adjust the audio level corresponding to the first set of one or more system sound effects that include one or more ambient sound effects based on whether the audio level corresponding to the multiple audio sources is in a particular range allows the computer system to choose whether to adjust the audio level corresponding to one or more ambient sound effects, thereby reducing the number of inputs needed to perform an operation and performing an operation when a set of one or more conditions has been satisfied without requiring further user input.

In some embodiments, in response to detecting the first input (e.g., 705a and/or as discussed above in relation to 701) and while proportionally adjusting output of media corresponding to the multiple audio sources, the computer system displays (e.g., concurrently displaying) a plurality of adjustment indications including system an indication that an audio level corresponding to a second set of one or more system sound effects being adjusted based on the first input; and an indication that an audio level corresponding to a third set of one or more system sound effects being adjusted based on the first input. In some embodiments, the third set of one or more system sounds effects is different from the second set of one or more system sound effects. In some embodiments, the indication that the audio level corresponding to the second set of one or more system sound effects being adjusted based on the first input and the indication that the audio level corresponding to the third set of one or more system sound effects being adjusted based on the first input are different from each other. In some embodiments, proportionally adjusting output of media corresponding to the multiple audio sources includes, the computer system causes the audio level corresponding to the second set of one or more system sound effects to be adjusted based on the first input. In some embodiments, proportionally adjusting output of media corresponding to the multiple audio sources includes, causing the audio level corresponding to the third set of one or more system sound effects to be adjusted based on the first input. In some embodiments, the audio level corresponding to the third set of one or more system sound effects is proportionally adjusted relative to the audio level corresponding to the second set of one or more system sound effects is proportionally adjusted. In some embodiments, the audio level corresponding to the third set of one or more system sound effects is not proportionally adjusted relative to the audio level corresponding to the second set of one or more system sound effects is proportionally adjusted. Displaying the plurality of adjustment indications for multiple system sound effects allows the computer system to automatically display separate indications of how different audio levels for different system sound effects are being changed, thereby performing an operation when a set of one or more conditions has been met without requiring further user input, reducing the number of inputs needed to perform an operation (e.g., to correct errors), and providing feedback.

In some embodiments, the computer system displays, via the display generation component, a list of available audio sources. In some embodiments, while displaying the list of available audio sources, the computer system detects that media corresponding to a seventh audio source is active (e.g., as described above). In some embodiments, in response to detecting that the seventh audio source is active, the computer system displays, via the display generation component, a control corresponding to the seventh audio source in the list of available audio sources. Displaying, via the display generation component, a control corresponding to the seventh audio source in the list of available audio sources in response to detecting that the seventh audio source is active allows the computer system to provide the user with a control option when the seventh audio source is being output, thereby reducing the number of inputs needed to perform an operation and performing an operation when a set of one or more conditions has been satisfied without requiring further user input.

In some embodiments, while displaying the control corresponding to the seventh audio source, the computer system detects an eighth input (e.g., 705b and/or 705d and/or as discussed above in relation to 701) (e.g., a tap input and/or In some embodiments, a non-tap input, such as an air input (e.g., a pointing air gesture, a tapping air gesture, and/or a moving air gesture), a gaze input, a mouse click input, a voice command, and/or a selection input (e.g., such as moving the computer system in a particular direction)) directed to the control corresponding to the seventh audio source. In some embodiments, in response to detecting the eighth input, the computer system displays, via the display generation component, a first control for adjusting a first audio level corresponding to the seventh audio source independently of adjustments to the audio level corresponding to one or more other audio sources (e.g., the first audio source, the second audio source, and/or another audio source). In some embodiments, in response to detecting input on the second control for adjusting an audio level corresponding to the seventh audio source independently of adjustments to the audio level corresponding to one or more other audio sources, the computer system adjusts the audio level corresponding to the seventh audio source without adjusting audio level(s) corresponding to one or more other audio sources. Displaying a first control for adjusting a first audio level corresponding to the seventh audio source independently of adjustments to the audio level corresponding to one or more other audio source in response to detecting the eighth input allows the computer system to provide a user with the option to display a control option to adjust the seventh audio source independently, thereby providing additional control options.

In some embodiments, while displaying the control corresponding to the seventh audio source, the computer system detects a ninth input (e.g., 705b and/or 705d and/or as discussed above in relation to 701) (e.g., a tap input and/or In some embodiments, a non-tap input, such as an air input (e.g., a pointing air gesture, a tapping air gesture, and/or a moving air gesture), a gaze input, a mouse click input, a voice command, and/or a selection input (e.g., such as moving the computer system in a particular direction)) directed to the control corresponding to the seventh audio source. In some embodiments, in response to detecting the ninth input, the computer system ceases to display a second control for adjusting a second audio level corresponding to the seventh audio source independently of adjustments to the audio level corresponding to one or more other audio sources (optionally while maintaining display of one or more controls for controlling audio level(s) corresponding to one or more audio sources) (e.g., the first audio source, the second audio source, and/or another audio source) (e.g., as described above in relation to the first control for adjusting the audio level corresponding to the seventh audio source independently of adjustments to the audio level corresponding to one or more other audio sources). Displaying a second control for adjusting a second audio level corresponding to the seventh audio source independently of adjustments to the audio level corresponding to one or more other audio source in response to detecting the eighth input allows the computer system to provide a user with the option to cease to display a control option to adjust the seventh audio source independently, thereby providing additional control options.

In some embodiments, the first audio source is a set of audio sources corresponding to one or more communication applications (e.g., one or more phone call applications and/or one or more video call applications). In some embodiments, the second set of one or more audio sources is a set of audio sources that correspond to applications that are not communication applications. Allowing the proportional adjustment output of media corresponding to the multiple audio sources (e.g., in response to detecting the first input directed to the control for adjusting the audio level corresponding to the multiple audio sources) and adjusting output of media corresponding to communication applications without adjusting output of media corresponding to the non-communication applications (e.g., in response to detecting the second input directed to a control for adjusting an audio level corresponding to the first audio source independently of adjustments to the audio level corresponding to the second audio source) (and/or vice-versa) allows the computer system to provide the user with different control options for adjusting audio corresponding to the communication applications differently from audio corresponding to non-communication applications, thereby reducing the number of inputs needed to perform an operation and providing additional control options.

In some embodiments, the first audio source is a set of audio sources corresponding to one or more environmental audio sources (e.g., environmental sounds from audio sources that surround and/or are external to the computer system, such as a television, speaker, and/or conversation in the physical environment and/or ambient environmental sounds). In some embodiments, the second set of one or more audio sources is a set of audio sources that do not correspond to one or more environmental audio sources. In some embodiments, a control for the set of audio sources corresponding to one or more communication applications, a control for the set of audio sources corresponding to one or more non-communication applications, a control for the set of audio sources corresponding to one or more environmental audio sources, and/or a control for the set of audio sources that do not correspond to one or more environmental audio sources are (e.g., two or more of them are and/or a plurality of them are) concurrently displayed by the computer system. Allowing the proportional adjustment output of media corresponding to the multiple audio sources (e.g., in response to detecting the first input directed to the control for adjusting the audio level corresponding to the multiple audio sources) and adjusting output of media corresponding to environmental audio sources without adjusting output of media corresponding to the non-environmental audio sources (e.g., in response to detecting the second input directed to a control for adjusting an audio level corresponding to the first audio source independently of adjustments to the audio level corresponding to the second audio source) (and/or vice-versa) allows the computer system to provide the user with different control options for adjusting audio corresponding to the environmental audio sources differently from audio corresponding to non-environmental audio sources, thereby reducing the number of inputs needed to perform an operation and providing additional control options.

Note that details of the processes described above with respect to method 800 and 800 (e.g., FIGS. 8A-8B) are also applicable in an analogous manner to the methods described herein. For example, method 800 optionally includes one or more of the characteristics of the various methods described above with reference to method 1000. For example, one or more steps of method 1000 for changing prominence of audio can be used after lowering the audio output using one or more steps of method 800. For brevity, these details are not repeated below.

FIGS. 9A-9H illustrate exemplary user interfaces for managing for managing the prominence of audio in accordance with some embodiments. The user interfaces in these figures are used to illustrate the processes described below, including the processes in FIG. 10.

FIGS. 9A-9H illustrate exemplary user interfaces for audio attenuation based on gaze inputs within a three-dimensional environment using a computer system that is in communication with one or more output devices in accordance with some embodiments. The user interfaces in these figures are used to illustrate the processes described below, including the processes in FIG. 10.

FIGS. 9A-9H illustrate a top portion including a top-down view of a user with various virtual and conceptual objects in a three-dimensional environment as well as a bottom portion including a representation of the viewpoint of computer system 700. While the examples are described with respect to computer system 700 performing one or more operations and/or providing audio output, computer system 990 is optionally used to perform one or more operations. At FIG. 9A, computer system 700 is a tablet while computer system 990 is an HMD device. In some embodiments, one or more other types of computer systems, can be used to perform the one or more operations discussed below.

FIG. 9A illustrates user 924 within three-dimensional environment 900, further referred to as environment 900 (e.g., an XR environment), along with physical object 902 (a table) to the user's right, physical object 904 (a television) in front of the user, and physical object 906 (a couch) to the user's left. Physical objects 902-906 represent physical objects within environment 900. At FIG. 9A, applications 908, 910, 912, and 914 are virtual objects (e.g., windows of applications of computer system 700). In FIGS. 9A-9H, computer system 700 outputs audio corresponding to one or more of the virtual objects. The virtual objects in this example are conceptual representations (e.g., are not a part of a physical environment) of applications, which computer system 700 displays to user 924 (e.g., as seen in bottom portion of FIGS. 9A-9H) due to user 924's relative positioning within environment 900. In FIG. 9A, application 908 is positioned in front of physical object 902, application 910 is positioned in front of physical object 904, application 912 is positioned on the right size of object 806, and application 914 is positioned on the left side of physical object 906. In some embodiments, computer system 700 displays application windows in different locations relative to physical objects within environment 900.

Within environment 900, computer system 700 outputs audio from applications corresponding to that application with an amount of prominence based on the category of the application. In some embodiments, computer system 700 uses one or more audio output devices to output the audio. The categories of applications sourced from computer system 700 will further be referred to as persistent or non-persistent applications. In some embodiments, computer system 700 continues to output audio of persistent applications with an elevated prominence even when computer system 700 does not detect the user's attention directed to the application and/or when a non-persistent application is closed and/or ceases to be visible in the environment. In some embodiments, persistent applications can include music, spoken audio (e.g., podcast or book), and/or communication applications. In some embodiments, persistent applications include one or more characteristics described above in relation to FIGS. 70-7Q. In some embodiments, computer system 700 lowers the prominence of audio output for a non-persistent application when computer system 700 does not detect the user's attention being directed to the non-persistent application and/or when the non-persistent application is closed and/or ceases to be visible in the environment. In this example, non-persistent applications are a sports game and a voice memos application. As mentioned above, computer system 700 outputs audio from an application at a first prominence while computer system 700 detects that the user's gaze is directed to an application. When computer system 700 detects that the user's attention has moved away from that application, computer system 700 outputs audio from the application at a second prominence (e.g., a lower prominence than the first prominence). In some embodiments, computer system 700 does not alter the prominence of an application (e.g., a persistent application) in response to detecting that the user's attention has moved away from the application.

FIG. 9A illustrates within environment 900, in this example represented as speakers, indicators near each application that represent the prominence of the audio (e.g., which is based on whether or not computer system 700 detects that the user's attention is directed to a particular application). FIG. 9A represents within environment 900 the prominence of an application by illustrating some indicators as being dim. A dimmed indicator represents computer system 700 outputting audio at a lower level of prominence or not outputting audio at all. While an undimmed indicator represents computer system 700 outputting audio a higher level of prominence.

As illustrated in FIG. 9A, after detecting user 924's attention directed toward application 910, computer system 700 outputs audio at a higher level of prominence for application 910 (e.g., as indicated 910a-910b being undimmed and sound indicator 928 being larger that sound indicator 920 and 926). However, while outputting the audio at the higher level of prominence for application 910, computer system 700 also outputs audio corresponding to application 912 and application 914 at a lower prominence level (e.g., because the user's attention is not directed to these applications) (e.g., as indicated by 912a and 914 being dimmed).

Also illustrated in FIG. 9A, within environment 900, are sound indicators 916, 920, and 926, which vary in size depending on the prominence (e.g., volume (e.g., reducing to below 50% of original volume or, optionally, to 10-15% of original volume), clarity, and/or reverberation) of the spatialized audio that computer system 700 outputs from each application. Sound indicators illustrated as being larger represent a higher prominence than sound indicators that are illustrated as being smaller. In some embodiments, small sound indicators represent a muffled audio output (e.g., lower prominence) from the application to which they are adjacent (or associated with) in the environment. A lack of either large or small sound indicators between user 924 and spatial audio indicators (e.g., 908a-908b for application 908) depicts a lack of audio output by computer system 700 for the representative application (e.g., a lack of 918 of FIG. 9C and dimmed 908a-908b at FIG. 9A depicts no audio output for application 908).

FIG. 9A also includes a bottom portion which illustrates computer system 700, which is an output device from which the application windows described above are sourced. Computer system 700 includes viewpoint 902, which is a visual representation of the view displayed by computer system 700 to user 924 depending on user 924's orientation within the environment 900. Viewpoint 902 includes objects 902-906 in the relative positions as user 924 sees them as well as visual representation 904, which is the window associated with application 910, to which computer system 700 detects the user's gaze is directed. At FIG. 9B, computer system 700 detects that user 924 has directed their attention to application 908. Application 908 is a music application that includes one or more media controls, such as play button 986. In addition, at FIG. 9B, computer system 700 detects a gaze input of user 924 at a location corresponding to play button 986.

As illustrated in FIG. 9C, in response to detecting the gaze input at FIG. 9B, computer system 700 initiates playback of audio corresponding to application 908 at a higher prominence level (e.g., because the attention of user 942 is directed to application 908). In some embodiments, at FIG. 9C, computer system 700 reduces the prominence of audio for one or more applications, such as application 910 in response to computer system 700 initiating playback of audio that has a higher prominence level. In some embodiments, reducing the prominence of prominence of audio for one or more applications includes increasing the amount of reverberation, such that the audio corresponding to the application sounds more muffled than the audio sounded previously. As shown in FIG. 9C, computer system 700 detects that user 942 without user 924 changing their core displacement (e.g., measure via the tors or feat of a user) relative to the one or more applications.

At FIG. 9D, application 922 is positioned between user 924 and application 908 in environment 900. In response to detecting application 922, computer system 700 decreases the prominence level of application 908, which is indicated within environment 900 by shrinking sound indicator 918 and dimming indicators 908a-908b. Computer system 700 reduces the prominence of application 908 because a determination is made that application 908 is currently occluded by one or more portions of application 922. Thus, computer system 700 can lower prominence when an object and/or person occludes the user from view the virtual object to which the user's attention was directed towards.

At FIG. 9E, computer system 700 detects that the attention of user 924 has moved from application 908 to application 912. In response, computer system 700 outputs audio corresponding to application 912 with a higher level of prominence (e.g., as indicated by indicator 912 not being dim and sound indicator 920 being enlarged). As shown in FIG. 9E, computer system 700 continues to output audio from application 908 at a higher prominence level (e.g., as indicated by sound was being enlarged in between the back of user 942 and physical object 902). Here, computer system 700 continues to output audio from application 908 at a higher prominence level because a determination has been made that application 908 is a persistent application. As illustrated in FIG. 9E, computer system 700 outputs audio at the same level from both application 908 and application 912. However, in some embodiments, computer system 700 outputs audio corresponding application 908 different from audio corresponding to application 912 with respect to the prominence of audio output. At FIG. 9E, computer system 700 detects hand input 905e from user 924.

As illustrated in FIG. 9F, in response to detecting hand input 905e2, computer system 700 closes application 912 and stops outputting audio corresponding to application 912 because application 912 is a non-persistent application. In addition, computer system 700 detects that the attention of the user is directed to application 914. In response, computer system 700 begins outputting audio corresponding to application 914 at a high prominence level. Here, computer system 700 reduces the prominence of audio corresponding to application 908 because both application 914 and application 908 are persistent applications. In some embodiments, when two applications are persistent applications, an application that starts outputting audio later at a higher prominence can override the prominence (or reduce the prominence) of an already established persistent application. At FIG. 9F, computer system 700 detects hand input 905f from user 924.

As illustrated in FIG. 9G, in response to detecting hand input 90f, computer system 700 closes application 914. However, computer system 700 continues to output audio corresponding to application 914 at a high prominence because application 914 is a persistent application (e.g., using one or more techniques described above). At FIG. 9G, computer system 700 detects gaze input 905g at a particular location in the environment. As illustrated in FIG. 9H, in response to detecting gaze input 905g at the particular location in the environment, computer system 700 displays audio control center 718, which includes audio controls for application 908 and application 914 (e.g., the persistent applications). Thus, in some embodiments, audio controls can be accessed from a user interface application even when the persistent applications are no longer visible in the environment.

FIG. 10 is a flow diagram for illustrating a method for managing the prominence of audio in accordance with some examples. Some operations in method 1000 are, optionally, combined, the orders of some operations are, optionally, changed, and some operations are, optionally, omitted.

As described below, method 1000 provides an intuitive way for managing the prominence of audio. Method 1000 reduces the cognitive burden on a user for managing the prominence of audio, thereby creating a more efficient human-machine interface. For battery-operated computing devices, enabling a user to manage the prominence of audio faster and more efficiently conserves power and increases the time between battery charges. In some embodiments, method 1000 is performed at a computer system (e.g., 700 and 990) (e.g., as described above in relation to method 800) that is in communication with one or more audio output devices (e.g., as described above in relation to method 800) and a display generation component (e.g., as described above in relation to method 800).

At 1002, while a first object (e.g., 1184 corresponding to an application (e.g., a user interface, a virtual object and/or a physical object (e.g., corresponding to an application, a window, a user interface, and/or a user account)) is visible (e.g., a virtual object that is displayed using, and/or a physical object that can be seen through (e.g., via a transparent display and/or via a display where the opacity of the display is adjustable)), via the display generation component, the computer system outputs, via the one or more audio outputs, audio corresponding to the first object at a first prominence of audio output (e.g., amount of sound, level of audio, volume, amount of high frequency sounds, amount of medium frequency sounds, amount of low frequency sounds, amount of base, amount of fidelity, amount of pitch, speed of audio playback, and/or amount of tone (e.g., as compared to other audio output (e.g., via the one or more audio output devices)))).

At 1004, while outputting audio corresponding to the first object (e.g., 908, 910, 912, 914, and/or APP1-APP4) at the first prominence of audio output, the computer system detects an occurrence of an event that includes detecting attention of a user moving away from being directed to the first object (e.g., 908, 910, 912, 914, and/or APP1-APP4) (e.g., as described above in relation to FIGS. 9A-9D). In some embodiments, detecting attention of the user moving away from being directed to the first object includes detecting a viewpoint of the user and/or computer system (e.g., 700 and 990) changing from a first viewpoint (e.g., a field of view, an area of focus, a displayed area, and/or a provided area) to a second viewpoint different from the first viewpoint. In some embodiments, the first object is included in the first viewpoint includes the first object and not included in the second viewpoint. In some embodiments, the first object is included closer to a center of the first viewpoint than a center of the second viewpoint (e.g., but the first object is included in the first viewpoint and the second viewpoint). In some embodiments, before detecting attention of the user moving away from being directed to the first object, the computer system (e.g., 700 and 990) detects attention of the user being directed to the first object.

At 1006, in response to detecting the occurrence of the event that includes detecting the attention of the user moving away from being directed to the first object (e.g., 908, 910, 912, 914, and/or APP1-APP4), the computer system outputs, via the one or more audio output devices, the audio corresponding to the first object (e.g., 908, 910, 912, 914, and/or APP1-APP4) at a second prominence of audio output that is lower than (e.g., less than and/or reduced from) the first prominence of audio output (e.g., as described above in relation to FIGS. 9A-9D). In some embodiments, in response to not detecting the occurrence of the event that includes detecting the attention of the user moving away from being directed to the first object, the computer system (e.g., 700 and 990) continues to output the audio corresponding to the first object at the first prominence of audio output. Outputting, via the one or more audio output devices, the audio corresponding to the first object at a second prominence of audio output that is lower than the first prominence of audio output in response to detecting the occurrence of the event that includes detecting the attention of the user moving away from being directed to the first object allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, detecting the attention of the user moving away from being directed to the first object (e.g., 908, 910, 912, 914, and/or APP1-APP4) includes detecting a first gaze input (e.g., gaze of the user's eyes and/or direction of the user's eyes) of the user moving from a first gaze position to a second gaze position. In some embodiments, the first gaze position corresponds to a location corresponding to (e.g., at, of, and/or associated with) the first object (e.g., 908, 910, 912, 914, and/or APP1-APP4) and the second gaze position corresponds to a location that does not correspond to the first object (e.g., 908, 910, 912, 914, and/or APP1-APP4). In some embodiments, the user is not looking at and/or the first gaze input is not directed to the first object while the first gaze input is detected at the second gaze position. In some embodiments, the user is looking at and/or the first gaze input is directed to the first object while the first gaze input is detected at the first position. Outputting, via the one or more audio output devices, the audio corresponding to the first object at a second prominence of audio output that is lower than the first prominence of audio output in response to detecting a first gaze input of the user moving from a first gaze position to a second gaze position corresponding to a location that does not correspond to the first object allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, detecting the attention of the user moving away from being directed to the first object (e.g., 908, 910, 912, 914, and/or APP1-APP4) includes detecting that a second gaze input has not been directed to the first object for more than a threshold amount of time (e.g., as described above in relation to FIGS. 9A-9D) (e.g., 01-60 seconds). In some embodiments, detecting the attention of the user moving away from being directed to the first object includes detecting that the second gaze input has been directed to one or more locations not corresponding to the first object for more than the threshold amount of time. In some embodiments, detecting the attention of the user moving away from being directed to the first object includes detecting that the second gaze input has been directed to a location that is different from a location corresponding to the first object for more than the threshold amount of time. Outputting, via the one or more audio output devices, the audio corresponding to the first object at a second prominence of audio output that is lower than the first prominence of audio output in response to detecting that a second gaze input has not been directed to the first object for more than a threshold amount of time allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, detecting the attention of the user moving away from being directed to the first object (e.g., 908, 910, 912, 914, and/or APP1-APP4) includes detecting that a second object, different from the first object, is becoming active (e.g., as described above in relation to FIGS. 9A-9D) (e.g., and/or is currently active, and/or is transitioning to become active) (e.g., in focused, opened, and/or interacted with). In some embodiments, detecting attention of the user moving away from being directed to the first object includes activating (and/or causing activation of) the first object. Outputting, via the one or more audio output devices, the audio corresponding to the first object at a second prominence of audio output that is lower than the first prominence of audio output in response to detecting that a second object, different from the first object, is becoming active allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, detecting that the second object (e.g., 908, 910, 912, 914, and/or APP1-APP4) is becoming active includes detecting a third gaze input directed to the second object (e.g., as described above in relation to FIGS. 9A-9D) (and, in some embodiments, detecting that the third gaze input is not directed to the first object). In some embodiments, detecting the attention of the user moving away from being directed to the first object includes detecting the third gaze input directed to the second object. Outputting, via the one or more audio output devices, the audio corresponding to the first object at a second prominence of audio output that is lower than the first prominence of audio output in response to detecting that a third gaze input directed to the second object allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, detecting that the second object (e.g., 908, 910, 912, 914, and/or APP1-APP4) (e.g., a virtual object and/or a physical object (e.g., corresponding to an application, a window, a user interface, and/or a user account)) is becoming active includes detecting a fourth gaze input (e.g., 905b) has been directed to the second object for more than a second threshold amount of time (e.g., 0.01-60 seconds) (and, in some embodiments, detecting that the third gaze input is not directed to the first object for more than the second threshold amount of time). In some embodiments, detecting the attention of the user moving away from being directed to the first object includes detecting the fourth gaze input has been directed to the second object for more than the second threshold amount of time. In some embodiments, the second threshold amount of time is the same as the first threshold amount of time. In some embodiments, the second threshold amount of time longer than the first threshold amount of time, such that a user has to dwell on an object before the object becomes active longer than the user has to look away from an object for the object to become inactive. Outputting, via the one or more audio output devices, the audio corresponding to the first object at a second prominence of audio output that is lower than the first prominence of audio output in response to detecting a fourth gaze input has been directed to the second object for more than a second threshold amount of time allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, detecting that the second object is becoming active includes detecting an input (e.g., an air gesture (e.g., an air tap and/or an air pinch), an air gesture while a gaze input is detected, a mouse click, a tap input, an indirect input, a direct input, a voice command, an input directed to a physical and/or virtual controller and/or other physical and/or virtual mechanism) that is directed to the second object (e.g., as described above in relation to FIGS. 9A-9D) (and, in some embodiments, detecting that an input that is not directed to the first object). In some embodiments, detecting the attention of the user moving away from being directed to the first object includes detecting an input (e.g., an air gesture (e.g., an air tap and/or an air pinch), an air gesture while a gaze input is detected, a mouse click, a tap input, an indirect input, a direct input, a voice command, an input directed to a physical and/or virtual controller and/or other physical and/or virtual mechanism) that is directed to the second object. Outputting, via the one or more audio output devices, the audio corresponding to the first object at a second prominence of audio output that is lower than the first prominence of audio output in response to detecting an input that is directed to the second object allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby providing improved feedback to the user, saving battery power, the number of instructions processed, and/or time by reducing the need for the user to manually change the one or more audio properties, reducing the number of inputs needed to perform an operation, providing additional control options without cluttering the user interface with additional displayed controls, and performing an operation when a set of conditions has been met without requiring further user input.

In some embodiments, detecting the attention of the user moving away from being directed to the first object includes detecting that the first object is becoming (and/or is transitioning to become and/or is currently) inactive (e.g., as described above in relation to FIGS. 9A-9F) (e.g., not in focused, closed, exited, and/or not interacted with). Outputting, via the one or more audio output devices, the audio corresponding to the first object at a second prominence of audio output that is lower than the first prominence of audio output in response to detecting that the first object is becoming inactive allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, detecting that the first object is becoming inactive includes detecting a request to cease displaying the first object. In some embodiments, ceasing to display the first object includes detecting a request to close the first object, changing the first object from operating in the foreground to operating in the background, closing and/or exiting a window including the first object, and/or closing and/or exiting an application (e.g., corresponding to the first object). Outputting, via the one or more audio output devices, the audio corresponding to the first object at a second prominence of audio output that is lower than the first prominence of audio output in response to detecting a request to cease displaying the first object allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, detecting that the first object is becoming inactive includes detecting that the first object is obscured by (e.g., blocked by, covered by, overlapped by, in a direction but behind of, not visible because of, and/or obstructed by) a third object (e.g., 922) different from the first object (e.g., from a viewpoint of the user and/or from the gaze of the user). Outputting, via the one or more audio output devices, the audio corresponding to the first object at a second prominence of audio output that is lower than the first prominence of audio output in response to detecting that the first object is obscured by a third object different from the first object allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, before detecting the attention of the user moving away from being directed to the first object, the computer system (e.g., 700 and 990) is a first distance from the first object. In some embodiments, while (and/or after) detecting the attention of the user moving away from being directed to the first object, the computer system (e.g., 700 and 990) is the first distance from the first object. In some embodiments, detecting the attention of the user moving away from being directed to the first object does not include detecting a change in distance between the computer system and the first object (e.g., turning away but not moving laterally forward and/or away from the first object, not walking and/or moving away from, and/or not walking and/or toward the first object (e.g., before, while, and/or after, the attention of the user is detected as moving away from being directed to the first object)).

In some embodiments, detecting the attention of the user moving away from being directed to the first object includes detecting an interaction (e.g., as described above in relation to FIGS. 9E-9F) (e.g., via one or more inputs, such as one or more gaze inputs, tap inputs, air gestures (e.g., air taps, air swipes, and/or air pinches), mouse clicks, and/or inputs detected via a physical and/or virtual controller) with a fourth object different from the first object. Outputting, via the one or more audio output devices, the audio corresponding to the first object at a second prominence of audio output that is lower than the first prominence of audio output in response to detecting an interaction with a fourth object different from the first object allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, outputting, via the one or more audio output devices, the audio corresponding to the first object at the second prominence of audio output includes reducing a volume level of the audio corresponding to the first object (e.g., at the first prominence of audio output) from a first volume level (e.g., volume level of the audio corresponding to the first object at the first prominence of audio output and/or volume level of the audio corresponding to the first object before detecting the attention of the user moving away from being directed to the first object) to a second volume level (e.g., volume level of the audio corresponding to the first object at the second prominence of audio output and/or volume level of the audio corresponding to the first object after and/or in response to detecting the attention of the user moving away from being directed to the first object) different from the first volume level (e.g., as described above in relation to FIGS. 9A-9D). In some embodiments, the first volume is above 50% of the system volume level and/or the maximum volume level. In some embodiments, the second volume level is below 50% of the system volume level and/or the maximum volume level. In some embodiments, the second volume level is 5%-20% below the first volume level and/or the previous volume level. Reducing a volume level of the audio corresponding to the first object in response to detecting the attention of the user moving away from being directed to the first object allows the computer system to reduce the volume of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, outputting, via the one or more audio output devices, the audio corresponding to the first object at the second prominence of audio output includes increasing an amount of reverberation (e.g., reverberation time, RT60, RT30, and/or RT20) for the audio corresponding to the first object (e.g., at the first prominence of audio output) from a first reverberation level (e.g., amount of reverberation for the audio corresponding to the first object at the first prominence of audio output and/or amount of reverberation for the audio corresponding to the first object before detecting the attention of the user moving away from being directed to the first object) to a second reverberation level (e.g., amount of reverberation for the audio corresponding to the first object at the second prominence of audio output and/or amount of reverberation for the audio corresponding to the first object after and/or in response to detecting the attention of the user moving away from being directed to the first object) different from the first reverberation level (e.g., as described above in relation to FIGS. 9A-9D). In some embodiments, increasing the amount of reverberation includes reducing a direct-to-reverberant ratio and/or a direct-to-reverberant energy ratio. Increasing an amount of reverberation for the audio corresponding to the first object in response to detecting the attention of the user moving away from being directed to the first object allows the computer system to reduce the prominence of audio output for objects, by increasing the amount of reverberation for the audio, to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, outputting, via the one or more audio output devices, the audio corresponding to the first object at the second prominence of audio output includes applying a low-pass filter to the audio corresponding to the first object at the first prominence of audio output (e.g., as described above in relation to FIGS. 9A-9D). In some embodiments, applying the low-pass filter includes reducing a ratio of high frequency components to low frequency components. Applying a low-pass filter to the audio corresponding to the first object at the first prominence of audio output in response to detecting the attention of the user moving away from being directed to the first object allows the computer system to reduce the prominence of audio output for objects, by reducing the amount of high frequency sounds relative to the amount of low frequency sounds, to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, while outputting, via the one or more audio output devices, the audio corresponding to the first object at the second prominence of audio output, the computer system detects an occurrence of a second event that includes detecting the attention of the user moving away from being directed to the first object (e.g., as described above in relation to FIGS. 9E-9F). In some embodiments, in response to detecting the occurrence of the second event that includes detecting the attention of the user moving away from being directed to the first object, the computer system reduces prominence of the output of audio corresponding to the first object by pausing the audio corresponding to the first object (e.g., as described above in relation to FIGS. 9E-9F). In some embodiments, in response to detecting the occurrence of the second event that includes detecting attention of the user moving away from being directed to the first object, the computer system exits out of the audio, ceases to display the first object, and/or mutes the audio. Pausing the audio corresponding to the first object in response to detecting the attention of the user moving away from being directed to the first object allows the computer system to reduce the prominence of audio output for objects to which the user may no longer be paying attention or for objects that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, while a fifth object different from the first object is visible, via the display generation component (e.g., 120), the computer system outputs, via the one or more audio output devices, audio corresponding to the fifth object at a third prominence of audio output (e.g., as described above in relation to FIGS. 9E-9F). In some embodiments, while outputting audio corresponding to the fifth object (and, in some embodiments, while the fifth object is visible and/or displayed via the display generation component (e.g., 120)) at a third prominence of audio output, the computer system detects an occurrence of a third event that includes detecting the attention of a user moving away from being directed to the first object (e.g., as described above in relation to FIGS. 9E-9F). In some embodiments, in response to detecting the occurrence of the third event that includes detecting the attention of the user moving away from being directed to the first object and in accordance with a determination that the fifth object corresponds to a first type of object (e.g., an object that corresponds to a persistent audio source, an important audio source, an audio that has been designed as persistent, relevant, and/or important), the computer system continues to output audio corresponding to the fifth object at the third prominence of audio output (e.g., as described above in relation to FIGS. 9E-9H). In some embodiments, in accordance with a determination that the fifth object corresponds to a second type of object (e.g., not an object that corresponds to a persistent audio source, not an important audio source, not an audio that has been designed as persistent, relevant, and/or important) different from the first type of object, the computer system forgoes outputting audio corresponding to the fifth object at the third prominence of audio output (e.g., as described above in relation to FIGS. 9E-9F). In some embodiments, in response to detecting the occurrence of the third event that includes detecting the attention of the user moving away from being directed to the first object and in accordance with a determination that the fifth object corresponds to the second type of audio, the computer system outputs audio corresponding to the fifth object at a respective prominence of audio output that is lower than the third prominence of audio output. Continuing or not continuing to output audio corresponding to the fifth object at the third prominence of audio output based on the type of object corresponding to the fifth object in response to detecting the occurrence of the third event that includes detecting the attention of the user moving away from being directed to the first object allows the computer system to automatically reduce the prominence of audio for some objects (e.g., non-persistent objects) while not reducing the prominence of audio for other objects (e.g., persistent objects) and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, the first type of object is an object that corresponds to a music application (e.g., a music playback application and/or sound playback application), a video application (e.g., a live video application, a movie application, a short-form video application, and/or a longer form video application), a spoken audio application (e.g., podcast and/or book), a communication application (e.g., live video communication application, a phone call application, and/or a messaging application), or one or more combinations thereof (e.g., as described above in relation to FIGS. 9A-9D). In some embodiments, the second type of object is not an object that corresponds to the music application the spoken audio application (e.g., podcast and/or book), the communication application, or one or more combinations thereof. In some embodiments, the first type of object corresponds to an application where a user would like to and/or is designed to continue playing audio while the application is closed. In some embodiments, the second type of object corresponds to an application where a user would not like to and/or is not designed to continue playing audio while the application is closed. In some embodiments, the first type of object corresponds to an application, where a background audio setting for the application has been enabled and/or is active. In some embodiments, the second type of object corresponds to an application, where the background setting for the application has been disabled and/or inactive. In some embodiments, the background audio setting can be enabled by a user and/or a developer of the computer system. In some embodiments, the background audio setting includes a setting for enabling a picture in picture mode and/or a wireless audio sharing mode.

In some embodiments, the computer system detects a request to display a system user interface. In some embodiments, in response to detecting the request to display the system user interface, the computer system displays, via the display generation component (e.g., 120), the system user interface (e.g., 718), including: a first control (e.g., 722a-722c) that, when selected, causes the computer system (e.g., 700 and 990) to adjust output of audio corresponding to the fifth object; and a second control (e.g., 722a-722c) that, when selected, causes the computer system to adjust output of audio corresponding to a sixth object (e.g., without adjusting output of audio corresponding to the fifth object), wherein the sixth object is the first type of object. In some embodiments, the system user interface does not include a control that, when selected, causes the computer system to output audio corresponding to an object that is the second type of object. In some embodiments, as a part of detecting the request to display the system user interface, the computer system detects a gaze input at a particular location, an air gesture, an air gesture while detecting a gaze input, a voice command, a tap input, a swipe input, and/or a mouse click. Displaying the system user interface in response to detecting the request to display the system user interface provides the user with control over the computer system to display the system user interface, thereby providing additional control options without cluttering the user interface with additional displayed controls.

In some embodiments, detecting the request to display the system user interface includes detecting a fifth gaze input (e.g., 905g) at a fixed location in a viewport of the three-dimensional environment (e.g., as described above in relation to FIG. 9G). In some embodiments, a three-dimensional environment (e.g., VR environment and/or AR environment) is visible in the viewport of the three-dimensional environment (e.g., as described above in relation to FIG. 9G). In some embodiments, the fixed location in the viewport does not change with respect to the viewpoint as the viewpoint is moved around. In some embodiments, the system user interface is a control center user interface. In some embodiments, the control central user interface includes: a third control that, when selected, causes the computer system to adjust output of a first component (e.g., a speaker, the display generation component (e.g., 120), a Bluetooth antenna, a Wi-Fi antenna, and/or an external device) that is in communication with the computer system; and a fourth control that, when selected, causes the computer system to adjust output of a second component (e.g., a speaker, the display generation component (e.g., 120), a Bluetooth antenna, a Wi-Fi antenna, and/or an external device) that is in communication with the computer system. In some embodiments, the first component is a different type of component than the second component. In some embodiments, adjusting output of a component includes managing one or more Wi-Fi connection, Bluetooth connection, flashlights (e.g., turning a light on and/or off), the output of an external device (e.g., a smart light, a smart speaker, a smart lock, and/or a smart plug), brightness of a display and/or display generation component (e.g., 120), and/or volume level of audio and/or output of speakers (e.g., maximum and/or minimum volume level). Displaying the system user interface in response to detecting a fifth gaze input at a fixed location in a viewpoint provides the user with control over the computer system to display the system user interface, thereby providing additional control options without cluttering the user interface with additional displayed controls.

In some embodiments, the computer system detects a request to display a system user interface. In some embodiments, in response to detecting the request to display the system user interface, the computer system displays, via the display generation component (e.g., 120), the system user interface (e.g., 718), including: a first control (e.g., 722a-722c) that, when selected, causes the computer system (e.g., 700 and 990) to adjust output of audio corresponding to the fifth object; and a second control (e.g., 722a-722c) that, when selected, causes the computer system to adjust output of audio corresponding to a sixth object (e.g., without adjusting output of audio corresponding to the fifth object), wherein the sixth object is the first type of object. In some embodiments, the system user interface does not include a control that, when selected, causes the computer system to output audio corresponding to an object that is the second type of object. In some embodiments, as a part of detecting the request to display the system user interface, the computer system detects a gaze input at a particular location, an air gesture, an air gesture while detecting a gaze input, a voice command, a tap input, a swipe input, and/or a mouse click. Displaying the system user interface in response to detecting the request to display the system user interface provides the user with control over the computer system to display the system user interface, thereby providing additional control options without cluttering the user interface with additional displayed controls.

In some embodiments, detecting the request to display the system user interface includes detecting a fifth gaze input at a fixed location in a viewport of the three-dimensional environment. In some embodiments, a three-dimensional environment (e.g., VR environment and/or AR environment) is visible in the viewport of the three-dimensional environment. In some embodiments, the fixed location in the viewport does not change with respect to the viewpoint as the viewpoint is moved around. In some embodiments, the system user interface is a control center user interface, and wherein the control central user interface includes: a third control that, when selected, causes the computer system to adjust output of a first component (e.g., a speaker, the display generation component, a Bluetooth antenna, a Wi-Fi antenna, and/or an external device) that is in communication with the computer system; and a fourth control that, when selected, causes the computer system to adjust output of a second component (e.g., a speaker, the display generation component, a Bluetooth antenna, a Wi-Fi antenna, and/or an external device) that is in communication with the computer system, wherein the first component is a different type of component than the second component. In some embodiments, adjusting output of a component includes managing one or more Wi-Fi connection, Bluetooth connection, flashlights (e.g., turning a light on and/or off), the output of an external device (e.g., a smart light, a smart speaker, a smart lock, and/or a smart plug), brightness of a display and/or display generation component, and/or volume level of audio and/or output of speakers (e.g., maximum and/or minimum volume level). Displaying the system user interface in response to detecting a fifth gaze input at a fixed location in a viewpoint provides the user with control over the computer system to display the system user interface, thereby providing additional control options without cluttering the user interface with additional displayed controls.

In some embodiments, the fifth object is the first type of object (e.g., an object that corresponds to a persistent audio source, an important audio source, an audio that has been designed as persistent, relevant, and/or important). In some embodiments, while outputting audio corresponding to the fifth object, the computer system detects a request to output audio corresponding to an object that is the first type of object different from the fifth object; and in response to detecting the request to output audio corresponding to the object that is the first type of object: outputs audio corresponding to the object that is the first type of object; and ceases outputting audio corresponding to the fifth type of object (e.g., as described above in relation to FIG. 9E-9F). In some embodiments, in response to detecting the request to output audio corresponding to the object that is the second type of object, the computer system continues to output audio corresponding to the fifth object and outputs audio corresponding to the object that is the second type of object. In some embodiments, in response to detecting the request to output audio corresponding to the object that is the second type of object, the computer system reduces the audio prominence of the audio corresponding to the fifth object. In some embodiments, the object that is the second type of object is different from the fifth object. Outputting audio corresponding to the object that is the first type of object and ceasing outputting audio corresponding to the fifth type of object in response to detecting the request to output audio corresponding to the object that is the first type of object allows the computer system to manage audio sources and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls, providing improved feedback, and performing an operation when a set of conditions has been met without requiring further user input.

In some embodiments, in response to detecting the occurrence of the event that includes detecting the attention of the user moving away from being directed to the first object, the computer system outputs, via the one or more audio output devices, audio corresponding to a seventh object (and, In some embodiments, while the seventh object is visible and/or displayed via the display generation component (e.g., 120)) at a fourth prominence of audio output that is higher than a fifth prominence of audio output (e.g., as described above in relation to FIG. 9A-9D), wherein the fifth prominence of audio output is a prominence of audio output at which audio corresponding to the seventh object was output before (and, In some embodiments, immediately before and/or while) detecting the occurrence of the event that includes detecting the attention of the user moving away from being directed to the first object, wherein the seventh object is different from the first object (e.g., as described above in relation to FIG. 9A-9D). Outputting audio corresponding to a seventh object at a fourth prominence of audio output that is higher than a fifth prominence of audio output that was previously output in response to detecting the occurrence of the event that includes detecting the attention of the user moving away from being directed to the first object allows the computer system to increase the prominence of audio output for objects to which the user may be paying attention or for objects that are receiving an increased amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, while outputting audio corresponding to the first object at the first prominence of audio output, the computer system outputs audio corresponding to an eighth object different from the first object at a sixth prominence of audio output that is different from the first prominence of audio output (e.g., as described above in relation to FIG. 9A-9D). In some embodiments, the first prominence of audio output is lower or higher than the sixth prominence of audio output. Outputting audio corresponding to an eighth object different from the first object at a sixth prominence of audio output that is different from the first prominence of audio output while outputting audio corresponding to the first object at the first prominence of audio output allows the computer system to provide audio at different levels of prominence and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing the user with improved feedback.

In some embodiments, the first object (e.g., 714) is an application window (e.g., a window that includes an application and/or an application of the window). Outputting, via the one or more audio output devices, the audio corresponding to an application window at a second prominence of audio output that is lower than the first prominence of audio output in response to detecting the occurrence of the event that includes detecting the attention of the user moving away from being directed to the first application window allows the computer system to reduce the prominence of audio output for application windows to which the user may no longer be paying attention or for application windows that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, the object (e.g., 714) is visible in a three-dimensional environment (a VR, XR, or AR environment). Outputting, via the one or more audio output devices, the audio corresponding to an object visible in the three-dimensional environment at a second prominence of audio output that is lower than the first prominence of audio output in response to detecting the occurrence of the event that includes detecting the attention of the user moving away from being directed to the object visible in the three-dimensional environment allows the computer system to reduce the prominence of audio output for objects visible in the three-dimensional environment to which the user may no longer be paying attention or for objects visible in the three-dimensional environment that are receiving a reduced amount of user attention and automatically changing the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, in accordance with a determination that the first object is associated with (e.g., corresponds to, at, and/or centrally located at) a first location, the audio corresponding to the first object is output such that the audio corresponding to the first object is spatially positioned (e.g., output and/or configured to sound as if output) at the first location (e.g., as described above in relation to FIG. 9A-9G) (e.g., virtually sourced, where a virtual audio source is generated and/or created at the first location, and/or where one or more virtual audio sources are generated such that audio is generated (and/or perceived to be generated) at the first location) (e.g., the position of the sound of the audio is distinct from the positions of the of the actual audio output devices and/or the position of the second of the audio is not a fixed position that is on a surface of the computer system). In some embodiments, in accordance with a determination that the first object is associated with (e.g., corresponds to, at, and/or centrally located at) a second location different from the first location, the audio corresponding to the first object is output such that the audio corresponding to the first object is spatially positioned at the second location (e.g., as described above in relation to FIG. 9A-9G) (and, In some embodiments, without being virtually sourced from the first location) (e.g., virtually sourced, where a virtual audio source is generated and/or created at the second location, and/or where one or more virtual audio sources are generated such that audio is generated (and/or perceived to be generated) at the first location). In some embodiments, spatialized audio experiences are produced by manipulating sounds in an audio output device's two audio channels (e.g., left and right) so that they resemble directional sounds arriving in the car-canal. For example, headphones can reproduce a spatial audio signal that simulates a soundscape around the listener (also referred to as the user). An effective spatial sound reproduction can render sounds such that the listener perceives the sound as coming from a location within the soundscape external to the listener's head, just as the listener would experience the sound if encountered in the real world. In some embodiments, spatialized audio is audio that has been filtered such that a listener of the audio perceives the audio as coming from one or more directions and/or locations in a three-dimensional space (e.g., from above, below, and/or in front of the listener). An example of such a filter is a Head-Related Transfer Function (HRTF) filter. Outputting, via the one or more audio output devices, audio corresponding to the first object that is virtually sourced from a location allows the computer system to provide audio that appears to be coming from a certain location in an environment and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user.

Note that details of the processes described above with respect to method 1000 (e.g., FIG. 10) are also applicable in an analogous manner to the methods described herein. For example, one or more steps of method 1000 for changing prominence of audio can be used after changing virtual sound sources using one or more steps of 1200. For brevity, these details are not repeated below.

FIGS. 11A-11F illustrate exemplary user interfaces for managing audio output based on distance in accordance with some examples. The user interfaces in these figures are used to illustrate the processes described below, including the processes in FIG. 12.

FIGS. 11A-11F illustrate a top portion including a user and a device near a conceptualized illustration of a soundstage (e.g., 1102), which is a visualization of a sound system from which computer system 700 outputs audio that appears to come from different spatial locations and with different characteristics based on various factors, which will be discussed below. The soundstages in this example are for exemplary purposes only and are not necessarily accurate and applicable to every example. In some embodiments, altering the audio property (e.g., altering volume and/or reverberation) of soundstages includes adding and/or removing the virtual sources within the soundstage that represent a sound system arrangement. In some embodiments, altering the audio property of sound stages includes moving one or more virtual sources and/or speakers closer to and/or away from each other. In this example, FIGS. 11A-11F illustrate altering the audio property of soundstages by retaining the same amount of virtual sources and/or speaker representations across different sizes of soundstages but changing their positions, which alters the positions of the audio sources. The soundstages range presented in FIGS. 11A-11F range in size from large, medium, and small. In some embodiments, the size of the soundstage in each figure is based on the distance from the user to the area that encompasses the soundstage, movements of the user (e.g., air inputs and/or gaze inputs), the environment of the user and the soundstage, and/or the state of the application to which the sound stage corresponds. The environment illustrated in FIGS. 11A-11F is a virtual environment, but In some embodiments it is an augmented reality environment. While the examples are described with respect to computer system 700 performing one or more operations and/or providing audio output, computer system 990 is optionally used to perform one or more operations. At FIG. 11A, computer system 700 is a tablet while computer system 990 is an HMD device. In some embodiments, one or more other types of computer systems, can be used to perform the one or more operations discussed below.

The top portion of FIG. 11A illustrates user 924 holding computer system 700 in a virtual environment as well as, optionally, wearing computer system 990, which is located around the head of user 924. Also illustrated in FIG. 11A is large soundstage 1102, which includes representations of a sound system arrangement, represented in this example as speakers. Although large soundstage 1102 in this example is illustrated as being two-dimensional, large soundstage 1102 is a sound system that surrounds user 924 in their environment. The bottom portion of FIG. 11A illustrates computer system 700, which is the device that user 924 is holding in the environment. Computer system 700 includes viewpoint 902, which is a representation of what user 924 sees in their environment, which is video application 1184. Computer system 700 illustrates video application 1184 as a movie application interface of a movie currently playing. Included on the interface of video application 1184 is screen size control 1186, which allows a user to reduce or increase the size of the interface. At FIG. 11A, computer system 700 detects input 1105a on screen size control 1186.

As illustrated in FIG. 11B, in response to detecting input 1105a, computer system 700 reduces the size of video application 1184 to a minimized version of video application 1184 illustrated in FIG. 11A. At FIG. 11B, in response to detecting input 1105a, computer system 700 alters large soundstage 1102 of FIG. 11A to medium soundstage 1104 of FIG. 11B, where medium soundstage 1104 is illustrated as being smaller than large soundstage 1102. Here, at 11B, medium soundstage 1104 has the same amount (but different locations) of speaker representations as large sound stage 1102. In some embodiments, medium soundstage 1104 less (or more) of speaker representations as large sound stage 1102. It should be understood that the location of speaker representations in a virtual sound stage indicates a spatial arrangement of virtual audio sources in space, where sound is provided via spatialized audio. In some embodiments, spatialized audio experiences are produced by manipulating sounds in an audio output device's two audio channels (e.g., left and right) so that they resemble directional sounds arriving in the car-canal. In some embodiments, an HMD device or headphones can reproduce a spatial audio signal that simulates a soundscape around the listener (also referred to as the user). In some embodiments, an effective spatial sound reproduction can render sounds such that the listener perceives the sound as coming from a location within the soundscape external to the listener's head, just as the listener would experience the sound if encountered in the real world. In some embodiments, spatialized audio is audio that has been filtered such that a listener of the audio perceives the audio as coming from one or more directions and/or locations in a three-dimensional space (e.g., from above, below, and/or in front of the listener).

At FIG. 11B, computer system 700 transitions from large soundstage 1102 to medium soundstage 1104 to alter the audio property of video application 1184. In some embodiments, the audio property is changed to mimic the change in size of the application. In some embodiments, changing the audio property includes changing a volume, reverberation, and/or the size of the spatial area from which computer system 700 sources the audio. In some embodiments, computer system 700 changes the sound at FIG. 11B, such that the sound produced by computer system 700 is more concentrated and less of a surround sound effect as the sound produced by computer system 700 at 11A. At FIG. 11B, computer system 700 detects swipe input 1105b on video application 1184.

As illustrated in the bottom portion of FIG. 11C, in response to detecting input 1105b, computer system 700 dynamically resizes (e.g., reduces the size of) video application 1184 from the minimized version (e.g., video application 1184 of FIG. 11B) to the size of an icon. As illustrated in the top portion of FIG. 11C, in response to detecting input 1105b, computer system 700 alters medium soundstage 1104 into small soundstage 1106. In some embodiments, computer system 700 changes the audio property of video application 1184 relative to the viewpoint of user 924. Note that, similar to the change illustrated in FIG. 11B, small soundstage 1106 contains the same amount of speaker representations as medium soundstage 1104 but computer system 700 displays them as being in a different arrangement. Computer system 700 displays the speaker representations of small soundstage 1106 as being closer together, which is reflective of computer system 700 sourcing the sound system from a focal point (e.g., in front of user 924) of audio output as opposed to the audio surrounding user 924 as illustrated with respect to large soundstage 1102 in FIG. 11A. In some embodiments, computer system 700 maintains the volume of audio output at the same level from one soundstage size to another and does not increase or decrease it. In some embodiments, in response to detecting input 1105b, computer system 700 changes medium soundstage 1104 to small soundstage 1106, though computer system 700 maintains the size of video application 1184 as illustrated in FIG. 11B. At FIG. 11C, computer system 700 continues to detect swipe input 1105b on video application 1184, which computer system 700 displays as being sized as an icon.

As illustrated in FIG. 11D, in response to detecting swipe input 1105b at FIG. 11C, computer system 700 moves the icon of video application 1184 in the direction of the swipe (e.g., to the right on viewpoint 902). Note that, as computer system 700 has not changed the size of video application 1184 from the size it was illustrated as in FIG. 11C, neither has the size of small soundstage 1106 been changed. At FIG. 11D, computer system 700 detects that user 924 releases swipe input 1105b. Note that the changes illustrated and described above with respect to alterations in the sizes of the soundstages and video application 1184 can occur based on the physical movement of computer system 700 (e.g., left to right) rather than an input (e.g., swipe input) on viewpoint 902 of computer system 700. In some embodiments, computer system 700 can alter the size of a conceptual sound stage and/or characteristics of a sound system based on a user holding computer system 700 and turning their body to face various directions, as illustrated and described above with respect to FIGS. 8A-8H, rather than in response to detecting an input, as illustrated in FIGS. 11A-11B.

As illustrated in the bottom portion of FIG. 11E, in response to detecting the end of input 1105b, computer system 700 returns video application 1184 to its size as illustrated in FIG. 11B (in between the sizes of full screen and icon). As illustrated in the top portion of FIG. 11E, in response to detecting the end of swipe input 1105b, computer system 700 returns small soundstage 1106 to medium soundstage 1104. In some embodiments, in response to detecting the end of swipe input 1105b, computer system 700 maintains the sound stage (e.g., small sound stage 1106). In some embodiments, in response to detecting an air gesture (e.g., an air swipe, an air flick gesture, and/or an air gestures that is detected based on a body part moving from one position in an environment to another position in the environment) made by hand 701 at FIGS. 7A-7D, computer system 700 performs the one or more operations described above in relation detecting input 1105b, such as adjusting the virtual sounds stages. At FIG. 11E, computer system 700 detects that user 924 moves closer in proximity to medium soundstage 1104.

As illustrated in the top portion of FIG. 11F, in response to user 924 moving closer to medium soundstage 1104, computer system 700 changes medium soundstage 1104 into large soundstage 1102. As illustrated in the bottom portion of FIG. 11F, in response to detecting user 924 moving closer to medium soundstage 1104, computer system 700 returns video application 1184 to full screen mode as first illustrated in FIG. 11A in accordance with large soundstage 1102. In some embodiments, computer system 700 displays an immersive environment (e.g., an environment that surrounds the head of the user) when the user is wearing computer system 990 of FIG. 11A.

The change that occurs from FIG. 11E to FIG. 11F includes a request to alter the appearance (e.g., size, location, and/or position) of video application 1184 on viewpoint 902 in accordance with the physical position of user 924 holding computer system 700 relative to the soundstage. In some embodiments, computer system 700 moving closer to medium soundstage 1104 changes the audio property of video application 1184. In some embodiments, the changes in audio property in a virtual environment illustrated in the above figures are not to the same degree of change that happens in a physical three-dimensional environment. In some embodiments, the audio property changes caused by movement of computer system 700 in relation to the soundstage in this example can be more or less drastic than the movement of a user relative to an audio source in a physical environment. In some embodiments, changes in the sizes of the soundstages occur based on the user's attention moving away from an object. For example, computer system 700 detects that a user's attention has moved from being directed to video application 1184 to not being directed to video application 1184, computer system 700 alters medium soundstage 1104 into small soundstage 1106 or a large soundstage into a medium sound stage. In some embodiments, computer system 700 switches between sound stages for different reasons. In some embodiments, computer system 700 switches between sounds stages in response to a request to transition between modes (e.g., to a full screen mode, immersive mode, and/or a non-immersive mode). In some embodiments, computer system 700 switches between sounds stages in response to detecting a request to hide an object in the environment, such that the object is not visible in the viewpoint of the user. In some embodiments, in response to the request to hide the object, computer system 700 transitions to a smaller soundstage. It should be understood that, in some embodiments, computer system 700 can alter a sound stage and/or transition between sound stages while maintaining the size of the application. In some embodiments, a developer of an application can configured the application to have a particular sound stage while the application is displayed at a particular, at a particular time, and/or at a particular location in the environment.

FIG. 12 is a flow diagram illustrating a method (e.g., method 1200) for managing for managing virtual sounds in accordance with some examples. Some operations in method 1200 are, optionally, combined, the orders of some operations are, optionally, changed, and some operations are, optionally, omitted.

As described below, method 1200 provides an intuitive way for managing for managing virtual sounds. Method 1200 reduces the cognitive burden on a user for managing for managing virtual sounds, thereby creating a more efficient human-machine interface. For battery-operated computing devices, enabling a user to manage sounds faster and more efficiently conserves power and increases the time between battery charges. In some embodiments, method 1200 is performed at a computer system (e.g., 700 and 990) (e.g., as described above in relation to method 800) that is in communication with one or more audio output devices (e.g., as described above in relation to method 800) and a display generation component (e.g., 120) (e.g., as described above in relation to method 800).

At 1202, while a user interface object (e.g., 1184) corresponding to an application (e.g., a user interface, a virtual object and/or a physical object (e.g., corresponding to an application, a window, a user interface, and/or a user account)) is visible (e.g., a virtual object that is displayed using, and/or a physical object that can be seen through (e.g., via a transparent display and/or via a display where the opacity of the display is adjustable)) at a first location in a three-dimensional environment (e.g., corresponding to a location in physical and/or virtual environment), the computer system outputs, via the one or more audio output devices, audio corresponding to the user interface with a first value for a respective audio property (e.g., amount of sound, amount of high frequency sounds, amount of medium frequency sounds, amount of low frequency sounds, amount of base, amount of fidelity, amount of pitch, speed of audio playback, and/or amount of tone) (e.g., location that the audio is originating from in space, location that the audio is being generated from in space).

At 1204, while outputting audio corresponding to the user interface with the first value for the respective audio property, the computer system detects a request (e.g., 1105b) to move the user interface relative to a viewpoint of a user.

At 1206, in response to detecting the request (e.g., 1105b) to move the user interface object (e.g., 1184) corresponding to the application relative to the viewpoint of the user in the three-dimensional environment, the computer system moves (at 1208) the user interface object (e.g., 1184) corresponding to the application relative to the viewpoint of the user in the three-dimensional environment (e.g., from the first location to a second location that is different from the first location).

At 1208, in response to detecting the request (e.g., 1105b) to move the user interface object (e.g., 1184) corresponding to the application relative to the viewpoint of the user in the three-dimensional environment, the computer system outputs (1210), via the one or more audio output devices, the audio corresponding to the user interface object (e.g., 1184) with a second value for the respective audio property different from the first value for the respective audio property (e.g., changing he first value for the respective audio property to the second value for the respective audio property and/or replacing the first value for the respective audio property with the second value for the respective audio property). Outputting, via the one or more audio output devices, the audio corresponding to the user interface object with a second value for the respective audio property different from the first value for the respective audio property in response to detecting the request to move the user interface object corresponding to the application relative to the viewpoint of the user in the three-dimensional environment allows the computer system to change how audio is output when object is moved in the three-dimensional environment, provides the user with an indication that the object is being moved and/or has changed states, and automatically changes the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, detecting the request (e.g., 1105b) to move the user interface object (e.g., 1184) corresponding to the application relative to the viewpoint of the user in the three-dimensional environment includes detecting an input (e.g., 1105b and/or as discussed above in relation to 701) (e.g., an air gesture (e.g., an air swipe gesture and/or an air flick gesture), a swipe gesture, a moving gaze input, a mouse click and drag input, and/or a voice command) corresponding to a request (e.g., 1105b) to move the user interface object (e.g., 1184) (and, In some embodiments, without moving the viewpoint of the user in the three-dimensional environment) from a first location in the three-dimensional environment to a second location in the three-dimensional environment. In some embodiments, the first location is different from the second location. Outputting, via the one or more audio output devices, the audio corresponding to the user interface object with a second value for the respective audio property different from the first value for the respective audio property in response to detecting an input (e.g., 1105b and/or as discussed above in relation to 701) corresponding to a request to move the user interface object from a first location in the three-dimensional environment to a second location in the three-dimensional environment allows the computer system to provide the user with a control option to manage the movement of the user interface object as well as output of audio corresponding to the user interface object and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, in accordance with a determination that the first object is associated with (e.g., corresponds to, at, and/or centrally located at) a first location, the audio corresponding to the first object is output such that the audio corresponding to the first object is spatially positioned (e.g., output and/or configured to sound as if output) at the first location (e.g., as described above in relation to FIG. 9A-9G) (e.g., virtually sourced, where a virtual audio source is generated and/or created at the first location, and/or where one or more virtual audio sources are generated such that audio is generated (and/or perceived to be generated) at the first location) (e.g., the position of the sound of the audio is distinct from the positions of the of the actual audio output devices and/or the position of the second of the audio is not a fixed position that is on a surface of the computer system). In some embodiments, in accordance with a determination that the first object is associated with (e.g., corresponds to, at, and/or centrally located at) a second location different from the first location, the audio corresponding to the first object is output such that the audio corresponding to the first object is spatially positioned at the second location (e.g., as described above in relation to FIG. 9A-9G) (and, in some embodiments, without being virtually sourced from the first location) (e.g., virtually sourced, where a virtual audio source is generated and/or created at the second location, and/or where one or more virtual audio sources are generated such that audio is generated (and/or perceived to be generated) at the first location). Outputting, via the one or more audio output devices, audio corresponding to the first object that is virtually sourced from a location allows the computer system to provide audio that appears to be coming from a certain location in an environment and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user.

In some embodiments, moving the user interface object (e.g., 1184) corresponding to the application relative to the viewpoint of the user in the three-dimensional environment includes: ceasing displaying the user interface object (e.g., 1184) at the first location in the three-dimensional environment; and displaying the user interface object at the second location in the three-dimensional environment. In some embodiments, moving the user interface object corresponding to the application relative to the viewpoint of the user in the three-dimensional environment includes moving display to the user interface object and/or moving the user interface object from the first location in the three-dimensional environment to the second location in the three-dimensional environment. Moving the user interface object corresponding to the application relative to the viewpoint of the user in the three-dimensional environment in response to detecting the request to move the user interface object corresponding to the application relative to the viewpoint of the user in the three-dimensional environment allows the computer system to provide the user with a control option to manage the movement of the user interface object as well as output of audio corresponding to the user interface object and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, the input (e.g., 1105b and/or as discussed above in relation to 701) corresponding to the request (e.g., 1105b) to move the user interface object (e.g., 1184) from the first location in the three-dimensional environment includes one or more air gestures (e.g., an air swipe gesture, an air pinch and move gesture, one or more air pinches with a gaze input that moves, and/or an air flick gesture). Outputting, via the one or more audio output devices, the audio corresponding to the user interface object with a second value for the respective audio property different from the first value for the respective audio property in response to detecting one or more air gestures allows the computer system to provide the user with a control option to manage the movement of the user interface object as well as output of audio corresponding to the user interface object and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, outputting the audio corresponding to the user interface with the second value for the respective audio property includes changing the respective audio property from the first value to the second value while moving the user interface object corresponding to the application relative to the viewpoint of the user in the three-dimensional environment (and/or, In some embodiments, while moving the user interface corresponding to the application from one location in the three-dimensional environment to another location in the three-dimensional environment; In some embodiments, while not moving the user interface corresponding to the application from one location in the three-dimensional environment to another location in the three-dimensional environment; and/or, In some embodiments, while moving the viewpoint of the user without moving the user interface object (e.g., 1184)) (e.g., before stopping movement of and/or ceasing to move the user interface object). Changing the respective audio property from the first value to the second value while moving the user interface object corresponding to the application relative to the viewpoint of the user in the three-dimensional environment allows the computer system to change how audio is output when the object is moved in the three-dimensional environment and provides the user with an indication that the object is being moved and/or has changed states and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, outputting the audio corresponding to the user interface with the second value for the respective audio property includes changing the respective audio property from the first value to the second value after ceasing to move the user interface object corresponding to the application relative to the viewpoint of the user in the three-dimensional environment (and/or once moving the user interface corresponding to the application relative to the viewpoint of the user in the three-dimensional environment is complete and/or has ended) (and/or, In some embodiments, after ceasing to move the user interface corresponding to the application from one location in the three-dimensional environment to another location in the three-dimensional environment; In some embodiments, after not moving the user interface corresponding to the application from one location in the three-dimensional environment to another location in the three-dimensional environment; and/or, In some embodiments, after moving the viewpoint of the user and without moving the user interface object (e.g., 1184)) in response to detecting the request (e.g., 1105b) to move the user interface object (e.g., 1184) corresponding to the application relative to the viewpoint of the user in the three-dimensional environment. Changing the respective audio property from the first value to the second value after ceasing to move the user interface object corresponding to the application relative to the viewpoint of the user in the three-dimensional environment in response to detecting the request to move the user interface object corresponding to the application relative to the viewpoint of the user in the three-dimensional environment allows the computer system to change how audio is output after the object is moved in the three-dimensional environment and provides the user with an indication that the audio has been moved and/or has changed states and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, in response to detecting the request (e.g., 1105b) to move the user interface object (e.g., 1184) corresponding to the application relative to the viewpoint of the user in the three-dimensional environment (and/or, In some embodiments, while moving the user interface corresponding to the application from one location in the three-dimensional environment to another location in the three-dimensional environment; In some embodiments, while not moving the user interface corresponding to the application from one location in the three-dimensional environment to another location in the three-dimensional environment; and/or, In some embodiments, while moving the viewpoint of the user without moving the user interface object), the computer system resizes the user interface object (e.g., changing a size of the user interface object from a first size to a second size different from the first size) (continuously resizing, resizing at least once, and/or non-continuously resizing) while the user interface object is being moved. Resizing the user interface object while the user interface object is being moved in response to detecting the request to move the user interface object corresponding to the application relative to the viewpoint of the user in the three-dimensional environment in response to detecting the request to move the user interface object corresponding to the application relative to the viewpoint of the user in the three-dimensional environment provides the user with a control options to resize the user interface and allows the computer system to reduce visual distraction to the user while the user interface object is being moved, thereby providing additional control options without cluttering the user interface with additional displayed controls, and performing an operation when a set of conditions has been met without requiring further user input.

In some embodiments, detecting the request (e.g., 1105b) to move the user interface object (e.g., 1184) corresponding to the application relative to the viewpoint of the user in the three-dimensional environment includes detecting movement of (e.g., a change to and/or displacement of) the viewpoint (and/or the computer system, the display generation component (e.g., 120), and/or an input device (e.g., a camera and/or a sensor) in communication with the computer system) (e.g., from a third location in the three-dimensional environment to a fourth location in the three-dimensional environment, where ethe third location is different from the fourth location). Outputting, via the one or more audio output devices, the audio corresponding to the user interface object with a second value for the respective audio property different from the first value for the respective audio property in response to detecting movement of the viewpoint allows the computer system to change how audio is output when object is moved in the three-dimensional environment and provides the user with an indication that the object is being moved and/or has changed states and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, detecting movement of the viewpoint includes detecting movement of a device (e.g., 700 and/or 990) (e.g., the computer system, an HMD device, a battery pack, and/or a fitness tracking device). In some embodiments, the device is attached to the body of the user, such as an HMD device and/or a fitness tracking device. Outputting, via the one or more audio output devices, the audio corresponding to the user interface object with a second value for the respective audio property different from the first value for the respective audio property in response to detecting movement of the device allows the computer system to change how audio is output when object is moved in the three-dimensional environment and provides the user with an indication that the object is being moved and/or has changed states and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, the respective audio property includes (and/or is) a volume of the audio corresponding to the user interface (e.g., as described above in relation to FIG. 11A-11F). Outputting, via the one or more audio output devices, the audio corresponding to the user interface object with a second value for a volume different from the first value for the volume in response to detecting the request to move the user interface object corresponding to the application relative to the viewpoint of the user in the three-dimensional environment allows the computer system to change how the volume of audio is output when object is moved in the three-dimensional environment and provides the user with an indication that the object is being moved and/or has changed states and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, the respective audio property includes (and/or is) a direct-to-reverberant ratio of the audio corresponding to the user interface (and/or a direct to reverberant energy ratio). Outputting, via the one or more audio output devices, the audio corresponding to the user interface object with a second value for a direct-to-reverberant ratio different from the first value for the direct-to-reverberant ratio in response to detecting the request to move the user interface object corresponding to the application relative to the viewpoint of the user in the three-dimensional environment allows the computer system to change how the direct-to-reverberant ratio of audio is output when object is moved in the three-dimensional environment, provides the user with an indication that the object is being moved and/or has changed states, and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, providing additional control options without cluttering the user interface with additional displayed controls, and performing an operation when a set of conditions has been met without requiring further user input.

In some embodiments, an amount of difference between the first value of the respective audio property and the second value for the respective audio property does not correspond to (e.g., and/or is different from (e.g., less than or more than)) a difference in audio of a physical sound source (e.g., a physical speaker and/or another physical audio output device) that would occur in a physical environment in conjunction with moving the user interface object corresponding to the application relative to the viewpoint of the user in the three-dimensional environment. In some embodiments, the amount of difference between the first value of the respective audio property and the second value for the respective audio property is different from an amount of attenuation (sound and/or acoustic attenuation) corresponding to a distance that the user interface object moved in the three-dimensional environment (e.g., sound in a physical environment reduces its volume and/or intensity as it travels in the physical environment, such reduction is bound by physical laws of nature (e.g., the Doppler Effect) and reduces based on a defined amount (e.g., the amount of attenuation corresponding to the distance that the user interface object moved in the three-dimensional environment)). In some embodiments, the physical laws of nature cause an object moving from a first distance away to a second distance away (e.g., different from the first distance away) to be reduced by a particular amount. In some embodiments, the amount of difference between the first value of the respective audio property and the second value for the respective audio property is different from the particular amount.

In some embodiments, while outputting, via the one or more audio output devices, audio corresponding to the user interface with the second value for the respective audio property, detecting an occurrence of an event that includes detecting attention of a user moving away from being directed to the first user interface object (e.g., as described above in relation to method 1000). In some embodiments, in response to detecting the occurrence of the event that includes detecting the attention of the user moving away from being directed to the first user interface object (e.g., 1184), the computer system outputs, via the one or more audio output devices, the audio corresponding to the user interface with a third value for the respective audio property different from the second value for the respective audio property (and, In some embodiments, without moving the user interface object corresponding to the application relative to the viewpoint of the user in the three-dimensional environment). In some embodiments, the third value is different from the first value. Outputting, via the one or more audio output devices, the audio corresponding to the user interface with a third value for the respective audio property different from the second value for the respective audio property in response to detecting the occurrence of the event that includes detecting the attention of the user moving away from being directed to the first user interface object allows the computer system to change the prominence of audio output for objects to which the user may no longer be paying attention or for objects that are receiving a reduced amount of user attention and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, before detecting the request (e.g., 1105b) to move the user interface object (e.g., 1184) corresponding to the application relative to the viewpoint of the user in the three-dimensional environment, the audio corresponding to the user interface is output according to a first virtual sound stage. In some embodiments, in response to detecting the request to move the user interface object corresponding to the application relative to the viewpoint of the user in the three-dimensional environment, the computer system outputs the audio corresponding to the user interface object according to a second virtual sound stage different from the first virtual sound stage. In some embodiments, the first virtual sound stage includes the first set of one or more virtual sources in the first spatial arrangement. In some embodiments, the second virtual sound stage includes a second set of one or more virtual sources in a second spatial arrangement different from the first spatial arrangement (e.g., as described above in relation to CS4). Outputting the audio corresponding to the user interface object according to a second virtual sound stage different from the first virtual sound stage in response to detecting the request to move the user interface object corresponding to the application relative to the viewpoint of the user in the three-dimensional environment allows the computer system to change the virtual sound stage of the audio, change the spatial manner at which the volume is output, and automatically change the audio properties of objects to avoid the user from having to manually change the audio properties of objects and/or to manually close individual windows or user interface objects thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

Note that details of the processes described above with respect to method 1200 (e.g., FIG. 12) are also applicable in an analogous manner to the methods described herein. For example, one or more steps of method 800 of lowering the audio output can be used after changing a viewpoint of user in virtual environment using one or more steps of 1200. For brevity, these details are not repeated below.

FIG. 13 is a flow diagram illustrating a method (e.g., method 1300) for managing for managing virtual sounds in accordance with some examples. Some operations in method 1300 are, optionally, combined, the orders of some operations are, optionally, changed, and some operations are, optionally, omitted.

As described below, method 1300 provides an intuitive way for managing for managing virtual sounds. Method 1300 reduces the cognitive burden on a user for managing for managing virtual sounds, thereby creating a more efficient human-machine interface. For battery-operated computing devices, enabling a user to manage sounds faster and more efficiently conserves power and increases the time between battery charges. In some embodiments, method 1300 is performed at a computer system (e.g., 700 and 990) (e.g., as described above in relation to method 800) that is in communication with one or more input device and one or more audio output devices (e.g., as described above in relation to method 800).

At 1302, while outputting, via the one or more input devices, audio corresponding to an object (e.g., 1184) (e.g., an object in a three-dimensional environment such as a physical object in a physical environment or a virtual object in a virtual reality, extended reality, or mixed reality environment) according to a first virtual sound stage (e.g., 1102-1106) (e.g., 1102-1106) for the object (e.g., a geometrical positioning of virtual sources relative to an object (e.g., virtual sources being arranged in triangle, circle, square, and/or another shape, virtual sources being close and/or further away from each other, and/or virtual sources being displayed at the same position and/or different position) (e.g., virtual audio sources such as virtual speakers (e.g., a left and right speaker, or a more complicated arrangement of speakers such as front right, front left, rear right, rear left, and a subwoofer) and/or virtual point sources of audio (e.g., a bird chirping, a dog barking, wind blowing through the leaves of a tree or waves lapping on the shore))), detecting, via the one or more input devices, an input directed to the object (e.g., 1184) that corresponds to a request to change a spatial property (e.g., change in position, change in size, change in width, change in length, and/or change in amount of zoom) of the object

At 1304, in response to detecting the input directed to the object that corresponds to the request to change the spatial property of the object (e.g., 1184), the computer system changes (at 1306) the spatial property of the object from having a first value for a respective spatial property (e.g., size, position, length, width, height, and/or amount of zoom) to having a second value for the respective spatial property.

At 1304, in response to detecting the input directed to the object that corresponds to the request to change the spatial property of the object (e.g., 1184), the computer system outputs (1306), via the one or more input devices, audio corresponding to the object according to a second virtual sound stage (e.g., 1102-1106) different from the first virtual sound stage (e.g., 1102-1106). In some embodiments, in response to detecting the input directed to the object that corresponds to a request to change the spatial property of the object, the computer system changes the first virtual sound stage (e.g., 1102-1106) to the second virtual sound stage (e.g., 1102-1106). Changing the spatial property of the object from having a first value for a respective spatial property to having a second value for the respective spatial property in response to detecting the input directed to the object that corresponds to the request to change the spatial property of the object provides the user with a control option to cause the computer system to change the spatial property of an audio source and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties and providing additional control options without cluttering the user interface with additional displayed controls.

In some embodiments, while outputting audio corresponding to the object according to the first virtual sound stage (e.g., 1102-1106) for the object (e.g., 1184), the object is visible and is a first size. In some embodiments, in response to detecting the input directed to the object that corresponds to the request to change the spatial property of the object (e.g., 1184), the computer system resizes the object from the first size to a second size different from the first size. In some embodiments, the input directed to the object that corresponds to the request to change the spatial property of the object is a resizing input (e.g., an air gesture, a gaze input, an air de-pinch and/or pinch gesture, a pinch gesture on a surface, a de-pinch gesture on a surface, scrolling a mouse wheel, a voice command). Resizing the object from the first size to a second size in response to detecting the input directed to the object that corresponds to the request to change the spatial property of the object provides the user with a control option to cause the computer system to change the spatial property of audio source and resize the object and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, while outputting audio corresponding to the object according to the first virtual sound stage (e.g., 1102-1106) for the object (e.g., 1184), the computer system (e.g., 700 and 990) is operating in a first mode. In some embodiments, in response to detecting the input directed to the object (e.g., 1184) that corresponds to the request to change the spatial property of the object, the computer system transitions the computer system (e.g., 700 and 990) from being configured to operate in the first mode (e.g., a full screen mode, a non-full screen mode, an immersive mode, a partially immersive mode, and/or a window mode) to being configured to operate in a second mode (e.g., a full screen mode, a non-full screen mode, an immersive mode, a partially immersive mode, and/or a window mode) different from the first mode. In some embodiments, the input directed to the object that corresponds to the request to change the spatial property of the object is a mode change input (e.g., an air gesture, a voice command, an input directed to one or more user interface objects that, when selected, cause the computer system to transition from the first mode to the second mode and/or from the second mode to the first mode and/or from first mode or second mode to another mode). Transitioning the computer system from being configured to operate in the first mode to being configured to operate in a second mode in response to detecting the input directed to the object that corresponds to the request to change the mode in which the computer system is operating provides the user with a control option to cause the computer system to change the spatial property of audio source, change the mode in which the computer system is operating and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, while outputting audio corresponding to the object (e.g., 1184) according to the first virtual sound stage (e.g., 1102-1106) for the object (e.g., 1184), the object is visible and is at a first location in the three-dimensional environment. In some embodiments, in response to detecting the input directed to the object that corresponds to the request to change the spatial property of the object, the computer system moves the object from the first location in the three-dimensional environment to a second location in the three-dimensional environment. In some embodiments, the input directed to the object that corresponds to the request to change the spatial property of the object is a movement input (e.g., an air pinch and move gesture, a point and move gesture, a mouse click and drag input, and/or a voice command input). In some embodiments, the object is visible at the second location. In some embodiments, the object is at least partially not visible at the second location. Moving the object from the first location in the three-dimensional environment to a second location in the three-dimensional environment in response to detecting the input directed to the object that corresponds to the request to change the spatial property of the object provides the user with a control option to cause the computer system to change the spatial property of audio source and move the object and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, while outputting audio corresponding to the object according to the first virtual sound stage (e.g., 1102-1106) for the object (e.g., 1184), the object (e.g., 1184) is visible. In some embodiments, in response to detecting the input directed to the object that corresponds to the request to change the spatial property of the object (e.g., moving an audio session to an ambient “now playing” mode in which the audio can be controlled in a system now playing user interface (e.g., as described above in relation to CS5)), the computer system ceases to display the object. Ceasing to display the object in response to detecting the input directed to the object that corresponds to the request to change the spatial property of the object provides the user with a control option to cause the computer system to change the spatial property of audio source and cease displaying the object and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, while outputting audio corresponding to the object (e.g., 1184) according to the second virtual sound stage (e.g., 1102-1106), the computer system detects an end of the input directed to the object that corresponds to the request to change the spatial property of the object. In some embodiments, in response to detecting the end of the input directed to the object that corresponds to the request to change the spatial property of the object (e.g., while moving of the object and/or adjusting the position of the object), the computer system outputs, via the one or more input devices, audio corresponding to the object according to the first virtual sound stage (e.g., 1102-1106) (e.g., without outputting audio corresponding to the object according to the second the first virtual sound stage (e.g., 1102-1106)). In some embodiments, in response to detecting the end of the input directed to the object that corresponds to the request to change the spatial property of the object, the computer system reverts output of the audio corresponding to the object to a previous sound stage (e.g., 1102-1106) in response to detecting the end of the input directed to the object that corresponds to the request to change the spatial property of the object. In some embodiments, the computer system collapses one or more virtual sources while moving and expands the one or more virtual sources when movement input ends. Outputting, via the one or more input devices, audio corresponding to the object according to the first virtual sound stage in response to detecting the end of the input directed to the object that corresponds to the request to change the spatial property of the object allows the computer system to revert outputting audio back to the virtual sound stage that was being used before the input was detected and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, while outputting audio corresponding to the object according to the second virtual sound stage, the computer system detects an end of the input directed to the object (e.g., 1184) that corresponds to the request to change the spatial property of the object. In some embodiments, in response to detecting the end of the input directed to the object that corresponds to the request to change the spatial property of the object (e.g., after and/or while resizing and/or changing a mode corresponding to the object), the computer system continues outputting, via the one or more input devices, audio corresponding to the object according to the second virtual sound stage (e.g., 1102-1106) (e.g., without outputting audio corresponding to the object according to the second the first virtual sound stage). Continuing outputting, via the one or more input devices, audio corresponding to the object according to the second virtual sound stage in response to detecting the end of the input directed to the object that corresponds to the request to change the spatial property of the object allows the computer system to continue outputting audio with a virtual sound stage changed in response to the detecting the input and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing improved feedback to the user, reducing the number of inputs needed to perform an operation, providing additional control options without cluttering the user interface with additional displayed controls, and performing an operation when a set of conditions has been met without requiring further user input.

In some embodiments, outputting, via the one or more input devices, audio corresponding to the object according to the second virtual sound stage (e.g., 1102-1106) in response to detecting the input directed to the object (e.g., 1184) that corresponds to the request to change the spatial property of the object includes moving one or more virtual sources (e.g., moving locations for which sources of audio are located and/or positioned) corresponding to the first virtual sound stage (e.g., 1102-1106) relative to each other. Moving one or more virtual sources corresponding to the first virtual sound stage relative to each other in response to detecting the input directed to the object that corresponds to the request to change the spatial property of the object provides the user with a control option to cause the computer system to change the spatial property of audio source and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, in accordance with a determination that a difference between the second value for the respective spatial value and the first value for the respective spatial value is a first amount, the one or more virtual sources corresponding to the first virtual sound stage are moved a second amount relative to each other. In some embodiments, in accordance with a determination that a difference between the second value for the respective spatial value and the first value for the respective spatial value is a third amount different from the first amount, the one or more virtual sources corresponding to the first virtual sound stage are moved a fourth amount relative to each other different from the second amount.

In some embodiments, in accordance with a determination that changing the spatial property of the object from having the first value for the respective spatial property to having the second value for the respective spatial property includes changing the spatial property in a first direction, the one or more virtual sources corresponding to the first virtual sound stage (e.g., 1102-1106) are moved in a second direction. In some embodiments, in accordance with a determination that changing the spatial property of the object (e.g., 1184) from having the first value for the respective spatial property to having the second value for the respective spatial property includes changing the spatial property in a third direction different from the first direction, the one or more virtual sources corresponding to the first virtual sound stage are moved in a fourth direction different from the second direction.

In some embodiments, the one or more virtual sources corresponding to the first virtual sound stage (e.g., 1102-1106) includes a first virtual source and a second virtual source. In some embodiments, moving the one or more virtual sources corresponding to the first virtual sound stage relative to each other includes increasing a distance between the first virtual source and the second virtual source (e.g., moving the first virtual source and the second virtual away from each other). Increasing a distance between the first virtual source and the second virtual source in response to detecting the input directed to the object that corresponds to the request to change the spatial property of the object provides the user with a control option to cause the computer system to change the spatial property of audio source and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, the one or more virtual sources corresponding to the first virtual sound stage includes a third virtual source and a fourth virtual source. In some embodiments, moving the one or more virtual first sources corresponding to the virtual sound stage relative to each other includes decreasing a distance between the third virtual source and the fourth virtual source (e.g., moving the first virtual source and the second virtual closer to each other). Decreasing a distance between the third virtual source and the fourth virtual source in response to detecting the input directed to the object that corresponds to the request to change the spatial property of the object provides the user with a control option to cause the computer system to change the spatial property of audio source and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, moving the one or more virtual sources corresponding to the virtual sound stage relative to each other includes: in accordance with a determination that changing the spatial property of the object from having the first value for the respective spatial property to having the second value for the respective spatial property includes changing the spatial property in a first direction, the one or more virtual sources corresponding to the first virtual sound stage (e.g., 1102-1106) are moved in a second direction. In some embodiments, moving the one or more virtual sources corresponding to the virtual sound stage relative to each other includes: in accordance with a determination that changing the spatial property of the object (e.g., 1184) from having the first value for the respective spatial property to having the second value for the respective spatial property includes changing the spatial property in a third direction different from the first direction, the one or more virtual sources corresponding to the first virtual sound stage are moved in a fourth direction different from the second direction. In some embodiments, moving the one or more virtual sources corresponding to the virtual sound stage relative to each other includes: in accordance with a determination that changing the spatial property of the object (e.g., 1184) from having the first value for the respective spatial property to having the second value for the respective spatial property includes increasing the size of the object (e.g., a small form (e.g., icon, window at a first size, and/or an application at a first application size) to a medium form (e.g., a window at a second size that is greater than the first size and/or an application at a second application size that is greater than the first application size); and/or a large form (e.g., a window at a third size that is greater than the second size and/or an application at a third application size that is greater than the second application size) and/or a medium form to a large form), moving the one or more virtual sources corresponding to the virtual sound stage (e.g., 1102-1106) away from each other. In some embodiments, the one or more virtual sources corresponding to the virtual sound stage away from each other at an amount that is not proportional to the size that the object was increased, in accordance with a determination that changing the spatial property of the object from having the first value for the respective spatial property to having the second value for the respective spatial property includes decreasing the size of the object (e.g., a large form to a medium form and/or small form; and/or a medium form to a small form), moving the one or more virtual sources corresponding to the virtual sound stage toward each other. In some embodiments, the one or more virtual sources corresponding to the virtual sound stage toward from each other at an amount that is not proportional to the size that the object was decreased.

In some embodiments, outputting, via the one or more input devices, audio corresponding to the object according to the second virtual sound stage (e.g., 1102-1106) in response to detecting the input directed to the object (e.g., 1184) that corresponds to the request to change the spatial property of the object includes transitioning from outputting audio using a first number of virtual sources of audio included in the first virtual sound stage to using a second number of virtual source of audio included in the second virtual sound stage. In some embodiments, the first number of virtual sources of audio is different from (e.g., less than and/or greater than) the second number of virtual sources of audio. Transitioning from outputting audio using a first number of virtual sources of audio included in the first virtual sound stage to using a second number of virtual source of audio included in the second virtual sound stage in response to detecting the input directed to the object that corresponds to the request to change the spatial property of the object provides the user with a control option to cause the computer system to change the spatial property of audio source, thereby saving battery power, the number of instructions processed, and/or time by reducing the need for the user to manually change the one or more audio properties, providing additional control options without cluttering the user interface with additional displayed controls.

In some embodiments, changing the spatial property of the object from having the first value for a respective spatial property to having the second value for the respective property includes transitioning the object (e.g., 1184) from operation in a first object mode to a second object mode different from the first object mode. In some embodiments, in accordance with a determination that the object is designed (e.g., defined, predefined, set, and/or preset, such as in an application definition and/or setting) to be associated with a first type of virtual sound stage (e.g., 1102-1106) while operating in the second object mode, the second virtual sound stage is the first type of virtual sound stage. In some embodiments, a developer of the object can choose whether the application is associated with a particular sound stage for a particular mode. In some embodiments, in accordance with a determination that the object is designed to be associated with a second type of virtual sound stage while operating in the second object mode, the second virtual sound stage is the second type of virtual sound stage different from the first type of virtual sound stage. Having a virtual sound stage that is designed to be used while the object is operating in a certain mode allows the computer system to output different virtual sound stages for different modes in which an object is operating and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, performing an operation when a set of conditions has been met without requiring further user input.

In some embodiments, changing the spatial property of the object (e.g., 1184) from having the first value for a respective spatial property to having the second value for the respective property includes resizing the object to a third size. In some embodiments, in accordance with a determination that the object is designed to be associated with a third type of virtual sound stage (e.g., 1102-1106) while being displayed at the third size, the second virtual sound stage is the third type of virtual sound stage. In some embodiments, a developer of the object can choose whether the application is associated with a particular sound stage while the application is displayed at a particular size. In some embodiments, in accordance with a determination that the object is designed to be associated with a fourth type of virtual sound stage while being displayed at the third size, the second virtual sound stage is the fourth type of virtual sound stage different from the first type of virtual sound stage. Having a virtual sound stage that is designed to be associated with the object allows the computer system to output different virtual sound stages for different objects and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, performing an operation when a set of conditions has been met without requiring further user input.

In some embodiments, the object (e.g., 1184) is a virtual object that is displayed (and/or visible) in a three-dimensional environment (e.g., a virtual or physical three-dimensional environment). In some embodiments, the spatial property of the object is changed in the three-dimensional environment (e.g., in response to detecting the input directed to the object that corresponds to the request to change the spatial property of the object). Changing the spatial property of a virtual object in a three-dimensional environment from having a first value for a respective spatial property to having a second value for the respective spatial property in response to detecting the input directed to the virtual object in the three-dimensional environment that corresponds to the request to change the spatial property of the object provides the user with a control option to cause the computer system to change the spatial property of audio source and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

Note that details of the processes described above with respect to method 1300 (e.g., FIG. 13) are also applicable in an analogous manner to the methods described herein. For example, one or more steps of method 800 of lowering the audio output can be used after changing a spatial portion of an object using one or more steps of 1300. For brevity, these details are not repeated below.

FIGS. 14A-14K illustrate exemplary user interfaces for outputting audio at one or more locations in accordance with some examples. The user interfaces in these figures are used to illustrate the processes described below, including the processes in FIG. 14.

FIGS. 14A-14K illustrate a top portion in which a user, along with various virtual components, is in a three-dimensional environment holding a computer system that is in communication with one or more output devices. FIGS. 14A-14K illustrate various examples of audio output based on inputs (e.g., air inputs, hand inputs, and/or gaze inputs) that a user makes. FIGS. 14A-14K also illustrate a bottom portion of a representation of the user's view via computer system 700.

FIGS. 14A-14C illustrate one or more exemplary scenario, where computer system 700 outputs audio for a persistent object (e.g., as described above in relation to FIGS. 7A-7R and FIG. 9H) at a system location for a persistent object is not visible within a three-dimensional environment. In some embodiments, computer system 700 outputs audio at the most recent location that the persistent object was previously displayed. In some embodiments, computer system 700 outputs audio at a location that is the center point (and/or based on) one or more virtual objects that are currently displayed. In some embodiments, computer system 700 output audio at a head-locked location. In some embodiments, computer system 700 outputs stereo audio and/or non-spatialized audio while audio is output at the head-locked location but outputs spatialized audio while audio is output at the location that is based on the locations of one or more virtual objects that are currently displayed and/or the most recent location that the persistent object was previously displayed.

FIG. 14A illustrates user 924 within three-dimensional environment 1400 (e.g., an XR environment) along with object 902 (e.g., a table) to the user's left, object 904 (e.g., a television) in front of the user, and object 906 (e.g., a couch) to the user's right. Physical objects 902-906 represent physical objects within environment 1400 and will be used herein to describe relative positions within environment 1400. Also illustrated in FIG. 14A are virtual objects (e.g., windows of applications of computer system 700). The virtual components in this example are conceptual representations (e.g., are not a part of a physical environment) of windows of applications, which computer system 700 is displaying to user 924 (e.g., as seen in bottom portion of FIGS. 9A-9H) due to user 924's relative positioning within environment 1400. The virtual components represented in FIGS. 14A-14K will further be referred to as applications and/or application windows and include APP3 and APP4 in front of object 902 and APP1 and APP2 in front of object 904. In some embodiments, application windows are in different locations relative to physical objects within environment 1400. Also illustrated in FIG. 14A is indicator 1404 in front of APP2 and indicator 1402 in front of APP1. Indicator 1404 and indicator 1402 are illustrated as being dim, which indicates that computer system 700 is not outputting audio for the respective application that is behind them.

FIG. 14A also includes a bottom portion that illustrates computer system 700, which is an output device from which the application windows described above are sourced. Physical objects 902-906 are visible via computer system 700, and computer system 700 displays virtual representation 1406 of the window associated with APP2 and virtual representation 1408 of window associated with APP1, which are overlaid on the physical objects. In this example, virtual representation 1408 is an interface associated with a memo application, and virtual representation 1406 is an interface associated with the music application. Moreover, the memo application is not a persistent application while music application is a persistent application for the purposes of the discussion provided below. At FIG. 14A, computer system 700 detects gaze input on play control 1412 of virtual representation 1408.

As illustrated in FIG. 14B, in response to detecting gaze input 1405a, computer system 700 begins to output audio from the Memos application (e.g., APP1) (e.g., as indicated by undimmed indicator 1402 and sound indicator 1414). As illustrated in 14B, in response to detecting gaze input 1405a, computer system 700 changes play control 1412 into a pause button, which indicates that computer system 700 is playing the audio from the Memos application (e.g., is outputting audio). At FIG. 14B, computer system 700 detects hand input 1405b. As illustrated in FIG. 14C, in response to detecting input 1405b, computer system 700 closes (e.g., hides) virtual representation 1408 and ceases to output audio corresponding to virtual representation 1408 (e.g., as indicated by indicator 1402 being dim and sound indicator 1414 of FIG. 14B not being displayed).

As illustrated in FIG. 14D, in response to detecting gaze input 1405c, computer system 700 begins to output audio from the music application (e.g., APP2) (e.g., as indicated by the presence of sound indicator 1424 and indicator 1404 being undimmed). As illustrated in FIG. 14D, computer system 700 changes play control 1434 into a pause button, which indicates that computer system 700 is playing the audio (e.g., outputting audio) from the music application. At FIG. 14D, computer system 700 detects hand input 1405d1 and/or hand input 1405d2.

At FIGS. 14E-14F, in response to detecting hand input 1405d1 and/or hand input 1405d2, computer system 700 ceases to display the virtual object that corresponds to APP2, and outputs audio corresponding to APP2 at the location at which the virtual object that corresponds to APP2 was previously displayed. Computer system 700 continues to output audio corresponding to APP2 (e.g., the music application) because the music application is a persistent application. Here, FIGS. 14E-14F illustrate that user 942 can turn in the environment and the audio output will continue to sound like it is coming from the location at which the virtual object that corresponds to APP2 was previously displayed (e.g., because it is spatial audio).

At FIGS. 14G-14H, in response to detecting hand input 1405d1 and/or hand input 1405d2, computer system computer system 700 ceases to display the virtual object that corresponds to APP2, and outputs audio corresponding to APP2 at a centroid location with respect to applications that are currently displayed (e.g., center of APP3 and APP4). Computer system 700 continues to output audio corresponding to APP2 (e.g., the music application) because the music application is a persistent application. Here, FIGS. 14E-14F illustrate that user 942 can turn in the environment and the audio output will continue to sound like it is coming from the location at which the virtual object that corresponds to APP2 was previously displayed (e.g., because it is spatial audio).

At FIGS. 14I-14J, in response to detecting hand input 1405d1 and/or hand input 1405d2, computer system computer system 700 ceases to display the virtual object that corresponds to APP2, and outputs audio corresponding to APP2 at a head-locked location. Computer system 700 continues to output audio corresponding to APP2 (e.g., the music application) because the music application is a persistent application. Here, FIGS. 14I-14J illustrate that the audio corresponding to audio corresponding to APP2 moves as the user 924 moves (and/or as the head of user 924 moves). In some embodiments, the audio output at the head-locked location is stereo audio and/or non-spatial audio.

FIGS. 14D-14J illustrate how computer system 700 can output audio corresponding to a persistent application after the persistent application has cease to be displayed. FIGS. 14D-14J cover three scenarios: (1) computer system 700 outputs spatial audio at the location at which was most recently displayed (e.g., 14D-14F), (2) computer system 700 outputs spatial audio a centroid of two or more visible objects (e.g., 14D, 14G, and 14H), (3) computer system 700 outputs non-spatial audio (e.g., 14D, 14I, and 14J) (e.g., stereo audio) that is head-locked to user 924. At FIG. 14J, computer system 700 detects an input (e.g., a touch input) while the audio is head-locked to user 924. As illustrated in FIG. 14K, computer system 700 transitions from providing non-spatial audio to spatial audio, where the location of the spatial audio is chosen based on one or more inputs. Thus, In some embodiments, a user can switch between receiving spatial audio output and non-spatial audio output.

FIG. 15 is a flow diagram illustrating a method (e.g., method 1500) for outputting audio at one or more locations in accordance with some examples. Some operations in method 1500 are, optionally, combined, the orders of some operations are, optionally, changed, and some operations are, optionally, omitted.

As described below, method 1500 provides an intuitive way for outputting audio at one or more locations. Method 1500 reduces the cognitive burden on a user for outputting audio at one or more locations, thereby creating a more efficient human-machine interface. For battery-operated computing devices, enabling a user to output audio at one or more locations faster and more efficiently conserves power and increases the time between battery charges. In some embodiments, method 1500 is performed at a computer system (e.g., 700 and 990) (e.g., as described above in relation to method 800) that is in communication with one or more audio output devices and one or more display generation components (e.g., as described above in relation to method 800).

At 1502, the computer system detects a request (e.g., 1405c) to play audio (e.g., initiate, resume, transfer, and/or start playback of audio) corresponding to an audio source (e.g., 1404 and/or 1406) (e.g., a media player, a spoken audio source, or other application or system audio source).

At 1504, in response to detecting the request (e.g., 1405c) to play audio corresponding to the audio source (e.g., 1404 and/or 1406) and in accordance with (1506) a determination that the audio source corresponding to an object (e.g., APP1, APP2, 1404, and/or 1406) (e.g., an object in a three-dimensional environment such as a physical object in a physical environment or a virtual object in a virtual reality, extended reality, or mixed reality environment) (e.g., as described above in relation to method 800) that has an associated location (e.g., currently presented in, displayed, presented, and/or positioned in) (e.g., currently visible in (e.g., visible when a viewpoint of the computer system and/or user is directed to a location that includes the object and/or a location corresponding to the object), currently configured to be visible in, not hidden in, and/or not currently configured to be hidden in, and/or is currently visible from a viewpoint of the user and/or can be viewed by changing a location and/or orientation of the viewpoint of the user) in a three-dimensional environment that is visible via the one or more display generation components (e.g., a virtual environment and/or a physical environment), the computer system outputs, via the one or more audio output devices, audio corresponding to the object, such that the audio corresponding to the object is output (e.g., spatially output and/or output relative to one or more and/or as originating from one or more points in space) with respect to a first location (e.g., location of 1404 and/or 1406) that is associated with the object in the three-dimensional environment (e.g., as described in relation to FIGS. 14A-14D).

At 1504, in response to detecting the request to play (e.g., 1405c) audio corresponding to the audio source (e.g., 1404 and/or 1406) and in accordance with (1508) a determination that the audio source does not correspond to an object (e.g., 1404 and/or 1406) that has an associated location in (e.g., not currently visible in, not currently configured to be visible in, hidden in, and/or currently configured to be hidden in (e.g., due to occlusion or the location and/or orientation of the viewpoint of the user)) the three-dimensional environment (e.g., a hidden application and/or a hidden object and/or that is not currently visible from a viewpoint of the user and/or cannot be viewed by changing a location and/or orientation of the viewpoint of the user), the computer system (e.g. 700) outputs, via the one or more audio output devices, the audio corresponding to the object, such that the audio corresponding to the object is output with respect to a second location (e.g., a location that is not the location APP2 while 1406 is displayed via computer system 700) that is a system selected location (e.g., a location that is the location APP2 while 1406 is not displayed via computer system 700) that is different from the first location in the three-dimensional environment (e.g., FIGS. 14E-14K). Outputting, via the one or more audio output devices, the audio corresponding to the object with respect to a first location associated with the object or at a system location based on prescribed conditions being met allows the computer system to automatically choose where to output audio based on one or more characteristics of the audio source and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, performing an operation when a set of conditions has been met without requiring further user input.

In some embodiments, a first object (e.g., APP1 or APP2) corresponds to the audio source. In some embodiments, the system selected location is a location (e.g., a location that is the location APP2 while 1406 is not displayed via computer system 700) at which the first object was last visible (and/or included in the three-dimensional environment). Outputting, via the one or more audio output devices, the audio corresponding to the object with respect to a first location associated with the object or at a last location at which the first object was last visible based on prescribed conditions being met allows the computer system to automatically choose where to output audio with respect to different locations based on one or more characteristics of the audio source, to choose a system location based on the last location at which the first object was last visible if needed, and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, performing an operation when a set of conditions has been met without requiring further user input.

In some embodiments, the system selected location is a location (e.g., 1426 in FIG. 14H) (e.g., center point, a central point, and/or a point that is equidistance) between a plurality of objects that are visible (e.g., open application and/or displayed application) in the three-dimensional environment (e.g., as described above in relation 14D-14J). Outputting, via the one or more audio output devices, the audio corresponding to the object with respect to a first location associated with the object or at a location between a plurality of objects that are visible in the three-dimensional environment based on prescribed conditions being met allows the computer system to automatically choose where to output audio with respect to different locations based on one or more characteristics of the audio source, to choose a system location based on the location between the plurality of objects that are visible if needed, and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, performing an operation when a set of conditions has been met without requiring further user input.

In some embodiments, the system selected location (e.g., 1428) is a first head-locked location (e.g., one or more locations that do not change relative to a head-mounted display (HMD) device as the HMD is moved and/or rotated, such as audio output to the left of the HMD device and to the right of the HMD device) (and/or view-point locked location). In some embodiments, outputting, via the one or more audio output devices, the audio corresponding to the object, such that the audio corresponding to the object is output with respect to the second location that is the system selected location, includes outputting audio corresponding to the object that is head-locked (e.g., 1428) to a user of the computer system (e.g., 700 and 990) (e.g., the audio continues to appear to be output at and/or near the user's head as the user's head is moved in the environment) (1428) (e.g., as described above in relation to FIGS. 14I-14J). Outputting, via the one or more audio output devices, the audio corresponding to the object that is head-locked to a user based on prescribed conditions being met allows the computer system to automatically choose to output head-lock audio for audio that is not currently associated with a location that is not a system location and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, performing an operation when a set of conditions has been met without requiring further user input.

In some embodiments, while outputting the audio corresponding to the object (e.g., APP1, APP2, 1404, and/or 1406), the computer system detects a request to change a location of the audio output (e.g., as described above in relation to 14K). In some embodiments, detecting the request to change the location of the audio output is detected via one or more inputs, such as one or more gaze inputs, tap inputs, air gestures (e.g., air taps, air swipes, and/or air pinches), mouse clicks, and/or inputs detected via a physical and/or virtual controller. In some embodiments, in response to detecting the request to change the location of the audio output (e.g., as described above in relation to 14K) (e.g., via a control center and/or via one or more audio settings, as described above in relation to method 800) and in accordance with a determination that the request to change the location of the audio output includes a request to output head-locked audio (e.g., as described above in relation to 14K), the computer system outputs, via the one or more audio output devices, the audio corresponding to the object, such that the audio corresponding to the object is output with respect to a second head-locked location. In some embodiments, in response to detecting the request to change the location of the audio output and in accordance with a determination that the request to change the location of the audio output includes a request to output environment-locked audio, the computer system outputs, via the one or more audio output devices, the audio corresponding to the object (e.g., as described above in relation to 14K), such that the audio corresponding to the object is output with respect to an environment-locked location. Switching between outputting audio at a head-locked location and environment-locked location in response to detecting the request to change the location of the audio output provides the user with control over the computer system to switch between outputting head-locked audio and environment-locked audio and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, while outputting, via the one or more audio output devices, the audio corresponding to the object (e.g., APP1, APP2, 1404, and/or 1406), such that the audio corresponding to the object is output with respect to the first location that is associated with the object in the three-dimensional environment, the computer system detects movement of the viewpoint (e.g., of a user and/or of the computer system) relative to the object (e.g., as described above in relation to 14D-14H). In some embodiments, detecting movement of the viewpoint relative to the object includes detecting movement of the viewpoint. In some embodiments, detecting movement of the viewpoint relative the object includes detecting movement of the object. In some embodiments, in response to detecting movement of the viewpoint relative to the object, the computer system outputs, via the one or more audio output devices, audio corresponding to the object, such that the audio corresponding to the object is output with respect to a third location in the three-dimensional environment, wherein the third location is different from the first location (e.g., as described above in relation to 14D-14H). Outputting, via the one or more audio output devices, audio corresponding to the object, such that the audio corresponding to the object is output with respect to a third location in the three-dimensional environment in response to detecting movement of the viewpoint relative to the object allows the user to control the location with respect to an audio source is output and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls.

In some embodiments, while outputting, via the one or more audio output devices, the audio corresponding to the object (e.g., APP1, APP2, 1404, and/or 1406), such that the audio corresponding to the object is output with respect to the first location that is associated with the object in the three-dimensional environment and while the object (e.g., as described above in relation to 14D-14H) is visible (and/or a representation is included) in the three-dimensional environment, the computer system detects a first request (e.g., 1405d1 and/or 1405d2) to hide the object from being visible (e.g., currently visible and/or visible while a viewpoint is facing a location corresponding to the object) when a in the three-dimensional environment (e.g., as described above in relation to 14D-14E). In some embodiments, in response to detecting the first request (e.g., 1405d1 and/or 1405d2) to hide the object from being visible in the three-dimensional environment (e.g., as described above in relation to 14D-14E), the computer system detects the first request (e.g., 1405d1 and/or 1405d2) to hide the object from being visible in the three-dimensional environment includes detecting, via one or more inputs, such as one or more gaze inputs, tap inputs, air gestures (e.g., air taps, air swipes, and/or air pinches), mouse clicks, and/or inputs detected via a physical and/or virtual controller. In some embodiments, in response to detecting the first request to hide the object from being visible in the three-dimensional environment (e.g., as described above in relation to 14D-14E), the computer system hides the object from being visible in the three-dimensional environment (e.g., as described above in relation to 14D-14E). In some embodiments, in response to detecting the first request to hide the object from being visible in the three-dimensional environment (e.g., as described above in relation to 14D-14E), the computer system outputs, via the one or more audio output devices, the audio corresponding to the object, such that the audio corresponding to the object is output with respect to a fourth location that is the system selected location different from the first location in the three-dimensional environment (e.g., as described above in relation to 14D-14E). Outputting, via the one or more audio output devices, the audio corresponding to the object, such that the audio corresponding to the object is output with respect to the system selected location in response to detecting the first request (e.g., 1405d1 and/or 1405d2) In some embodiments, the computer system continues outputting, via the one or more audio output devices, the audio corresponding to the object, such that the audio corresponding to the object is output with respect to the first location that is associated with the object in the three-dimensional environment (e.g., as described above in relation to 14D-14E). Continuing outputting, via the one or more audio output devices, the audio corresponding to the object, such that the audio corresponding to the object is output with respect to the first location that is associated with the object in the three-dimensional environment in response to detecting the first request to hide the object from being visible in the three-dimensional environment allows the computer system to output audio for an audio source that has been hidden in response to detecting the first request and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls and performing an operation when a set of conditions has been met without requiring further user input.

In some embodiments, while outputting, via the one or more audio output devices, the audio corresponding to the object (e.g., APP1, APP2, 1404, and/or 1406), such that the audio corresponding to the object is output with respect to the first location that is associated with the object in the three-dimensional environment and while the object is visible in the three-dimensional environment, the computer system detects a second request (e.g., 1405d1 and/or 1405d2) to hide the object from being visible in the three-dimensional environment. In some embodiments, in response to detecting the second request (e.g., 1405d1 and/or 1405d2) to hide the object from being visible in the three-dimensional environment: detecting the second request (e.g., 1405d1 and/or 1405d2) to hide the object from being visible in the three-dimensional environment includes detecting, via one or more inputs, such as one or more gaze inputs, tap inputs, air gestures (e.g., air taps, air swipes, and/or air pinches), mouse clicks, and/or inputs detected via a physical and/or virtual controller. In some embodiments, the computer system hides the object (e.g., when the object is (e.g., a currently playing and/or now playing object, music, a podcast, an application that is exclusive and/or is designed as being important and/or exclusive (e.g., a movie, presentation mode, and/or mindfulness))) from being visible in the three-dimensional environment (e.g., as described above in relation to 14D-14E). In some embodiments, in response to detecting the second request to hide the object from being visible in the three-dimensional environment, the computer system continues outputting, via the one or more audio output devices, the audio corresponding to the object, such that the audio corresponding to the object is output with respect to the first location that is associated with the object in the three-dimensional environment (e.g., as described above in relation to 14D-14E). Continuing outputting, via the one or more audio output devices, the audio corresponding to the object, such that the audio corresponding to the object is output with respect to the first location that is associated with the object in the three-dimensional environment in response to detecting the first request (e.g., 1405d1 and/or 1405d2) to hide the object from being visible in the three-dimensional environment allows the computer system to output audio for an audio source that has been hidden in response to detecting the first request and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls and performing an operation when a set of conditions has been met without requiring further user input.

In some embodiments, while outputting, via the one or more audio output devices, the audio corresponding to the object, such that the audio corresponding to the object is output with respect to the first location that is associated with the object in the three-dimensional environment and while the object is visible in the three-dimensional environment (e.g., as described above in relation to 14B-14C), the computer system detects a third request (e.g., 1405d1 and/or 1405d2) to hide the object from being visible in the three-dimensional environment (e.g., as described above in relation to 14B-14C). In some embodiments, in response to detecting the third request (e.g., 1405d1 and/or 1405d2) to hide the object from being visible in the three-dimensional environment: In some embodiments, the computer system hides the object (e.g., as described above in relation to 14B-14C) (e.g., when the object is (e.g., a currently playing and/or now playing object, music, a podcast, an application that is exclusive and/or is designed as being important and/or exclusive (e.g., a movie, presentation mode, and/or mindfulness))) from being visible in the three-dimensional environment. In some embodiments, in response to detecting the third request to hide the object from being visible in the three-dimensional environment, the computer system ceases to output, via the one or more audio output devices, the audio corresponding to the object (e.g., as described above in relation to 14B-14C). Ceasing to output, via the one or more audio output devices, the audio corresponding to the object in response to detecting the third request (e.g., 1405d1 and/or 1405d2) to hide the object from being visible in the three-dimensional environment provide a user with a control object to cease the output of audio for an audio source that has been hidden and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls and performing an operation when a set of conditions has been met without requiring further user input.

In some embodiments, while outputting, via the one or more audio output devices, the audio corresponding to object, such that the audio corresponding to the object is output with respect to the second location that is the system selected location, the computer system detects a request to display the object (e.g., as described above in relation to FIGS. 14J-14K). In some embodiments, in response to detecting the request to display the object, the computer system outputs, via the one or more audio output devices, the audio corresponding to object, such that the audio corresponding to the object is output with respect to a location that is different from the system location (e.g., as described above in relation to FIGS. 14J-14K). In some embodiments, in response to detecting the request to display the object, the computer system moves the output of the audio from the system location to the location that is different from the system location. Outputting, via the one or more audio output devices, the audio corresponding to object, such that the audio corresponding to the object is output with respect to a location that is different from the system location in response to detecting the request to display the object provides the user with an additional control option to change the location to which audio is output and automatically change the audio properties of objects to avoid the user from having to manually change the audio properties of objects and/or to manually close individual windows or user interface objects, thereby saving battery power, the number of instructions processed, and/or time by reducing the need for the user to manually change the one or more audio properties, providing additional control options without cluttering the user interface with additional displayed controls and performing an operation when a set of conditions has been met without requiring further user input.

In some embodiments, the audio corresponding to the object that is output with respect to a first location that is associated with the object in the three-dimensional environment is spatialized audio (e.g., as described above in relation to FIGS. 14E-14F) (e.g., audio that makes sound appear to come from behind the user or to the side of the user in an area that is outside of a viewport of the user into the three-dimensional environment and/or audio associated with one or more virtual locations and/or virtual audio sources).

In some embodiments, the audio corresponding to the object that is output with respect to the second location that is the system selected location is spatialized audio (e.g., as described above in relation to FIGS. 14E-14F) (e.g., audio with an arbitrary location determined by the device and audio that is viewpoint-locked to a variety of different positions or environment-locked to a variety of different positions) (and/or, In some embodiments, a user can switch the spatial audio from being environment-locked to being viewpoint locked or vice versa) (e.g., audio that makes sound appear to come from behind the user or to the side of the user in an area that is outside of a viewport of the user into the three-dimensional environment and/or audio associated with one or more virtual locations and/or virtual audio sources).

In some embodiments, the audio corresponding to the object that is output with respect to the second location that is the system selected location is non-spatialized audio (e.g., as described above in relation to FIGS. 14H-14J) (e.g., audio with a fixed location (e.g., a location (e.g., a fixed location and/or a location on the surface of the computer system) of the audio output device and/or an audio output component and/or audio determined based on a stereo mix)) (e.g., stereo audio) (e.g., audio that does not make sound appear to come from behind the user or to the side of the user in an area that is outside of a viewport of the user into the three-dimensional environment and/or, In some embodiments, audio not associated with one or more virtual locations and/or virtual audio sources).

Note that details of the processes described above with respect to method 1500 (e.g., FIG. 15) are also applicable in an analogous manner to the methods described herein. For example, one or more steps of method 800 of lowering the audio output can be used after changing a system location is chosen for an audio source using one or more steps of 1500. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. In some embodiments, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

1.-35. (canceled)

36. A method, comprising:
at a computer system that is in communication with one or more audio output devices and a display generation component:
while a first object is visible, via the display generation component, outputting, via the one or more audio output devices, audio corresponding to the first object at a first prominence of audio output;
while outputting audio corresponding to the first object at the first prominence of audio output, detecting an occurrence of an event that includes detecting attention of a user moving away from being directed to the first object; and
in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

37. The method of claim 36, wherein detecting the attention of the user moving away from being directed to the first object includes detecting a first gaze input of the user moving from a first gaze position to a second gaze position, and wherein the first gaze position corresponds to a location corresponding to the first object and the second gaze position corresponds to a location that does not correspond to the first object.

38. The method of claim 36, wherein detecting the attention of the user moving away from being directed to the first object includes detecting that a second gaze input has not been directed to the first object for more than a threshold amount of time.

39. The method of claim 36, wherein detecting the attention of the user moving away from being directed to the first object includes detecting that a second object, different from the first object, is becoming active.

40. The method of claim 39, wherein detecting that the second object is becoming active includes detecting a third gaze input directed to the second object.

41. The method of claim 39, wherein detecting that the second object is becoming active includes detecting a fourth gaze input has been directed to the second object for more than a second threshold amount of time.

42. The method of claim 39, wherein detecting that the second object is becoming active includes detecting an input that is directed to the second object.

43. The method of claim 36, wherein detecting the attention of the user moving away from being directed to the first object includes detecting that the first object is becoming inactive.

44. The method of claim 43, wherein detecting that the first object is becoming inactive includes detecting a request to cease displaying the first object.

45. The method of claim 43, wherein detecting that the first object is becoming inactive includes detecting that the first object is obscured by a third object different from the first object.

46. The method of claim 36, wherein:
before detecting the attention of the user moving away from being directed to the first object, the computer system is a first distance from the first object; and
while detecting the attention of the user moving away from being directed to the first object, the computer system is the first distance from the first object.

47. The method of claim 36, wherein detecting the attention of the user moving away from being directed to the first object includes detecting an interaction with a fourth object different from the first object.

48. The method of claim 36, wherein outputting, via the one or more audio output devices, the audio corresponding to the first object at the second prominence of audio output includes reducing a volume level of the audio corresponding to the first object from a first volume level to a second volume level different from the first volume level.

49. The method of claim 36, wherein outputting, via the one or more audio output devices, the audio corresponding to the first object at the second prominence of audio output includes increasing an amount of reverberation for the audio corresponding to the first object from a first reverberation level to a second reverberation level different from the first reverberation level.

50. The method of claim 36, wherein outputting, via the one or more audio output devices, the audio corresponding to the first object at the second prominence of audio output includes applying a low-pass filter to the audio corresponding to the first object at the first prominence of audio output.

51. The method of claim 36, further comprising:
while outputting, via the one or more audio output devices, the audio corresponding to the first object at the second prominence of audio output, detecting an occurrence of a second event that includes detecting the attention of the user moving away from being directed to the first object; and
in response to detecting the occurrence of the second event that includes detecting the attention of the user moving away from being directed to the first object, reducing prominence of the output of audio corresponding to the first object by pausing the audio corresponding to the first object.

52. The method of claim 36, further comprising:
while a fifth object different from the first object is visible, via the display generation component, outputting, via the one or more audio output devices, audio corresponding to the fifth object at a third prominence of audio output;
while outputting audio corresponding to the fifth object at a third prominence of audio output, detecting an occurrence of a third event that includes detecting the attention of a user moving away from being directed to the first object; and
in response to detecting the occurrence of the third event that includes detecting the attention of the user moving away from being directed to the first object:
in accordance with a determination that the fifth object corresponds to a first type of object, continuing to output audio corresponding to the fifth object at the third prominence of audio output; and
in accordance with a determination that the fifth object corresponds to a second type of object different from the first type of object, forgoing outputting audio corresponding to the fifth object at the third prominence of audio output.

53. The method of claim 52, wherein the first type of object is an object that corresponds to a music application, a video application, a spoken audio application, a communication application, or one or more combinations thereof.

54. The method of claim 52, further comprising:
detecting a request to display a system user interface; and
in response to detecting the request to display the system user interface, displaying, via the display generation component, the system user interface, including:
a first control that, when selected, causes the computer system to adjust output of audio corresponding to the fifth object; and
a second control that, when selected, causes the computer system to adjust output of audio corresponding to a sixth object, wherein the sixth object is the first type of object.

55. The method of claim 54, wherein detecting the request to display the system user interface includes detecting a fifth gaze input at a fixed location in a viewport of a three-dimensional environment, and wherein the three-dimensional environment is visible in the viewport of the three-dimensional environment.

56. The method of claim 52, wherein the fifth object is the first type of object, the method comprising:
while outputting audio corresponding to the fifth object, detecting a request to output audio corresponding to an object that is the first type of object different from the fifth object; and
in response to detecting the request to output audio corresponding to the object that is the first type of object:
outputting audio corresponding to the object that is the first type of object; and
ceasing outputting audio corresponding to the fifth type of object.

57. The method of claim 36, further comprising:
in response to detecting the occurrence of the event that includes detecting the attention of the user moving away from being directed to the first object, outputting, via the one or more audio output devices, audio corresponding to a seventh object at a fourth prominence of audio output that is higher than a fifth prominence of audio output, wherein the fifth prominence of audio output is a prominence of audio output at which audio corresponding to the seventh object was output before detecting the occurrence of the event that includes detecting the attention of the user moving away from being directed to the first object, wherein the seventh object is different from the first object.

58. The method of claim 36, further comprising:
while outputting audio corresponding to the first object at the first prominence of audio output, outputting audio corresponding to an eighth object different from the first object at a sixth prominence of audio output that is different from the first prominence of audio output.

59. The method of claim 36, wherein the first object is an application window.

60. The method of claim 36, wherein the object is visible in a three-dimensional environment.

61. The method of claim 36, wherein:
in accordance with a determination that the first object is associated with a first location, the audio corresponding to the first object is output such that the audio corresponding to the first object is spatially positioned at the first location; and
in accordance with a determination that the first object is associated with a second location different from the first location, the audio corresponding to the first object is output such that the audio corresponding to the first object is spatially positioned at the second location.

62.-65. (canceled)

66. A non-transitory computer-readable storage medium storing one or more programs configured to be executed by one or more processors of a computer system that is in communication with one or more audio output devices and a display generation component, the one or more programs including instructions for:
while a first object is visible, via the display generation component, outputting, via the one or more audio output devices, audio corresponding to the first object at a first prominence of audio output;
while outputting audio corresponding to the first object at the first prominence of audio output, detecting an occurrence of an event that includes detecting attention of a user moving away from being directed to the first object; and
in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

67. A computer system that is in communication with one or more audio output devices and a display generation component, comprising:
one or more processors; and
memory storing one or more programs configured to be executed by the one or more processors, the one or more programs including instructions for:
while a first object is visible, via the display generation component, outputting, via the one or more audio output devices, audio corresponding to the first object at a first prominence of audio output;
while outputting audio corresponding to the first object at the first prominence of audio output, detecting an occurrence of an event that includes detecting attention of a user moving away from being directed to the first object; and
in response to detecting the occurrence of the event that includes detecting the attention of the user moving away from being directed to the first object, outputting, via the one or more audio output devices, the audio corresponding to the first object at a second prominence of audio output that is lower than the first prominence of audio output.

68.-137. (canceled)
